(19) United States
(12) Patent Application Publication
(10) Pub. No.: US 2019/0333480 A1
(43) Pub. Date: Oct. 31, 2019

(54) Improved Accuracy of Displayed Virtual Data with Optical Head Mount Displays for Mixed Reality

(71) Applicant: Philipp K. Lang, Lexington, MA (US)

(72) Inventor: Philipp K. Lang, Lexington, MA (US)

(21) Appl. No.: 16/475,162

(22) PCT Filed: Jan. 5, 2018
(86) PCT No.: PCT/US2018/012459

§ 371 Date: Jul. 1, 2019

Related U.S. Application Data
(60) Provisional application No. 62/442,541, filed on Jan. 5, 2017.

(51) Int. Cl. G09G 5/38; G02B 27/01; G06F 3/01

(52) U.S. Cl. CPC G09G 5/38; G02B 27/0172; G02B 27/0179; G09G 2354/00; G02B 2027/014; G02B 2027/0187; G06F 3/011

(57) ABSTRACT

Aspects of the invention relate to systems and methods for viewing live data and virtual data with the optical head mounted display unit. In some embodiments, the system comprises an optical head mounted display unit configured to be registered or calibrated in relationship to at least one of a user's head, face, eye or pupil; a computer processor configured for measuring movement of the optical head mount display unit in relationship to the at least one of the user's head, face, eye or pupil; and a means for adjusting one or more of the position, orientation, or alignment of the display of the optical head mounted display unit to adjust or compensate for the movement of the optical head mounted display unit in relationship to the at least one of the user's head, face, eye or pupil.

### RELATED APPLICATIONS

This application claims the benefit of and priority to U.S. Provisional Application Ser. No. 62/442,541, filed Jan. 5, 2017, the entire content of which is hereby incorporated by reference in its entirety.

### TECHNICAL FIELD

Aspects of the invention relate to systems, devices, techniques and methods to improve the accuracy of the display including the displayed information.

### BACKGROUND

Optical head mounted displays can be used and can guide gaming, industrial, aerospace, aviation, automotive, medical and other applications. Several inherent technical limitations and inaccuracies of optical head mounted displays including related hardware, display systems and software can, however, adversely affect the user experience including the accuracy of the display including the accuracy of the displayed information.

### SUMMARY OF THE INVENTION

Aspects of the invention relate to systems and methods for viewing live data and virtual data with the optical head mounted display unit. In some embodiments, the system comprises an optical head mounted display unit configured to be registered or calibrated in relationship to at least one of a user's head, face, eye or pupil; a computer processor configured for measuring movement of the optical head mount display unit in relationship to the at least one of the user's head, face, eye or pupil; and a means for adjusting one or more of the position, orientation, or alignment of the display of the optical head mounted display unit to adjust or compensate for the movement of the optical head mounted display unit in relationship to the at least one of the user's head, face, eye or pupil.

In some embodiments, the means of adjusting the one or more of a position, orientation or alignment of the display maintains the display substantially centered over the user's eye or pupil. In some embodiments, the optical head mounted display unit displays a left display and a right displays a right display and the left display is maintained substantially centered over the left eye of the user and the right display is maintained substantially centered over the right eye of the user.

In some embodiments, the optical head mounted display unit displays a left display and a right displays a right display and the left display is maintained substantially centered over the left pupil of the user and the right display is maintained substantially centered over the right pupil of the user.

In some embodiments, the means for adjusting of the position, orientation or alignment of the display of the optical head mounted display unit includes at least one of translation or rotation or tilting. In some embodiments, the translation is along at least one of an x-axis, y-axis or z-axis or combinations thereof. In some embodiments, the rotation is in at least an axial plane, sagittal plane, coronal plane, an oblique plane or combinations thereof. In some embodiments, the tilting is in at least an axial plane, sagittal plane, coronal plane, an oblique plane or combinations thereof.

In some embodiments, the display of the optical head mounted display unit includes at least one of a physical display or physical display elements, a projection or images generated by the physical display or physical display elements, an individual display element, a mirror, a holographic optical element, a waveguide, a grating, a diffraction grating, a prism, a reflector or a focus plane of the virtual data.

In some embodiments, the display is maintained in a substantially parallel plane relative to the frontal plane of the face of the user.

In some embodiments, the means of adjusting one or more of a position, orientation or alignment of the display of the optical head mounted display unit is at least one of optical, optoelectronic, mechanical or electrical means or a combination thereof.

In some embodiments, the adjusting is intermittent or continuous.

In some embodiments, the display of the optical head mounted display unit is at a predetermined position, orientation or alignment relative to the eye or pupil of the user and wherein the means of adjusting the one or more of the position, orientation or alignment of the display maintains the display substantially at the predetermined position.

The optical head mounted display can be a see-through optical head mounted display. The optical head mounted display can be a non-see through or a virtual reality optical head mounted display.

In some embodiments, the system further comprises one or more cameras for display live data of a target area of activity by the non-see through virtual reality optical head mounted display.

Aspects of the invention relate to a method for viewing live data and virtual data with the optical head mounted display unit, the method comprising registering or calibrating an optical head mounted display unit in relationship to at least one of a user's head, face, eye or pupil; measuring movement of the optical head mount display unit in relationship to the at least one of the user's head, face, eye or pupil; and adjusting one or more of the position, orientation, or alignment of the display of the optical head mounted display unit to adjust or compensate for the movement of the optical head mounted display unit in relationship to the at least one of the user's head, face, eye or pupil.

Aspects of the invention relate to an optical head mounted display, the optical head mounted display comprising a frame for adaptation to the user's head and/or face and a display, the display having at least one curved portion, the curved portion including two or more radii, wherein the radii are selected to correct a visual problem affecting the eye of the user. In some embodiments, the two or more radii are in a different plane.

In some embodiments, the display is an arrangement of two or more display elements, mirrors, holographic optical elements, and/or reflectors. In some embodiments, the display is a focus plane of virtual data displayed by the optical head mounted display unit. In some embodiments, the visual problem is a refractive error of the eye. In some embodiments, the visual problem is one or more of a myopia, hyperopia, presbyopia, or astigmatism.

In some embodiments, the optical head mounted display unit comprises a display for the user's left eye and the user's right eye, the curved portion of the display for the user's left eye having at least one radius that is different than the curved portion of the user's right eye.

Aspects of the invention relate to an optical head mounted display, the optical head mounted display comprising a frame for adaptation to the user's head and/or face and a display, the display having at least one curved portion, the curved portion including at least one radius of curvature, wherein the at least one radius of curvature is selected to correct a visual problem affecting the eye of the user.

In some embodiments, the display is an arrangement of two or more of a display elements, mirrors, holographic optical elements, and/or reflectors. In some embodiments, the display is a focus plane of virtual data displayed by the optical head mounted display unit. In some embodiments, the visual problem is a refractive error of the eye. In some embodiments, the visual problem is one or more of a myopia, hyperopia, presbyopia, or astigmatism. In some embodiments, two or more radii are present in the curved portion of the display, the two or more radii being located in a different plane. In some embodiments, the optical head mounted display unit comprises a display for the user's left eye and the user's right eye, the curved portion of the display for the user's left eye having at least one radius that is different than the curved portion of the user's right eye.

### BRIEF DESCRIPTION OF THE DRAWINGS

Illustrative, non-limiting example embodiments will be more clearly understood from the following detailed description taken in conjunction with the accompanying drawings.

FIGS. 1A-1C show the use of one or more cameras directed towards the eyes for measuring, for example, the angular orientation of an OHMD to the user's eyes according to some embodiments.

FIGS. 2A-2E are illustrative, non-limiting examples of re-orienting or re-aligning one or more OHMD displays to adjust or correct, for example, for movement of an OHMD on the user's head.

FIG. 3 is a flow chart providing multiple, non-limiting examples of various means, methods and or systems for performing corrections in response to movement of an OHMD unit, including movement of the OHMD unit during an activity, e.g. a surgical procedure or a gaming or industrial application, including movement of the OHMD unit relative to the user's and/or surgeon's head and/or face.

FIGS. 4A-4Q show various exemplary, non-limiting positions of an OHMD unit on a user's face and/or head and the resultant location of the OHMD display, as well as various exemplary, non-limiting adjustments or corrections of the OHMD display for different positions and/or orientations of the OHMD unit on the user's face and/or head.

FIG. 5 is an illustrative, exemplary, non-limiting flow chart providing examples how the movement of the display can be performed.

### DETAILED DESCRIPTION OF THE INVENTION

Aspects of the invention relate to devices and methods for utilizing one or more optical head mounted displays (OHMD's), for example during a medical or surgical procedure. The one or more OHMD's can be used for visual guidance. They can be of mixed reality type, e.g. non see through with the physical world captured via one or more video cameras or video systems and computer graphics, for example indicating a predetermined path for a surgical instrument or implant, or they can be of augmented reality type, for example using one or more see through OHMD's for viewing the physical world with optionally superimposed computer graphics, e.g. virtual paths, virtual planes, virtual instruments or virtual implants. Systems, devices, techniques and methods are described to improve the accuracy of the display including the displayed information.

With computer assisted surgery, e.g. surgical navigation or robotics, pre-operative imaging studies of the patient can be used. The imaging studies can be displayed in the OR on an external computer monitor and the patient's anatomy, e.g. landmarks, can be registered in relationship to the information displayed on the monitor. Since the surgical field is in a different location and has a different view coordinate system for the surgeon's eyes than the external computer monitor, hand-eye coordination can be challenging for the surgeon. Hand eye coordination can be improved by using optical head mounted displays (OHMD's), for example, when virtual surgical planning information and/or pre- or intra-operative imaging studies are superimposed with and/or aligned with corresponding portions of the patient's physical anatomy, e.g. as exposed or explored during surgery and as seen through the optical head mounted displays. Similarly, OHMD's can be used and can guide gaming, industrial, aerospace, aviation, automotive and other applications. Several inherent technical limitations and inaccuracies of optical head mounted displays including related hardware, display systems and software can, however, adversely affect the user experience including the accuracy of the display including the displayed information. The present invention provides, for example, for systems, devices, techniques and methods to improve the accuracy of the display including the displayed information.

Optical head mounted displays, related hardware and software, registration techniques, imaging techniques, sensor techniques, and applications are described in US 2017-0258526, entitled “Devices and Methods for Surgery”, filed Mar. 10, 2017 and U.S. Provisional Application No. 62/556,867, entitled “Devices and Methods for Surgery”, filed Sep. 11, 2017, which are incorporated herein by reference in their entirety.

Various exemplary embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout. For example, various embodiments can be applied to medical including surgical, industrial, and gaming applications.

The term “live data” of a patient or an object, as used herein, includes the surgical site, anatomy, anatomic structures or tissues and/or pathology, pathologic structures or tissues of the patient as seen, for example, by the surgeon's or viewer's eyes without information from virtual data, stereoscopic views of virtual data, or imaging studies. The “term live data of the patient” does not include internal or subsurface tissues or structures or hidden tissues or structures that can only be seen with assistance of a computer monitor or OHMD. Live data of the patient can also be seen by cameras, for example mounted over the surgical site or attached to one or more OR lights or integrated into or attached to one or more OHMD's.

The terms “real surgical instrument”, “actual surgical instrument”, and “physical surgical instrument” are used interchangeably throughout the application; the terms real surgical instrument, actual surgical instrument, and physical surgical instrument do not include virtual surgical instruments. For example, the physical surgical instruments can be surgical instruments provided by manufacturers or vendors for spinal surgery, pedicle screw instrumentation, anterior spinal fusion, knee replacement, hip replacement, ankle replacement and/or shoulder replacement; physical surgical instruments can be, for example, cut blocks, pin guides, awls, reamers, impactors, broaches. Physical surgical instruments can be re-useable or disposable or combinations thereof. Physical surgical instruments can be patient specific. The term “virtual surgical instrument” does not include real surgical instrument, actual surgical instrument, and physical surgical instrument.

The terms “real surgical tool”, “actual surgical tool”, and “physical surgical tool” are used interchangeably throughout the application; the terms real surgical tool, actual surgical tool, and physical surgical tool do not include virtual surgical tools. The physical surgical tools can be surgical tools provided by manufacturers or vendors. For example, the physical surgical tools can be pins, drills, saw blades, retractors, frames for tissue distraction and other tools used for orthopedic, neurologic, urologic or cardiovascular surgery. The term “virtual surgical tool” does not include real surgical tool, actual surgical tool, and physical surgical tool.

The terms “real implant” or “real implant component”, “actual implant” or “actual implant component”, “physical implant” or “physical implant component” are used interchangeably throughout the application; the terms real implant or implant component, actual implant or implant component, physical implant or implant component do not include virtual implant or implant components. The physical implants or implant components can be implants or implant components provided by manufacturers or vendors. For example, the physical surgical implants can be a pedicle screw, a spinal rod, a spinal cage, a femoral or tibial component in a knee replacement, an acetabular cup or a femoral stem and head in hip replacement, a humeral component or a glenoid component in a shoulder replacement. The term “virtual implant” or “virtual implant component” does not include real implant or implant component, actual implant or implant component, physical implant or implant component.

The terms “real instrument”, “actual instrument”, and “physical instrument” are used interchangeably throughout the application; the terms real instrument, actual instrument, and physical instrument do not include virtual instruments. Physical instruments can be re-useable or disposable or combinations thereof. Physical instruments can be customized. The term “virtual instrument” does not include real instrument, actual instrument, and physical instrument.

The terms “real tool”, “actual tool”, and “physical tool” are used interchangeably throughout the application; the terms real tool, actual tool, and physical tool do not include virtual tools Physical tools can be re-useable or disposable or combinations thereof. Physical tools can be customized. The term “virtual tool” does not include real tool, actual tool, physical tool and tool.

The terms “image and/or video capture system”, “video capture system”, “image or video capture system”, “image and/or video capture system, and/or optical imaging system” can be used interchangeably. In some embodiments, a single or more than one, e.g. two or three or more, image and/or video capture system, video capture system, image or video capture system, image and/or video capture system, and/or optical imaging system can be used in one or more locations (e.g. in one, two, three, or more locations), for example integrated into, attached to or separate from an OHMD, attached to an OR table, attached to a fixed structure in the OR, integrated or attached to or separate from an instrument, integrated or attached to or separate from an arthroscope, integrated or attached to or separate from an endoscope, internal to the patient's skin, internal to a surgical site, internal to a target tissue, internal to an organ, internal to a cavity (e.g. an abdominal cavity or a bladder cavity or a cistern or a CSF space, or an internal to a vascular lumen), internal to a vascular bifurcation, internal to a bowel, internal to a small intestine, internal to a stomach, internal to a biliary structure, internal to a urethra and or urether, internal to a renal pelvis, external to the patient's skin, external to a surgical site, external to a target tissue, external to an organ, external to a cavity (e.g. an abdominal cavity or a bladder cavity or a cistern or a CSF space, or an external to a vascular lumen), external to a vascular bifurcation, external to a bowel, external to a small intestine, external to a stomach, external to a biliary structure, external to a urethra and or urether, and/or external to a renal pelvis. In some embodiments, the position and/or orientation and/or coordinates of the one or more image and/or video capture system, video capture system, image or video capture system, image and/or video capture system, and/or optical imaging system can be tracked using any of the registration and/or tracking methods described in the specification, e.g. direct tracking using optical imaging systems and/or a 3D scanner(s), in any of the foregoing locations and/or tissues and/or organs and any other location and/or tissue and/or organ described in the specification or known in the art. Tracking of the one or more image and/or video capture system, video capture system, image or video capture system, image and/or video capture system, and/or optical imaging system can, for example, be advantageous when the one or more 3D scanners are integrated into or attached to an instrument, an arthroscope, an endoscope, and/or when they are located internal to any structures, e.g. inside a joint or a cavity or a lumen.

In some embodiments, a single or more than one, e.g. two or three or more, 3D scanners can be present in one or more locations(e.g. in one, two, three, or more locations), for example integrated into, attached to or separate from an OHMD, attached to an OR table, attached to a fixed structure in the OR, integrated or attached to or separate from an instrument, integrated or attached to or separate from an arthroscope, integrated or attached to or separate from an endoscope, internal to the patient's skin, internal to a surgical site, internal to a target tissue, internal to an organ, internal to a cavity (e.g. an abdominal cavity or a bladder cavity or a cistern or a CSF space, and/or internal to a vascular lumen), internal to a vascular bifurcation, internal to a bowel, internal to a small intestine, internal to a stomach, internal to a biliary structure, internal to a urethra and or urether, internal to a renal pelvis, external to the patient's skin, external to a surgical site, external to a target tissue, external to an organ, external to a cavity (e.g. an abdominal cavity or a bladder cavity or a cistern or a CSF space, and/or external to a vascular lumen), external to a vascular bifurcation, external to a bowel, external to a small intestine, external to a stomach, external to a biliary structure, external to a urethra and or urether, and/or external to a renal pelvis. In some embodiments, the position and/or orientation and/or coordinates of the one or more 3D scanners can be tracked using any of the registration and/or tracking methods described in the specification, e.g. direct tracking using optical imaging systems and/or a 3D scanner(s), in any of the foregoing locations and/or tissues and/or organs and any other location and/or tissue and/or organ mentioned in the specification or known in the art. Tracking of the one or more 3D scanners can, for example, be advantageous when the one or more 3D scanners are integrated into or attached to an instrument, an arthroscope, an endoscope, and/or when they are located internal to any structures, e.g. inside a joint or a cavity or a lumen. In some embodiments registration and tracking can be performed using depth sensors, e.g. integrated or attached to the OHMD, as described, for example, in US 2017-0258526, entitled “Devices and Methods for Surgery”, filed Mar. 10, 2017 and U.S. Provisional Application No. 62/556,867, entitled “Devices and Methods for Surgery”, filed Sep. 11, 2017, which are incorporated herein by reference in their entirety.

In some embodiments, one or more image and/or video capture system, video capture system, image or video capture system, image and/or video capture system, and/or optical imaging system can be used in conjunction with one or more 3D scanners, e.g. in any of the foregoing locations and/or tissues and/or organs and any other location and/or tissue and/or organ described in the specification or known in the art.

With surgical navigation, a first virtual instrument can be displayed on a computer monitor which is a representation of a physical instrument tracked with navigation markers, e.g. infrared or RF markers, and the position and/or orientation of the first virtual instrument can be compared with the position and/or orientation of a corresponding second virtual instrument generated in a virtual surgical plan. Thus, with surgical navigation the positions and/or orientations of the first and the second virtual instruments are compared.

Aspects of the invention relate to devices, systems and methods for positioning a virtual path, virtual plane, virtual tool, virtual surgical instrument or virtual implant component in a mixed reality environment using a head mounted display device, optionally coupled to one or more processing units.

With guidance in mixed reality environment, a virtual surgical guide, tool, instrument or implant can be superimposed onto a physical joint, spine or surgical site. Further, the physical guide, tool, instrument or implant can be aligned with the virtual surgical guide, tool, instrument or implant displayed or projected by the OHMD. Thus, guidance in mixed reality environment does not need to use a plurality of virtual representations of the guide, tool, instrument or implant and does not need to compare the positions and/or orientations of the plurality of virtual representations of the virtual guide, tool, instrument or implant. In various embodiments, the OHMD can display one or more of a virtual surgical tool, virtual surgical instrument including a virtual surgical guide or virtual cut block, virtual trial implant, virtual implant component, virtual implant or virtual device, predetermined start point, predetermined start position, predetermined start orientation or alignment, predetermined intermediate point(s), predetermined intermediate position(s), predetermined intermediate orientation or alignment, predetermined end point, predetermined end position, predetermined end orientation or alignment, predetermined path, predetermined plane, predetermined cut plane, predetermined contour or outline or cross-section or surface features or shape or projection, predetermined depth marker or depth gauge, predetermined stop, predetermined angle or orientation or rotation marker, predetermined axis, e.g. rotation axis, flexion axis, extension axis, predetermined axis of the virtual surgical tool, virtual surgical instrument including virtual surgical guide or cut block, virtual trial implant, virtual implant component, implant or device, estimated or predetermined non-visualized portions for one or more devices or implants or implant components or surgical instruments or surgical tools, and/or one or more of a predetermined tissue change or alteration.

Any of a position, location, orientation, alignment, direction, speed of movement, force applied of a surgical instrument or tool, virtual and/or physical, can be predetermined using, for example, pre-operative imaging studies, pre-operative data, pre-operative measurements, intra-operative imaging studies, intra-operative data, and/or intra-operative measurements.

Any of a position, location, orientation, alignment, sagittal plane alignment, coronal plane alignment, axial plane alignment, rotation, slope of implantation, angle of implantation, flexion of implant component, offset, anteversion, retroversion, and position, location, orientation, alignment relative to one or more anatomic landmarks, position, location, orientation, alignment relative to one or more anatomic planes, position, location, orientation, alignment relative to one or more anatomic axes, position, location, orientation, alignment relative to one or more biomechanical axes, position, location, orientation, alignment relative to a mechanical axis of a trial implant, an implant component or implant, virtual and/or physical, can be predetermined using, for example, pre-operative imaging studies, pre-operative data, pre-operative measurements, intra-operative imaging studies, intra-operative data, and/or intra-operative measurements. Intra-operative measurements can include measurements for purposes of registration, e.g. of a joint, a spine, a surgical site, a bone, a cartilage, an OHMD, a surgical tool or instrument, a trial implant, an implant component or an implant.

In some embodiments, multiple coordinate systems can be used instead of a common or shared coordinate system. In this case, coordinate transfers can be applied from one coordinate system to another coordinate system, for example for registering the OHMD, live data of the patient including the surgical site, virtual instruments and/or virtual implants and physical instruments and physical implants.

Optical Head Mounted Displays

In some embodiments of the invention, one or more optical head-mounted displays can be used. An optical head-mounted display (OHMD) can be a wearable display that has the capability of projecting images as well as allowing the user to see through it. Various types of OHMD's can be used in order to practice the invention. These include curved mirror or curved combiner OHMD's as well as wave-guide or light-guide OHMD's. The OHMD's can optionally utilize diffraction optics, holographic optics, polarized optics, and reflective optics.

Traditional input devices that can be used with the OHMD's include, but are not limited to touchpad or buttons, smartphone controllers, speech recognition, and gesture recognition. Advanced interfaces are possible, e.g. a brain—computer interface.

Optionally, a computer or server or a workstation can transmit data to the OHMD. The data transmission can occur via cable, Bluetooth, WiFi, optical signals and any other method or mode of data transmission known in the art. The OHMD can display virtual data, e.g. virtual data of the patient, in uncompressed form or in compressed form. Virtual data of a patient can optionally be reduced in resolution when transmitted to the OHMD or when displayed by the OHMD.

When virtual data are transmitted to the OHMD, they can be in compressed form during the transmission. The OHMD can then optionally decompress them so that uncompressed virtual data are being displayed by the OHMD.

Alternatively, when virtual data are transmitted to the OHMD, they can be of reduced resolution during the transmission, for example by increasing the slice thickness of image data prior to the transmission. The OHMD can then optionally increase the resolution, for example by re-interpolating to the original slice thickness of the image data or even thinner slices so that virtual data with resolution equal to or greater than the original virtual data or at least greater in resolution than the transmitted data are being displayed by the OHMD. In some embodiments, the OHMD can transmit data back to a computer, a server or a workstation. Such data can include, but are not limited to:
Positional, orientational or directional information about the OHMD or the operator or surgeon wearing the OHMD
Changes in position, orientation or direction of the OHMD
Data generated by one or more IMU's
Data generated by markers (radiofrequency, optical, light, other) attached to, integrated with or coupled to the OHMD
Data generated by a surgical navigation system attached to, integrated with or coupled to the OHMD
Data generated by an image and/or video capture system attached to, integrated with or coupled to the OHMD
Parallax data, e.g. using two or more image and/or video capture systems attached to, integrated with or coupled to the OHMD, for example one positioned over or under or near the left eye and a second positioned over or under or near the right eye
Distance data, e.g. parallax data generated by two or more image and/or video capture systems evaluating changes in distance between the OHMD and a surgical field or an object
Motion parallax data
Data related to calibration or registration phantoms (see other sections of this specification)
Any type of live data of the patient captured by the OHMD including image and/or video capture systems attached to, integrated with or coupled to the OHMD
   For example, alterations to a live surgical site
   For example, use of certain surgical instruments detected by the image and/or video capture system
   For example, use of certain medical devices or trial implants detected by the image and/or video capture system
Any type of modification to a surgical plan
   Portions or aspects of a live surgical plan
   Portions or aspects of a virtual surgical plan

Radiofrequency tags used throughout the embodiments can be of active or passive kind with or without a battery.

Exemplary optical head mounted displays include the ODG R-7, R-8 and R-8 smart glasses from ODG (Osterhout Group, San Francisco, Calif.), the NVIDIA 942 3-D vision wireless glasses (NVIDIA, Santa Clara, Calif.) and the Microsoft HoloLens (Microsoft, Redmond, Wis.).

The Microsoft HoloLens is manufactured by Microsoft. It is a pair of augmented reality smart glasses. Hololens can use the Windows 10 operating system. The front portion of the Hololens includes, among others, sensors, related hardware, several cameras and processors. The visor includes a pair of transparent combiner lenses, in which the projected images are displayed. The HoloLens can be adjusted for the interpupillary distance (IPD) using an integrated program that recognizes gestures. A pair of speakers is also integrated.

The speakers do not exclude external sounds and allow the user to hear virtual sounds. A USB 2.0 micro-B receptacle is integrated. A 3.5 mm audio jack is also present. The HoloLens has an inertial measurement unit (IMU) with an accelerometer, gyroscope, and a magnetometer, four environment mapping sensors/cameras (two on each side), a depth camera with a 120°×120° angle of view, a 2.4-megapixel photographic video camera, a four-microphone array, and an ambient light sensor.

Hololens has an Intel Cherry Trail SoC containing the CPU and GPU. HoloLens includes also a custom-made Microsoft Holographic Processing Unit (HPU). The SoC and the HPU each have 1 GB LPDDR3 and share 8 MB SRAM, with the SoC also controlling 64 GB eMMC and running the Windows 10 operating system. The HPU processes and integrates data from the sensors, as well as handling tasks such as spatial mapping, gesture recognition, and voice and speech recognition. HoloLens includes a IEEE 802.11ac Wi-Fi and Bluetooth 4.1 Low Energy (LE) wireless connectivity. The headset uses Bluetooth LE and can connect to a Clicker, a finger-operating input device that can be used for selecting menus and functions.

A number of applications are available for Microsoft Hololens, for example a catalogue of holograms, HoloStudio, a 3D modelling application by Microsoft with 3D print capability, Autodesk Maya 3D creation application' FreeForm, integrating HoloLens with the Autodesk Fusion 360 cloud-based 3D development application, and others.

HoloLens utilizing the HPU can employ sensual and natural interface commands—voice, gesture, and gesture. Gaze commands, e.g. head-tracking, allows the user to bring application focus to whatever the user is perceiving. Any virtual application or button can be are selected using an air tap method, similar to clicking a virtual computer mouse. The tap can be held for a drag simulation to move a display. Voice commands can also be utilized.

The HoloLens shell utilizes many components or concepts from the Windows desktop environment. A bloom gesture for opening the main menu is performed by opening one's hand, with the palm facing up and the fingers spread. Windows can be dragged to a particular position, locked and/or resized. Virtual windows or menus can be fixed at locations or physical objects. Virtual windows or menus can move with the user or can be fixed in relationship to the user. Or they can follow the user as he or she moves around. The Microsoft HoloLens App for Windows 10 PC's and Windows 10 Mobile devices can be used by developers to run apps and to view live stream from the HoloLens user's point of view, and to capture augmented reality photos and videos.

Almost all Universal Windows Platform apps can run on Hololens. These apps can be projected in 2D. Select Windows 10 APIs are currently supported by HoloLens. Hololens apps can also be developed on Windows 10 PC's. Holographic applications can use Windows Holographic APIs. Unity (Unity Technologies, San Francisco, Calif.) and Vuforia (PTC, Inc., Needham, Mass.) are some apps that can be utilized. Applications can also be developed using DirectX and Windows API's.

Computer Graphics Viewing Pipeline

In some embodiments of the invention, the optical head mount display uses a computer graphics viewing pipeline that consists of the following steps to display 3D objects or 2D objects positioned in 3D space or other computer generated objects and models:

1. Registration

2. View projection

Registration:

The different objects to be displayed by the OHMD computer graphics system (for instance virtual anatomical models, virtual models of instruments, geometric and surgical references and guides) are initially all defined in their own independent model coordinate system. During the registration process, spatial relationships between the different objects are defined, and each object is transformed from its own model coordinate system into a common global coordinate system. Different techniques that are described below can be applied for the registration process.

For augmented reality OHMD's that superimpose computer-generated objects with live views of the physical environment, the global coordinate system is defined by the environment. A process called spatial mapping, described below, creates a computer representation of the environment that allows for merging and registration with the computer-generated objects, thus defining a spatial relationship between the computer-generated objects and the physical environment.

View Projection:

Once all objects to be displayed have been registered and transformed into the common global coordinate system, they are prepared for viewing on a display by transforming their coordinates from the global coordinate system into the view coordinate system and subsequently projecting them onto the display plane. This view projection step uses the viewpoint and view direction to define the transformations applied in this step. For stereoscopic displays, such as OHMDs, two different view projections can be used, one for the left eye and the other one for the right eye. For augmented reality OHMD's the position of the viewpoint and view direction relative to the physical environment can be known in order to correctly superimpose the computer-generated objects with the physical environment. As the viewpoint and view direction change, for example due to head movement, the view projections are updated so that the computer-generated display follows the new view.

Positional Tracking Systems

In certain embodiments of the invention, the position and/or orientation of the OHMD can be tracked. For example, in order to calculate and update the view projection of the computer graphics view pipeline as described in the previous section and to display the computer generated overlay images in the OHMD, the view position and direction needs to be known.

Different methods to track the OHMD can be used. For example, the OHMD can be tracked using outside-in tracking. For outside-in tracking, one or more external sensors or cameras can be installed in a stationary location, e.g. on the ceiling, the wall or on a stand. The sensors or camera capture the movement of the OHMD, for example through shape detection or markers attached to the OHMD or the user's head. The sensor data or camera image is typically processed on a central computer to which the one or more sensors or cameras are connected. The tracking information obtained on the central computer is then used to compute the view projection. The view projection can be computed on the central computer or on the OH MD.

In certain embodiments, the inside-out tracking method is employed. One or more sensors or cameras are attached to the OHMD or the user's head or integrated with the OHMD. The sensors or cameras can be dedicated to the tracking functionality. In other embodiments, the data collected by the sensors or cameras is used for positional tracking as well as for other purposes, e.g. image recording or spatial mapping. Information gathered by the sensors and/or cameras is used to determine the OHMD's position and orientation in 3D space. This can be done, for example, by detecting optical, infrared or electromagnetic markers attached to the external environment. Changes in the position of the markers relative to the sensors or cameras are used to continuously determine the position and orientation of the OHMD. Data processing of the sensor and camera information is typically performed by a mobile processing unit attached to or integrated with the OHMD, which allows for increased mobility of the OHMD user as compared to outside-in tracking. Alternatively, the data can be transmitted to and processed on the central computer.

Inside-out tracking can also utilize markerless techniques. For example, spatial mapping data acquired by the OHMD sensors can be aligned with a virtual model of the environment, thus determining the position and orientation of the OHMD in the 3D environment. Alternatively or additionally, information from inertial measurement units can be used.

Potential advantages of inside-out tracking include greater mobility for the OHMD user, a greater field of view not limited by the viewing angle of stationary cameras and reduced or eliminated problems with marker occlusion.

Eye Tracking Systems

The present invention provides for methods of using the human eye including eye movements and lid movements as well as movements induced by the peri-orbital muscles for executing computer commands. The invention provides also for methods of executing computer commands by way of facial movements and movements of the head.

Command execution induced by eye movements and lid movements as well as movements induced by the peri-orbital muscles, facial movements and head movements can be advantageous in environments where an operator does not have his hands available to type on a keyboard or to execute commands on a touchpad or other hand—computer interface. Such situations include, but are not limited, to industrial applications including automotive and airplane manufacturing, chip manufacturing, medical or surgical procedures and many other potential applications.

In some embodiments, the optical head mount display can include an eye tracking system. Different types of eye tracking systems can be utilized. The examples provided below are in no way thought to be limiting to the invention. Any eye tracking system known in the art now can be utilized.

Eye movement can be divided into fixations and saccades—when the eye gaze pauses in a certain position, and when it moves to another position, respectively. The resulting series of fixations and saccades can be defined as a scan path. The central one or two degrees of the visual angle provide most of the visual information; the input from the periphery is less informative. Thus, the locations of fixations along a scan path show what information locations were processed during an eye tracking session, for example during a surgical procedure.

Eye trackers can measure rotation or movement of the eye in several ways, for example via measurement of the movement of an object (for example, a form of contact lens) attached to the eye, optical tracking without direct contact to the eye, and measurement of electric potentials using electrodes placed around the eyes.

If an attachment to the eye is used, it can, for example, be a special contact lens with an embedded mirror or magnetic field sensor. The movement of the attachment can be measured with the assumption that it does not slip significantly as the eye rotates. Measurements with tight fitting contact lenses can provide very accurate measurements of eye movement. Additionally, magnetic search coils can be utilized which allow measurement of eye movement in horizontal, vertical and torsion direction.

Alternatively, non-contact, optical methods for measuring eye motion can be used. With this technology, light, optionally infrared, can be reflected from the eye and can be sensed by an optical sensor or a video camera. The information can then be measured to extract eye rotation and/or movement from changes in reflections. Optical sensor or video-based eye trackers can use the corneal reflection (the so-called first Purkinje image) and the center of the pupil as features to track, optionally over time. A more sensitive type of eye tracker, the dual-Purkinje eye tracker, uses reflections from the front of the cornea (first Purkinje image) and the back of the lens (fourth Purkinje image) as features to track. An even more sensitive method of tracking is to image features from inside the eye, such as the retinal blood vessels, and follow these features as the eye rotates and or moves. Optical methods, particularly those based on optical sensors or video recording, can be used for gaze tracking. In some embodiments, optical or video-based eye trackers can be used. A camera focuses on one or both eyes and tracks their movement as the viewer performs a function such as a surgical procedure. The eye-tracker can use the center of the pupil for tracking. Infrared or near-infrared non-collimated light can be utilized to create corneal reflections. The vector between the pupil center and the corneal reflections can be used to compute the point of regard on a surface or the gaze direction. Optionally, a calibration procedure can be performed at the beginning of the eye tracking.

Bright-pupil and dark-pupil eye tracking can be employed. Their difference is based on the location of the illumination source with respect to the optics. If the illumination is co-axial relative to the optical path, then the eye acts is retroreflective as the light reflects off the retina creating a bright pupil effect similar to a red eye. If the illumination source is offset from the optical path, then the pupil appears dark because the retroreflection from the retina is directed away from the optical sensor or camera.

Bright-pupil tracking can have the benefit of greater iris/pupil contrast, allowing more robust eye tracking with all iris pigmentation. It can also reduce interference caused by eyelashes. It can allow for tracking in lighting conditions that include darkness and very bright lighting situations.

The optical tracking method can include tracking movement of the eye including the pupil as described above. The optical tracking method can also include tracking of the movement of the eye lids and also periorbital and facial muscles.

In some embodiments, the eye-tracking apparatus is integrated in an optical head mounted display. In some embodiments, head motion can be simultaneously tracked, for example using a combination of accelerometers and gyroscopes forming an inertial measurement unit (see below).

In some embodiments, electric potentials can be measured with electrodes placed around the eyes. The eyes generate an electric potential field, which can also be detected if the eyes are closed. The electric potential field can be modelled to be generated by a dipole with the positive pole at the cornea and the negative pole at the retina. It can be measured by placing two electrodes on the skin around the eye. The electric potentials measured in this manner are called an electro-oculogram.

If the eyes move from the center position towards the periphery, the retina approaches one electrode while the cornea approaches the opposing one. This change in the orientation of the dipole and consequently the electric potential field results in a change in the measured electro-oculogram signal. By analyzing such changes eye movement can be assessed. Two separate movement directions, a horizontal and a vertical, can be identified. If a posterior skull electrode is used, a EOG component in radial direction can be measured. This is typically the average of the EOG channels referenced to the posterior skull electrode. The radial EOG channel can measure saccadic spike potentials originating from extra-ocular muscles at the onset of saccades.

EOG can be limited for measuring slow eye movement and detecting gaze direction. EOG is, however, well suited for measuring rapid or saccadic eye movement associated with gaze shifts and for detecting blinks. Unlike optical or video-based eye-trackers, EOG allows recording of eye movements even with eyes closed. The major disadvantage of EOG is its relatively poor gaze direction accuracy compared to an optical or video tracker. Optionally, both methods, optical or video tracking and EOG, can be combined in select embodiments of the invention.

A sampling rate of 15, 20, 25, 30, 50, 60, 100, 120, 240, 250, 500, 1000 Hz or greater can be used. Any sampling frequency is possibly. In many embodiments, sampling rates greater than 30 Hz will be preferred.

One or more computer processors can be used for registration, view projection, tracking, measurements, computation of adjustments, corrections or compensation needed. The processor can receive data for example from a camera image or a 3D scanner. The processor processes the data representing the image, optionally overlaying computer graphics. The processor can receive data representing the image from an external source, e.g. a camera, an image capture system or a video system or a 3D scanner integrated into, attached to or separate from the OHMD. The external source can include a memory in which the image is stored. The memory can also be included in the OHMD. The memory can be operatively coupled to the processor. With the OHMD, the left and right displays can provide a horizontal field of view for the user that can be greater, for example, than 30, 40, 50 or more degrees. Each of the left and right displays can have different aspect ratios, e.g. 16/9, Data can be movie data. A user nterface can be provided that includes one or more controls for providing instructions from the user to the processor about what calibrations or registrations to perform, identifying a predetermined, preferred or first position of the OHMD unit and any attached cameras, video or image capture systems and/or 3D scanners relative to the user's face, eyes, sclera, cornea, lens and/or pupil.

Accuracy of Virtual Displays and Virtual Data Displayed

The accuracy of virtual data displayed by optical head mount displays in relationship to live data can be affected by the position, orientation, alignment and/or projection plane including projection plane curvature of the optical head mount display and any changes thereof during a viewing session. It is an objective of the current invention to address, correct, reduce or avoid potential inaccuracies of the display.

In some embodiments, the OHMD display including its position, orientation and/or alignment and/or projection plane including projection plane curvature can be adjusted based on the facial geometry of the surgeon or the operator and/or the seating, position, orientation and/or alignment of the OHMD on the head of the surgeon or operator. Such adjustments can be applied to both stereoscopic and non-stereoscopic displays. Adjustments can be performed at the beginning of an activity or, optionally, during an activity. Adjustments can be singular or multiple.

Movement of the OHMD unit on the user's head during or prior to an activity, e.g. after an initial registration of the OHMD on the user's head, can lead to errors. Such errors include, for example, distance errors, angle errors, dimensional errors, shape errors, as well as linear and non-linear distortion errors.

Error Sources

Potential errors sources include, but are not limited to, the following:

TABLE 1: Movement of the OHMD frame and/or display:
superior translation
inferior translation
left lateral translation (possibly with rotation in the axial plane)
right lateral translation (possibly with rotation in the axial plane)
superior tilting or vertical/sagittal plane rotation (e.g. inferior rim/edge/display border of OHMD more anterior than superior rim/edge/display border of OHMD)
inferior tilting or vertical/sagittal plane rotation (e.g. superior rim/edge/display border of OHMD more anterior than inferior rim/edge/display border of OHMD)
left-right tilting or coronal/frontal plane rotation (e.g. left rim/edge/display border of OHMD superior to right rim/edge/display border of OHMD)
right-left tilting or coronal/frontal plane rotation (e.g. right rim superior to left rim)
all possible combinations of two or more of the foregoing.

In surgical or medical procedures and any other activities or interactions between virtual data and real world that require high precision in registering virtual data and live data, e.g. in gaming, industrial, military, aircraft, automobile or other applications, any of the foregoing error sources can result in a mis-registration or misaligned display or distorted display of the virtual data relative to the live data, such as in surgical or medical procedures a mis-registration or misaligned display or distorted display of virtual anatomy, virtual surgical plan, projected path(s), projected endpoint(s), projected planes, projected cut planes, virtual surgical instruments or virtual medical devices or implants in relationship to the live anatomy, the live target tissue and/or the live patient. The different sources of error can lead to a distance error, an angle error as well as linear and non-linear distortion errors. The accuracy of any of the following OHMD display items listed in Table 2 can be adversely affected in this manner.

TABLE 2: List of virtual items that can be adversely affected with distance, angle, orientation, distortion or other errors by movement of the OHMD on the user's or operator's head, e.g. relative to the eyes, pupils, or face:
Predetermined/projected/intended start point
Predetermined/projected/intended start position
Predetermined/projected/intended start orientation/alignment
Predetermined/projected/intended intermediate point(s)
Predetermined/projected/intended intermediate position(s)
Predetermined/projected/intended intermediate orientation/alignment
Predetermined/projected/intended endpoint
Predetermined/projected/intended end position
Predetermined/projected/intended plane(s)
Predetermined/projected/intended cut plane(s)
Predetermined/projected/intended intermediate orientation/alignment
Predetermined/projected/intended path
Predetermined/projected/intended axis
Predetermined/projected/intended contour/outline/cross-section/surface features/shape/projection
Predetermined/projected/intended depth marker or depth gauge, optionally corresponding to a physical depth marker or depth gauge on the actual surgical tool, surgical instrument, trial implant, implant component, implant or device
Predetermined/projected/intended angle/orientation/rotation marker, optionally corresponding to a physical angle/orientation/rotation marker on the actual surgical tool, surgical instrument, trial implant, implant component, implant or device
Predetermined/projected/intended axis, e.g. rotation axis, flexion axis, extension axis
Predetermined/projected/intended axis of the actual surgical tool, surgical instrument, trial implant, implant component, implant or device, e.g. a long axis, a horizontal axis, an orthogonal axis, a drilling axis, a pinning axis, a cutting axis
Estimated/predetermined/projected/intended non-visualized portions of device/implant/implant component/surgical instrument/surgical tool, e.g. using image capture or markers attached to device/implant/implant component/surgical instrument/surgical tool with known geometry
Predetermined/projected/intended/estimated virtual tissue change/alteration
Predetermined/projected/intended direction of movement
Predetermined/projected/intended flight path
Predetermined/projected/intended position
Predetermined/projected/intended orientation
Predetermined/projected/intended alignment
Predetermined/projected/intended superimposition with physical objects, e.g. in a patient or on an instrument panel
Predetermined/projected/intended displacement
Predetermined/projected/intended dimensions
Predetermined/projected/intended perspective
Perspective view of any of foregoing and other virtual items, objects or entities corresponding to viewer's or operator's perspective view of physical objects
View angle of any of foregoing and other virtual items, objects or entities corresponding to viewer's or operator's perspective view of physical objects
View distance of any of foregoing and other virtual items, objects or entities corresponding to viewer's or operator's perspective view of physical objects

The purpose of the present invention and the embodiments herein is to reduce, avoid or correct, at least partially, any such errors affecting any of the foregoing in Table 2. In addition, the purpose of the present invention and the embodiments herein is also to reduce or avoid user discomfort related to differences in oculomotor cues, e.g. stereopsis and vergence or focus cues and accommodation, and visual cues, e.g. binocular disparity and retinal blur, processed by the brain for physical images or data and virtual images or data. By reducing or avoiding any of the error sources as tabulated, for example, in Table 1, or by adjusting or compensating for error sources, user discomfort related to differences in oculomotor cues and visual cues between physical images or data and virtual images or data processed by the brain can be reduced or avoided. For example, by determining a predetermined or preferred or first position of the display of an OHMD unit for a user, e.g. during a registration and calibration process, and by reducing or avoiding any of the foregoing error sources in Table 1 or by adjusting or compensating for error sources, e.g. by moving the OHMD display or by maintaining the OHMD display at the or near the predetermined or preferred or first position, user discomfort related to differences in oculomotor cues and visual cues between physical images or data and virtual images or data processed by the brain can be reduced or avoided. Calibration or registration can be performed once, for example during an initial use of an OHMD by a user. Calibration or registration can also be performed at each subsequent use. Predetermined, preferred or first positions can be stored for each use. Optionally, an average predetermined, preferred or first position can be determined, which can be used when a user decides to skip a calibration or registration, for example before the next use of the OHMD, for example as a means of saving set-up time.

Measurements of Inter-Ocular Distance, Pupil-to-Display Distance, Pupil-to-Retina Distance, and Retina-to-Display Distance; Measurement of Distance(s) Between Select Facial Features and an OHMD

In some embodiments, the user's/operator's/surgeon's inter-ocular distance can be measured, for example from the left pupil to the right pupil. In addition, the distance from the pupil to the display can be measured, which can vary, for example, based on the surgeon's or operator's nasal geometry or the contact points of the OHMD with the surgeon's or operator's nose, ears and head including temporal and parietal regions. The distance from the pupil to the retina and the distance from the display to the retina can also be measured. These measurements can be performed separately for the left eye and the right eye. These measurements can be performed using any technique known in the art or developed in the future, e.g. using standard techniques employed by ophthalmologists. The data generated by these and similar measurements can be entered into a database or into a user profile. Optionally, user profiles can be extracted from a database.

The inter-ocular distance as well as the pupil-to-display distance can be measured using, for example, physical measurement tools including a tape measure or a ruler or tools known in the art including optical tools and, for example, used by optometrists or ophthalmologists. The inter-ocular distance, the pupil-to-display distance, the pupil-to-retina distance, the retina-to-display distance, the sclera-to-display distance, the cornea-to-display distance, the diameter of the cornea, iris, pupil (for fixed or variable or predefined/preset light settings), and sclera can also be measured using optical means, e.g. an image and/or video capture system integrated into, attached to or separate from the OHMD, or any other means known in the art or developed in the future for performing such measurements. The distances and/or dimensions and/or shape and/or geometry between or of any of the following can be measured: Conjunctiva, cornea, anterior chamber, iris, pupil, sclera, posterior chamber, lens ciliary body, vitreous body, retina, macula, optic nerve, and the frame of the OHMD unit or other portions of the OHMD unit.

The optical head mounted display unit can be registered in a coordinate system, e.g. a common coordinate system. A target area of activity, e.g. a surgical site or surgical field, as well as anatomic or pathologic areas, imaging studies and other test or measurement data can be registered in the coordinate system, e.g. the common coordinate system. The user's or surgeons face, head, head or facial features, including, but not limited to, the nose, ears, cheeks, forehead, eye brows, left and/or right zygomatic arches, maxilla, mandible, lips, eyes, eye lids, pupil, sclera, cornea, conjunctiva, and lens can be registered in the coordinate system, e.g. the common coordinate system. Tools, instruments, devices, implants, gaming gear, industrial equipment and other types of equipment, tools, instruments or devices can also be registered in the coordinate system, e.g. the common coordinate system.

The distances, angles, and/or geometry between the frame of the OHMD unit or other portions of the OHMD unit, including, for example, the display, and one or more facial features or head features, including, but not limited to, the nose, ears, cheeks, forehead, eye brows, left and/or right zygomatic arches, maxilla, mandible, lips, eyes, eye lids, pupil, sclera, cornea, conjunctiva, and lens, can be measured. The measuring can be at the time of an initial registration of the OHMD unit in relationship to the user's face or head and it can be intermittently thereafter, e.g. every 10 min, 5 min, 3 min, 2 min, 1 min, 30 seconds, 15 seconds, 10 seconds, 5 seconds, 3 seconds, 2 seconds, 1 second, 0.5 seconds, 0.2 seconds, 0.1 seconds or any other time interval. The measuring can also be continuous.

The measured data can be used for adjusting one or more of a position, orientation or alignment of the display of the optical head mounted display unit to adjust or compensate for the measured movement of the optical head mounted display unit in relationship to the one or more head or facial features, eye or pupil. The adjusting of the one or more of a position, orientation or alignment of the display can be used to maintain the display substantially in at least one of the position, orientation or alignment it had relative to the user's eye or pupil or facial or head features at the time of the registration. The left display of the OHMD unit can be maintained substantially centered over the left eye of the user and the right display of the OHMD unit can be maintained substantially centered over the right eye of the user. The left display of the OHMD unit can be maintained substantially centered over the left pupil of the user and the right display of the OHMD unit can be maintained substantially centered over the right pupil of the user.

The optical head mounted display can be a see-through optical head mounted display. The optical head mounted display can be a non-see through, virtual reality optical head mounted display. When a non-see through, virtual reality optical head mounted display is used, the live data of the target area of activity can be obtained using one or more cameras; the images or video data obtained by the cameras can then be displayed by the non-see through virtual reality optical head mounted display and, optionally, virtual data, e.g. for guiding an instrument or a device in the user's hand, can be superimposed or co-displayed.

An image and/or video capture system including, for example, one or more cameras, can be used for measuring distances, dimensions, shape and/or geometry of structures such as the eye or pupil and can also be used for eye tracking. Optionally, one image and/or video capture system can be positioned over or in the vicinity of the left eye and one image and/or video capture system can be positioned over or in the vicinity of the right eye. Each image and/or video capture system can have one, two or more cameras, e.g. one, two or more cameras positioned near the left eye and/or the right eye pointing at the eye and/or one, two or more cameras positioned near the left eye and/or the right eye pointing at the target anatomy or target area.

In some embodiments, one or more cameras can be positioned on the OHMD frame superior to the left eye pointing at the eye and one or more cameras can be positioned on the OHMD frame superior to the right eye pointing at the eye. One or more cameras can be positioned on the OHMD frame inferior to the left eye pointing at the eye and one or more cameras can be positioned on the OHMD frame inferior to the right eye pointing at the eye. One or more cameras can be positioned on the OHMD frame medial to the left eye pointing at the eye and one or more cameras can be positioned on the OHMD frame medial to the right eye pointing at the eye. One or more cameras can be positioned on the OHMD frame lateral to the left eye pointing at the eye and one or more cameras can be positioned on the OHMD frame lateral to the right eye pointing at the eye. Any position of cameras is possible. Cameras can capture light from a spectrum visible to the human eye. Cameras can also capture light from a spectrum not visible to the human eye, e.g. infrared (IR) light or ultraviolet (UV) light.

In some embodiments, one or more light emitters can be positioned on the OHMD frame superior to the left eye pointing at the eye and one or more light emitters can be positioned on the OHMD frame superior to the right eye pointing at the eye. One or more light emitters can be positioned on the OHMD frame inferior to the left eye pointing at the eye and one or more light emitters can be positioned on the OHMD frame inferior to the right eye pointing at the eye. One or more light emitters can be positioned on the OHMD frame medial to the left eye pointing at the eye and one or more light emitters can be positioned on the OHMD frame medial to the right eye pointing at the eye. One or more light emitters can be positioned on the OHMD frame lateral to the left eye pointing at the eye and one or more light emitters can be positioned on the OHMD frame lateral to the right eye pointing at the eye. Any position of light emitters is possible. Light emitters can emit light from a spectrum visible to the human eye. Light emitters can also emit light from a spectrum not visible to the human eye, e.g. infrared (IR) light or ultraviolet (UV) light. The light emitted from the light emitters can be captured or measured by one or more cameras, e.g. any of the foregoing cameras, and the reflection including, for example, the reflection angle and/or the light dispersion and/or the wavelength of the reflected light and/or the intensity of the reflected light can be used to determine or estimate, for example, a distance from a light emitter and/or camera to the pupil or a portion of the lens or a conjunctiva, a cornea, an anterior chamber, an iris, a pupil, a sclera, a posterior chamber, a lens ciliary body, a vitreous body, a retina, a macula, and/or an optic nerve.

One or more infrared emitters can be installed around the eye. For example, one or more infrared emitters can be integrated into or attached to the OHMD. The infrared emitter can be an LED. One or more infrared emitters can, for example, be located superior to the eye, medial to the eye, lateral to the eye or inferior to the eye or at oblique angles relative to the eye. The one or more infrared emitters can be oriented to point at the eye, e.g. the cornea, the sclera, the lens or the pupil. The one or more infrared emitters can be oriented at other structures of the eye, e.g. the retina. The one or more infrared emitters can be oriented at an angle of 90 degrees to the cornea, the sclera, the lens, the pupil or the retina. The one or more infrared emitters can be oriented at an angle other than 90 degrees to the cornea, the sclera, the lens, the pupil or the retina, e.g. 10, 20, 30, 40, 50 or 60 degrees. Any other angle is possible. The angle can be selected to facilitate reflection of infrared light from the cornea, the sclera, the lens, the pupil, the retina or other structure of the eye. The angle can be selected to facilitate detection of reflected infrared light from the cornea, the sclera, the lens, the pupil, the retina or other structure of the eye by an infrared camera. The infrared camera can be located in a position, for example, opposite the infrared emitter and at an angle that is similar, but inverse, to the angle of the infrared emitter to the cornea, the sclera, the lens, the pupil, the retina or other structure of the eye to facilitate detection of reflected infrared light. For example, the infrared emitter can be located medial to the eye with an angle of 20 degrees relative to a frontal plane of the face, while the infrared camera can be located lateral to the eye with an angle of −20 degrees relative to the frontal plane of the face. The infrared emitter can be located superior to the eye with an angle of 30 degrees relative to a frontal plane of the face, while the infrared camera can be located inferior to the eye with an angle of −30 degrees relative to the frontal plane of the face. Someone skilled in the art will readily recognize other camera and emitter configurations, orientations and arrangements.

Optionally, the user can look initially at a fixed structure or a reference structure. The fixed structure or reference structure can be at a defined angle and distance relative to the eye. For example, it can be in the user's far field, e.g. at a distance of 3, 5, 10, 15, 20 or more meters with an angle substantially perpendicular to the eye and/or lens. The fixed structure or reference structure can be in the near field, e.g. at a distance of 15, 20, 30, 40, 50, 60, 70, 80, 90, 100, 120, 150 cm with an angle 10, 20, 30, 40, 50, 60 or other degrees inferior to the long or perpendicular axis of the eye and/or lens. A reference scan or calibration scan can be obtained by emitting light and detecting light reflected from the cornea, sclera, lens, pupil, retina or other eye structure while the user is looking at the reference structure. Multiple reference or calibration scans can be obtained in this manner, for example, for far field and near field fixed or reference structures. The distance and angle of the fixed or reference structure to the eye can be known for these reference or calibration scans, which can give an indication of the degree of accommodation by the eye for the different two or more distances.

In some embodiments, the reflected light can be used to measure the sphericity or curvature of the lens and, with that, to estimate the degree of accommodation of the eye. For example, if the sphericity or curvature of the lens changes between near field and far field reference of calibration scans, the angle of the reflected light can also change as a function of the change in radius or curvature of the lens. The change in angle of the reflected light can be measured by the one or more cameras, and can be used by a computer processor to estimate the degree of accommodation.

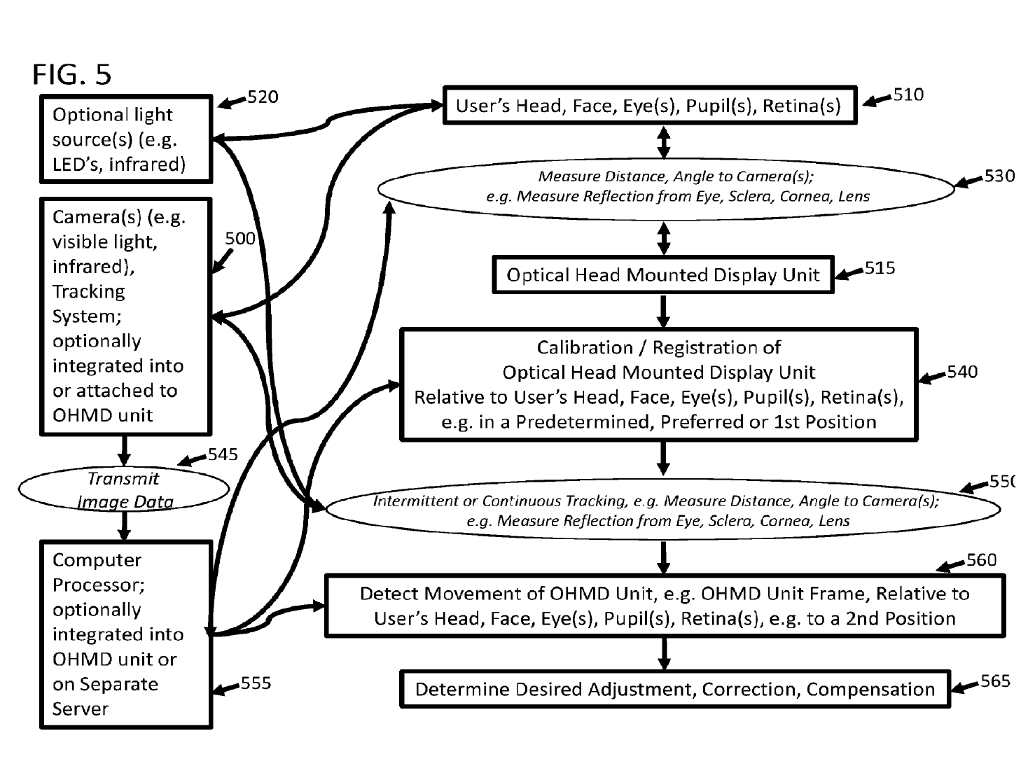

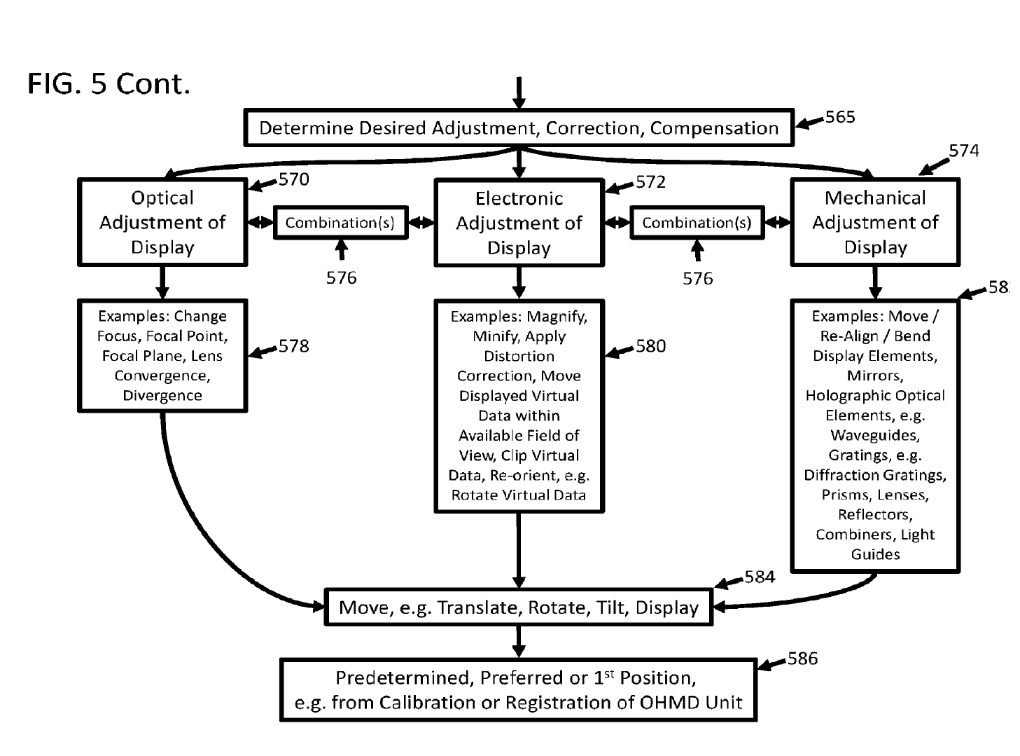

The estimate of the degree of accommodation of the eye can be used to move the display of the OHMD unit, for example in z-direction, e.g. closer or further away from the eye. The moving of the display of the OHMD unit can, for example, include moving the focus point or focal plane closer or further away from the eye. FIG. 5 shows several non-limiting examples how the display of the OHMD unit can be moved, in this case in response to changes in the degree of estimated or measured accommodation of the eye. By changing the position, location and, optionally, orientation of the display of the OHMD unit in response to changes in eye accommodation, user comfort in using AR or VR headsets can be improved and discomfort related to differences in oculomotor cues and visual cues between physical images or data and virtual images or data processed by the brain can be reduced or avoided. In some embodiments, estimates or measurements of the degree of accommodation can also be used to change the curvature of the display of the OHMD unit, for example by bending one or more mirrors, gratings, combiners, light guides, reflectors or by re-orienting display elements, e.g. mirrors, gratings, combiners, light guides, reflectors, for example to maintain the focal point of the light from the virtual data transmitted by the display of the OHMD unit on the retina as the accommodation of the user changes when viewing different objects of the physical world.

If two or more cameras are used for the distance or angle or other measurement(s), the distance between and the position and/or orientation of the cameras and light emitters, if applicable, can provide parallax information wherein the difference in perspective image capture views of the pupil and/or the retina can be used to add additional accuracy to the measurements of inter-ocular distance and/or pupil-to-display distance and/or pupil-to-retina distance and/or retina-to-display distance, including measurements obtained prior to an activity where the OHMD is used, including image capture and non image capture based measurements.

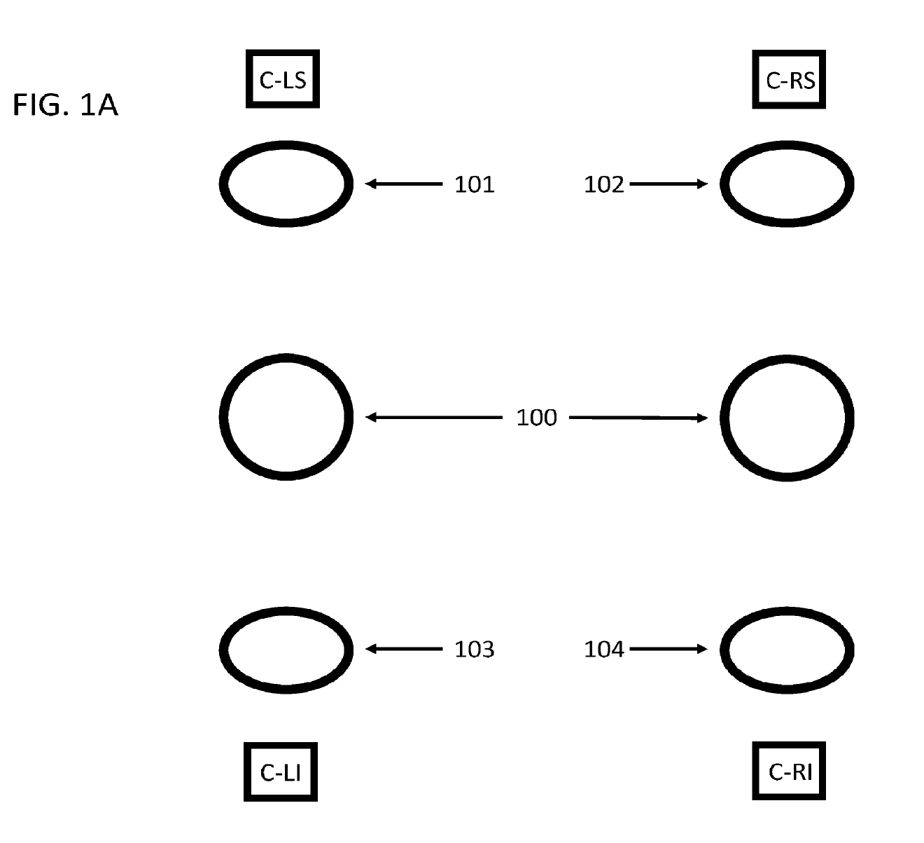

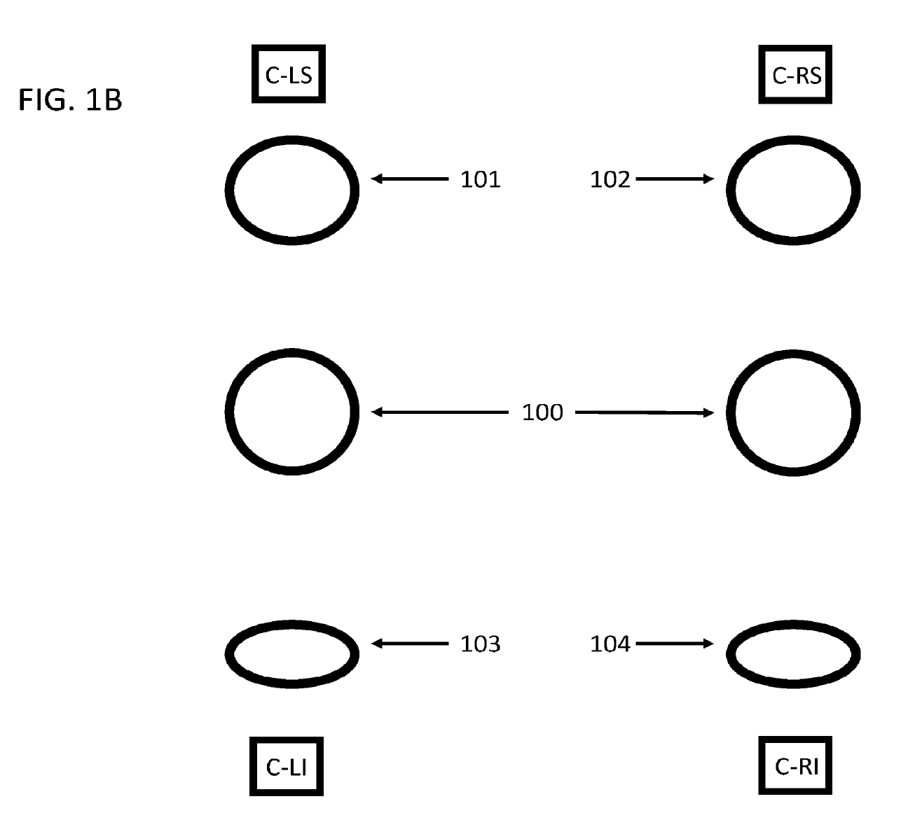

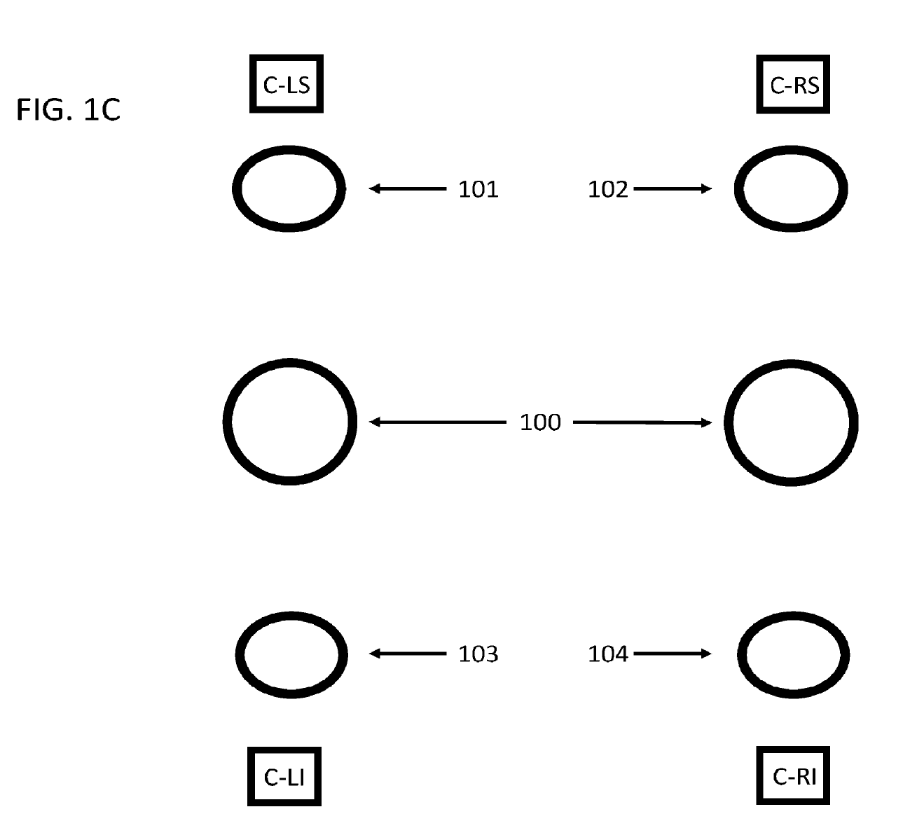

FIG. 1A is an illustrative, non-limiting example showing four cameras directed towards the eyes: Camera-left superior (C-LS), camera-right superior (C-RS), camera-left inferior (C-LI), camera-right inferior (C-RI). The real pupils (100) are round and circular. The projection of the left pupil seen by C-LS is ellipsoid (101). The projection of the right pupil seen by C-RS is ellipsoid (102). The projection of the left pupil seen by C-LI is ellipsoid (103). The projection of the right pupil seen by C-RI is ellipsoid (104). If the frame and the four cameras are centered over the pupils in equidistant location, the ellipses have the same shape and radii for all four cameras.

FIG. 1B is another illustrative, non-limiting examples that shows four cameras directed towards the eyes: Camera-left superior (C-LS), camera-right superior (C-RS), camera-left inferior (C-LI), camera-right inferior (C-RI). The real pupils (100) are round and circular. The OHMD frame (not shown) and cameras have slipped inferiorly on the user's nose in this example.

The projection of the left pupil seen by C-LS is ellipsoid (101), but has increased in height when compared to FIG. 1A. The projection of the right pupil seen by C-RS is ellipsoid (102), but has increased in height when compared to FIG. 1A. The increase in height in the C-LS and C-RS pupil images is caused by the decreased distance between the superior cameras to the left and right pupils as a result of the inferior slippage of the OHMD frame, moving the superior cameras closer and more over the pupils.

The projection of the left pupil seen by C-LI is ellipsoid (103), but has decreased in height when compared to FIG. 1A. The projection of the right pupil seen by C-RI is ellipsoid (104), but has decreased in height when compared to FIG. 1A. The decrease in height in the C-LI and C-RI pupil projections is caused by the increased distance between the inferior cameras to the left and right pupils as a result of the inferior slippage of the OHMD frame, moving the inferior cameras further away the pupils.

The change in projected pupil shape detected by one or more cameras can be used to determine movement of the OHMD unit on the user's face and/or nose and/or head. The magnitude of the change in pupil shape can be used to determine the direction of and amount of the movement of the OHMD unit.

FIG. 1C shows four cameras directed towards the eyes: Camera-left superior (C-LS), camera-right superior (C-RS), camera-left inferior (C-LI), camera-right inferior (C-RI). The real pupils (100) are round and circular. The OHMD frame (not shown) and cameras have slipped sideways on the user's nose in this example.

The projection of the left pupil seen by C-LS is ellipsoid (101), but has decreased in width when compared to FIG. 1A. The projection of the right pupil seen by C-RS is ellipsoid (102), but has decreased in width when compared to FIG. 1A. The decrease in width in the C-LS and C-RS pupil projections is caused by the increased distance between the superior cameras to the left and right pupils as a result of the sideways movement of the OHMD frame, moving the superior cameras further away from the pupils.

The projection of the left pupil seen by C-LI is ellipsoid (103), but has decreased in width when compared to FIG. 1A. The projection of the right pupil seen by C-RI is ellipsoid (104), but has decreased in width when compared to FIG. 1A. The decrease in width in the C-LI and C-RI pupil projections is caused by the increased distance between the inferior cameras to the left and right pupils as a result of the sideways movement of the OHMD frame, moving the superior cameras further away from the pupils.

The pupil projections of the inferior and superior cameras are comparable in height indicating that the OHMD unit has not slipped superiorly or inferiorly.

The change in projected pupil shape detected by one or more cameras can be used to determine movement of the OHMD unit on the user's face and/or nose and/or head. The magnitude of the change in pupil shape can be used to determine the direction of and amount of the movement of the OHMD unit.

Someone skilled in the art will readily recognize that different combinations of pupil projection or images captured by the one or more video cameras are possible. For example, combinations of movement of the OHMD on the user's head are possible; for example, an OHMD can slip inferior while simultaneously slipping sideways, e.g. to the left or right side of the user's face. The resultant change in pupil images captured by the one or more cameras can be used to determine the direction of movement(s) and magnitude of movement(s). In addition, the position and/or orientation of the one or more cameras monitoring the eye(s) and pupil will influence the shape of the eye and/or pupil as see by the one or more cameras. For example, the one or more cameras can be centered, e.g. superior or inferior, relative to the eye or pupil; or they can be offset, e.g. medially or laterally, relative to the eye, for example in superior or inferior location. Thus, the location, orientation and view direction of the camera(s) will determine the shape of the projection or image of the eye or pupil captured by the camera.

In some embodiments, the user can position and/or orient the OHMD, for example comfortably, on his or her nose and face and determine a starting position and/or orientation or preferred position and/or orientation or typical position and/or orientation of the OHMD relative to the user's face, eyes and pupils; the projection or images of the eye(s) and/or pupil(s) captured by the camera(s) for this starting position and/or orientation or preferred position and/or orientation or typical position and/or orientation of the OHMD relative to the user's face, eyes and/or pupils can optionally be stored and can subsequently be used to monitor changes in the projection, images or shape of the projection and images of the eye(s) and/or pupil(s); such changes can be used to determine the movement(s) including the direction of movement, the position and/or angular orientation of the OHMD on the user's face at a later time. If changes in position and/or orientation of the OHMD on the user's face are detected, such changes can be used to adjust the display of the OHMD thereby helping to reduce potential misalignment of virtual displays, e.g. virtual axes, virtual anatomic structures, virtual images, virtual instruments and/or virtual implants in relationship to a target area or structure or a target anatomic tissue. For example, if the one or more cameras detect an inferior slippage of the OHMD by 0.2, 0.5, 0.7, 1.0, 1.5, 2.0, 2.5, 3.0, 3.5, 4.0, 4.5, 5.0, 6.0, 7.0, 8.0, 9.0, 10.0, 11.0, 12.0, 13.0, 14.0, 15.0, 16.0, 17.0, 18.0, 19.0, 20.0 mm or any other value, the display of the OHMD can be moved or projected a corresponding amount more superior, e.g. by 0.2, 0.5, 0.7, 1.0, 1.5, 2.0, 2.5, 3.0, 3.5, 4.0, 4.5, 5.0, 6.0, 7.0, 8.0, 9.0, 10.0, 11.0, 12.0, 13.0, 14.0, 15.0, 16.0, 17.0, 18.0, 19.0, 20.0 mm.

For example, if the one or more cameras detect a superior movement of the OHMD by 0.2, 0.5, 0.7, 1.0, 1.5, 2.0, 2.5, 3.0, 3.5, 4.0, 4.5, 5.0, 6.0, 7.0, 8.0, 9.0, 10.0, 11.0, 12.0, 13.0, 14.0, 15.0, 16.0, 17.0, 18.0, 19.0, 20.0 mm or any other value, the display of the OHMD can be moved or projected a corresponding amount more inferior, e.g. by 0.2, 0.5, 0.7, 1.0, 1.5, 2.0, 2.5, 3.0, 3.5, 4.0, 4.5, 5.0, 6.0, 7.0, 8.0, 9.0, 10.0, 11.0, 12.0, 13.0, 14.0, 15.0, 16.0, 17.0, 18.0, 19.0, 20.0 mm.

For example, if the one or more cameras detect a movement of the OHMD to the left by 0.2, 0.5, 0.7, 1.0, 1.5, 2.0, 2.5, 3.0, 3.5, 4.0, 4.5, 5.0, 6.0, 7.0, 8.0, 9.0, 10.0, 11.0, 12.0, 13.0, 14.0, 15.0, 16.0, 17.0, 18.0, 19.0, 20.0 mm or any other value, the display of the OHMD can be moved or projected a corresponding amount to the right, e.g. by 0.2, 0.5, 0.7, 1.0, 1.5, 2.0, 2.5, 3.0, 3.5, 4.0, 4.5, 5.0, 6.0, 7.0, 8.0, 9.0, 10.0, 11.0, 12.0, 13.0, 14.0, 15.0, 16.0, 17.0, 18.0, 19.0, 20.0 mm.

For example, if the one or more cameras detect a movement of the OHMD to the right by 0.2, 0.5, 0.7, 1.0, 1.5, 2.0, 2.5, 3.0, 3.5, 4.0, 4.5, 5.0, 6.0, 7.0, 8.0, 9.0, 10.0, 11.0, 12.0, 13.0, 14.0, 15.0, 16.0, 17.0, 18.0, 19.0, 20.0 mm or any other value, the display of the OHMD can be moved or projected a corresponding amount to the left, e.g. by 0.2, 0.5, 0.7, 1.0, 1.5, 2.0, 2.5, 3.0, 3.5, 4.0, 4.5, 5.0, 6.0, 7.0, 8.0, 9.0, 10.0, 11.0, 12.0, 13.0, 14.0, 15.0, 16.0, 17.0, 18.0, 19.0, 20.0 mm.

For example, if the one or more cameras detect a movement of the OHMD by 0.2, 0.5, 0.7, 1.0, 1.5, 2.0, 2.5, 3.0, 3.5, 4.0, 4.5, 5.0, 6.0, 7.0, 8.0, 9.0, 10.0, 11.0, 12.0, 13.0, 14.0, 15.0, 16.0, 17.0, 18.0, 19.0, 20.0 mm or any other value superiorly in relationship to the left eye or pupil and a movement of the OHMD by 0.2, 0.5, 0.7, 1.0, 1.5, 2.0, 2.5, 3.0, 3.5, 4.0, 4.5, 5.0, 6.0, 7.0, 8.0, 9.0, 10.0, 11.0, 12.0, 13.0, 14.0, 15.0, 16.0, 17.0, 18.0, 19.0, 20.0 mm or any other value inferiorly in relationship to the right eye or pupil, the display of the OHMD for the left eye can be moved or projected a corresponding amount more inferior, e.g. by 0.2, 0.5, 0.7, 1.0, 1.5, 2.0, 2.5, 3.0, 3.5, 4.0, 4.5, 5.0, 6.0, 7.0, 8.0, 9.0, 10.0, 11.0, 12.0, 13.0, 14.0, 15.0, 16.0, 17.0, 18.0, 19.0, 20.0 mm and the display of the OHMD for the right eye can be moved or projected a corresponding amount more superior, e.g. by 0.2, 0.5, 0.7, 1.0, 1.5, 2.0, 2.5, 3.0, 3.5, 4.0, 4.5, 5.0, 6.0, 7.0, 8.0, 9.0, 10.0, 11.0, 12.0, 13.0, 14.0, 15.0, 16.0, 17.0, 18.0, 19.0, 20.0 mm. Someone skilled in the art will recognize that such a superior movement of the OHMD in relationship to the left eye and inferior movement of the OHMD in relationship to the right eye corresponds to a rotation of the OHMD relative to the user's face and/or eyes and/or pupils, e.g. by 1, 2, 3, 4, 5, 6, 7, 8, 9, 10, 11, 12, 13, 14, 15, 16, 17, 18, 19, 20 degrees or any other value; the OHMD display for the left eye and the right eye can be rotated a corresponding amount in the opposite direction to adjust or correct any potential rotation errors of the display of the virtual data. Thus, adjustment and/or correction of the OHMD display(s) to account for movement of the OHMD in relationship to the user's face and/or eyes and/or pupils can include translation of the OHMD display in x, y, and z direction and rotation of the OHMD display in x, y, and z direction.

For example, if the one or more cameras detect a movement of the OHMD by 0.2, 0.5, 0.7, 1.0, 1.5, 2.0, 2.5, 3.0, 3.5, 4.0, 4.5, 5.0, 6.0, 7.0, 8.0, 9.0, 10.0, 11.0, 12.0, 13.0, 14.0, 15.0, 16.0, 17.0, 18.0, 19.0, 20.0 mm or any other value inferiorly in relationship to the left eye or pupil and a movement of the OHMD by 0.2, 0.5, 0.7, 1.0, 1.5, 2.0, 2.5, 3.0, 3.5, 4.0, 4.5, 5.0, 6.0, 7.0, 8.0, 9.0, 10.0, 11.0, 12.0, 13.0, 14.0, 15.0, 16.0, 17.0, 18.0, 19.0, 20.0 mm or any other value superiorly in relationship to the right eye or pupil, the display of the OHMD for the left eye can be moved or projected a corresponding amount more superior, e.g. by 0.2, 0.5, 0.7, 1.0, 1.5, 2.0, 2.5, 3.0, 3.5, 4.0, 4.5, 5.0, 6.0, 7.0, 8.0, 9.0, 10.0, 11.0, 12.0, 13.0, 14.0, 15.0, 16.0, 17.0, 18.0, 19.0, 20.0 mm and the display of the OHMD for the right eye can be moved or projected a corresponding amount more inferior, e.g. by 0.2, 0.5, 0.7, 1.0, 1.5, 2.0, 2.5, 3.0, 3.5, 4.0, 4.5, 5.0, 6.0, 7.0, 8.0, 9.0, 10.0, 11.0, 12.0, 13.0, 14.0, 15.0, 16.0, 17.0, 18.0, 19.0, 20.0 mm. Someone skilled in the art will recognize that such an inferior movement of the OHMD in relationship to the left eye and superior movement of the OHMD in relationship to the right eye corresponds to a rotation of the OHMD relative to the user's face and/or eyes and/or pupils, e.g. by 1, 2, 3, 4, 5, 6, 7, 8, 9, 10, 11, 12, 13, 14, 15, 16, 17, 18, 19, 20 degrees or any other value; the OHMD display for the left eye and the right eye can be rotated a corresponding amount in the opposite direction to adjust or correct any potential rotation errors of the display of the virtual data.

The moving of the display of the OHMD unit can include a translation, a rotation and/or a tilting. A translation can be along at least one of an x-axis, y-axis or z-axis or combinations thereof. A rotation can be in at least an axial, sagittal or coronal plane, an oblique plane or combinations thereof. A tilting can be in at least an axial, sagittal or coronal plane, an oblique plane or combinations thereof. In some embodiments, the display can be maintained in a plane substantially parallel relative to the frontal plane of the face of the user. In some embodiments, the display can be maintained despite movement of the OHMD unit in at least one of a position, orientation or alignment similar to the position, orientation or alignment the display had at the time of the registration.

The adjustments or compensation including movement, e.g. translation, rotation or tilting, of the display of the OHMD unit can be performed with use of electronic means, e.g. by electronically moving and/or rotating the display, by optical means, e.g. by changing the reflection of one or more mirrors, by optoelectronic means, e.g. a combination of optical and electronic means, and by mechanical means, e.g. by moving and/or rotating one or more mirrors or prisms using mechanical means.

If the diameter of the pupil(s) changes in response to changes in ambient light during an activity, with a pupil, for example, dilating or constricting in response to the changes in ambient light, a correction can be applied to the height and/or width and/or diameter measurements shown in exemplary, non-limiting manner in FIG. 1. The dilation or constriction involves typically the entire perimeter of the pupil. If one or more cameras are located superior or inferior to the eye and are measuring the change in measured height of the pupil as a function of an OHMD slipping superiorly or inferiorly on the user's nose or face, the medial to lateral diameter measured with the cameras will not be affected by the superior or inferior movement of the OHMD on the user's nose and can be used to normalize the measured height for changes in pupil dilation or constriction. For example, a ratio of supero-inferior height to medial-lateral width of the pupil can be measured: Ratio R=superior-inferior pupil height/medial-lateral pupil width. The ratio will not change as a function of dilation or constriction of the pupil, since both superior-inferior pupil height and medial-lateral pupil width change simultaneously by the same amount with dilation or constriction of the pupil; thus, the ratio is independent of pupil dilation and/or constriction.

The ratio will, however, change if the OHMD moves superior or inferior relative to the user's eyes with the measured superior-inferior height of the pupil increasing or decreasing for superiorly or inferiorly located cameras depending on the superior or inferior direction and amount of the movement of the OHMD, while the medial-lateral pupil width will remain constant, as shown in FIG. 1.

Similarly, rather than only measuring the position, shape and/or geometry of one or both pupils, in some embodiments an image and/or video capture system can be used to measure the position, shape and/or geometry of one or both eyes, e.g. using one, two or more cameras, including from one or multiple view angles. The shape of the eye will change similar to the changes shown for the pupil in FIGS. 1A-C for different cameras and view angles and for different OHMD positions and/or orientations relative to the user's face or head. Such measurements can be performed for open and closed eye positions and/or orientations.

In addition, if two or more cameras are used, the cameras can be deployed to detect and/or measure movement of the frame of the OHMD unit on the user's head and/or nose and/or ears. For example, the position of the OHMD unit on the user's head and/or nose and/or ears can be registered initially before or after or concurrent with the spatial registration of the target area or target anatomy or surgical site.

Registration of OHMD Position and/or Orientation and/or Alignment

For purposes of the initial registration of the OHMD position and/or orientation and/or alignment and/or projection plane including projection plane curvature including any adjustments or changes using image capture and/or camera systems and for any of the other techniques used for registering the position and/or orientation and/or alignment of the OHMD in relationship to the target area or target anatomy or the patient, the user can place the OHMD on his or her head in the preferred position. The preferred position can be the most comfortable position. The preferred position can also be the position where the user obtains the best view angle of the real data and/or the virtual data displayed by the OHMD. The system can measure the location of the eyes and/or the pupils in relationship to the OHMD unit, e.g. the frame of the OHMD unit, and, optionally, the left OHMD display can be centered over the left eye and/or left pupil and the right OHMD display can be centered over the right eye and/or right pupil.

The user can optionally place his or her chin onto a stand for purposes of the initial registration of the position and/or orientation and/or alignment of the OHMD on the user's head. The stand can include a chin holder. The stand can include a forehead reference against which the user can lean his or her forehead, similar to head holders used in optometrist's or ophtalmologist's offices or other head holders or chin holders known in the art. In this manner, the OHMD located on the user's head and face and the user's head can be registered in a defined position and/or orientation and/or alignment. Any change in the user's head position and/or orientation and/or alignment can be detected and captured from here on using IMU's, navigation markers, optical markers, RF markers, a surgical navigation system or one or more image and/or video capture systems with one or more cameras.

The following techniques, systems, methods and/or devices can be used alone or in combination to determine the position of the user's head and/or orientation and/or alignment and/or change thereof and/or direction and speed of movement of the user's head as well as movement of the OHMD unit including the frame and/or display on the user's head relative to an initial position:
IMU's integrated into or attached to the OHMD
RF markers integrated or attached to the OHMD (for example used with a surgical navigation system)
Optical markers integrated or attached to the OHMD (for example used with a surgical navigation system)
One or more LED's integrated into or attached to the OHMD (for example used with a image and/or video capture system separate from the OHMD)
Reference phantoms or calibration phantoms integrated into or attached to the OHMD
Optional IMU's attached to the user/operator/surgeon, e.g. his or her skin or surgical gown or surgical head cover, or surgical face mask or surgical eye shield or surgical face shield, all optionally sterile
Optional RF markers attached to the user/operator/surgeon, e.g. his or her skin or surgical gown or surgical head cover, or surgical face mask or surgical eye shield or surgical face shield, all optionally sterile (for example used with a surgical navigation system)
Optional optical markers attached to the user/operator/surgeon, e.g. his or her skin or surgical gown or surgical head cover, or surgical face mask or surgical eye shield or surgical face shield, all optionally sterile (for example used with a surgical navigation system)
Optional one or more LED's attached to the user/operator/surgeon, e.g. his or her skin or surgical gown or surgical head cover, or surgical face mask or surgical eye shield or surgical face shield, all optionally sterile (for example used with a image and/or video capture system separate from the OHMD)
Optional reference phantom or calibration phantom attached to the user/operator/surgeon, e.g. his or her skin or surgical gown or surgical head cover, or surgical face mask or surgical eye shield or surgical face shield, all optionally sterile
Optional one or more skin marks placed on the user's/operator's/surgeon's skin, for example with a sharpie pen, or sticker applied to skin, removable tattoo applied to skin, and others, that can be detected by cameras/an image and/or video capture system directed towards the surgeon's face during the initial registration.

In some embodiments, the user and/or operator and/or surgeon can optionally place his or her chin or head onto the stand after the initial registration of the OHMD on the user's/operator's/surgeon's head and a registration of the OHMD on the user's/operator's/surgeon's head can be repeated, e.g. relative to the user's/operator's/surgeon's head and/or relative to the target area or target anatomy or activity. A re-registration can be triggered by the user/operator/surgeon, e.g. when he or she feels that the OHMD frame has moved on their face or nose or when he or she observers misalignment between or a distortion of virtual vs. real world data. A re-registration can also be trigged by an alert, e.g. if certain threshold values are exceeded, e.g. shape/diameter of projection of one or both pupils or other facial parameters registered during the initial or any subsequent registration. The distance of the user's left pupil, iris, cornea, sclera, conjunctiva and/or retina to the one, two, or more cameras can be determined and, optionally, stored, for example for a user and/or a given surgical procedure in a given patient. The distance of the user's right pupil, iris, cornea, sclera, conjunctiva and/or retina to the one, two, or more cameras can be determined and, optionally, stored, for example for a user and/or a given surgical procedure in a given patient. For example, the distance of the user's right pupil, iris, cornea, sclera, conjunctiva and/or retina can be stored in relationship of its position to an optional first camera located superior to the eye, an optional second camera located inferior to the eye, an optional third camera located medial of the eye, an optional forth camera located lateral of the eye. The distance of the user's left pupil, iris, cornea, sclera, conjunctiva and/or retina can be stored in relationship of its position to an optional first camera located superior to the eye, an optional second camera located inferior to the eye, an optional third camera located medial of the eye, an optional forth camera located lateral of the eye.

In other embodiments, one or more cameras can also be integrated into or attached to the frame of the OHMD unit in the piece that connects the frontal portion of the frame to the ears, e.g. the ear member. The one or more cameras integrated into one or both of the ear members can point towards the eye and the pupil and can measure the distance from the eye and/or the pupil to the display of the OHMD and other portions of the OHMD using a lateral view or side view.

Standard image processing and, optionally pattern recognition techniques known in the art and developed in the future can be applied for any of the foregoing embodiments involving image capture. Artificial neural networks can also be employed and, through progressive learning of the system, can be used to improve the accuracy of the system through repeated activities and/or procedures.

Error Detection

DetectingMmovement of OHMD Position and/or Orientation and/or Alignment, e.g. using Image and/or Video Capture Systems, Navigation Markers, Optical Markers, RF Markers or IMU's

If the OHMD unit moves on the user's head during an activity or a procedure, e.g. a surgical procedure or a gaming or industrial application, the change in distance(s) and/or angle(s) including, for example, projection or view angle(s) of one or more images of the user's left and/or right pupil, iris, cornea, sclera, conjunctiva and/or retina relative to the one, two, or more cameras in different locations can be used to determine the nature, direction and magnitude of the movement of the OHMD unit in relationship to the user's eyes. The following are a few representative, non-limiting examples how such changes in camera to pupil, iris, cornea, sclera, conjunctiva and/or retina and/or other structures can be used to determine the movement and resultant new position, orientation and/or alignment of the OHMD unit.

Example of an OHMD unit with 8-cameras directed towards, eye:
Left eye 1 superior, 1 inferior, 1 medial, 1 lateral
Right eye 1 superior, 1 inferior, 1 medial, 1 lateral

The user can place the OHMD unit in a preferred position on the user's head including his or her nose, ears, and/or temporal region. The cameras in this example can be used to measure the following baseline distances for the one or more preferred positions:
Baseline distance left pupil to left superior camera
Baseline distance left pupil to left inferior camera
Baseline distance left pupil to left medial camera
Baseline distance left pupil to left lateral camera
Baseline distance right pupil to right superior camera
Baseline distance right pupil to right inferior camera
Baseline distance right pupil to right medial camera
Baseline distance right pupil to right lateral camera

The following are exemplary changes in distance from baseline distances and the implied movement of the OHMD unit in relationship to the user's face and/or head. Other camera arrangements are feasible, for example, with two or more cameras superior to the left eye and/or superior to the right eye, two or more cameras inferior to the left eye and/or the right eye, two or more cameras medial to the left eye and/or the right eye, and two or more cameras lateral to the left eye and/or the right eye.

### EXAMPLE 1

| | Change from | Corresponding |
|---|---|---|
| | baseline | movement of |
| Distance measured | distance | OHMD unit |
| Distance left pupil to | Increased | Inferior translation, |
| left superior camera | | e.g. on the user's |
| Distance left pupil to | Decreased | nose, optionally |
| left inferior camera | | also with some inferior |
| Distance left pupil to | Unchanged | tilting/rotation of the |
| left medial camera | | OHMD unit |
| Distance left pupil to | Unchanged | |
| left lateral camera | | |
| Distance right pupil | Increased | |
| to right superior | | |
| camera | | |
| Distance right pupil | Decreased | |
| to right inferior | | |
| camera | | |
| Distance right pupil | Unchanged | |
| to right medial | | |
| camera | | |
| Distance right pupil | Unchanged | |
| to right lateral | | |
| camera | | |

### EXAMPLE 2

| | Change from | Corresponding |
|---|---|---|
| | baseline | movement of |
| Distance measured | distance | OHMD unit |
| Distance left pupil to | Decreased | Superior translation, |
| left superior camera | | e.g. on the user's |
| Distance left pupil to | Increased | nose, optionally |
| left inferior camera | | also with some inferior |
| Distance left pupil to | Unchanged | tilting/rotation of the |
| left medial camera | | OHMD unit |
| Distance left pupil to | Unchanged | |
| left lateral camera | | |
| Distance right pupil | Decreased | |
| to right superior | | |
| camera | | |
| Distance right pupil | Increased | |
| to right inferior | | |
| camera | | |
| Distance right pupil | Unchanged | |
| to right medial | | |
| camera | | |
| Distance right pupil | Unchanged | |
| to right lateral | | |
| camera | | |

### EXAMPLE 3

| | Change from | Corresponding |
|---|---|---|
| | baseline | movement of |
| Distance measured | distance | OHMD unit |
| Distance left pupil to | Unchanged | Rotation of OHMD |
| left superior camera | | unit in axial plane |
| Distance left pupil to | Unchanged | to user's left side |
| left inferior camera | | |
| Distance left pupil to | Increased | |
| left medial camera | | |
| Distance left pupil to | Decreased | |
| left lateral camera | | |
| Distance right pupil | Unchanged | |
| to right superior | | |
| camera | | |
| Distance right pupil | Unchanged | |
| to right inferior | | |
| camera | | |
| Distance right pupil | Decreased | |
| to right medial | | |
| camera | | |
| Distance right pupil | Increased | |
| to right lateral | | |
| camera | | |

### EXAMPLE 4

| | Change from | Corresponding |
|---|---|---|
| | baseline | movement of |
| Distance measured | distance | OHMD unit |
| Distance left pupil to | Unchanged | Rotation of OHMD |
| left superior camera | | unit in axial plane |
| Distance left pupil to | Unchanged | to user's right |
| left inferior camera | | side |
| Distance left pupil to | Decreased | |
| left medial camera | | |
| Distance left pupil to | Increased | |
| left lateral camera | | |
| Distance right pupil | Unchanged | |
| to right superior | | |
| camera | | |
| Distance right pupil | Unchanged | |
| to right inferior | | |
| camera | | |
| Distance right pupil | Increased | |
| to right medial | | |
| camera | | |
| Distance right pupil | Decreased | |
| to right lateral | | |
| camera | | |

### EXAMPLE 5

| | Change from | Corresponding |
|---|---|---|
| | baseline | movement of |
| Distance measured | distance | OHMD unit |
| Distance left pupil to | Decreased | The OHMD unit is more |
| left superior camera | | inferiorly located on the |
| Distance left pupil to | Increased | user's left side, moved down |
| left inferior camera | | on the user's left side of the |
| Distance left pupil to | Increased, | head, and more superiorly |
| left medial camera | decreased | located on the user's right |
| | or changed | side, moved up on the user's |
| Distance left pupil to | Increased, | right side of the head. If |
| left lateral camera | decreased | there is no axial plane |
| | or unchanged | translation associated with |
| Distance right pupil | Increased | this position, the distance of |
| to right superior | | the left and right pupils to |
| camera | | the respective medial and |
| Distance right pupil | Decreased | lateral cameras can remain |
| to right inferior | | unchanged. If there is axial |
| camera | | plane translation associated |
| Distance right pupil | Increased, | with this position, the |
| to right medial | decreased | distance of the left and right |
| camera | or unchanged | pupils to the respective |
| Distance right pupil | Increased, | medial and lateral cameras |
| to right lateral | decreased | can increase or decrease |
| camera | or unchanged | depending on the direction |
| | | of the axial plane translation. |

### EXAMPLE 6

| | Change from | Corresponding |
|---|---|---|
| | baseline | movement of |
| Distance measured | distance | OHMD unit |
| Distance left pupil to | Increased | The OHMD unit is more |
| left superior camera | | inferiorly located on the |
| Distance left pupil to | Decreased | user's right side, moved |
| left inferior camera | | down on the user's right side |
| Distance left pupil to | Increased, | of the head, and more |
| left medial camera | decreased | superiorly located on the |
| | or changed | user's left side, moved up on |
| Distance left pupil to | Increased, | the user's left side of the |
| left lateral camera | decreased | head. If there is no axial |
| | or unchanged | plane translation associated |
| Distance right pupil | Decreased | with this position, the |
| to right superior | | distance of the left and right |
| camera | | pupils to the respective |
| Distance right pupil | Increased | medial and lateral cameras |
| to right inferior | | can remain unchanged. If |
| camera | | there is axial plane |
| Distance right pupil | Increased, | translation associated with |
| to right medial | decreased | this position, the distance of |
| camera | or unchanged | the left and right pupils to |
| Distance right pupil | Increased, | the respective medial and |
| to right lateral | decreased | lateral cameras can increase |
| camera | or unchanged | or decrease depending on |
| | | the direction of the axial |
| | | plane translation. |

The increase or decrease in distance, e.g. in mm, can indicate the amount of superior or inferior or medial or lateral translation or rotation or tilting of the OHMD unit, which can then be used for correcting the position, orientation, alignment and, optionally, also curvature of the OHMD display.

Similarly, an increase or decrease in angle, e.g. view angle or projection angle including, for example, images of captured structures, e.g. the pupil(s), eye(s), etc., can indicate the amount of superior or inferior or medial or lateral translation or rotation or tilting of the OHMD unit, which can then be used for correcting the position, orientation, alignment and, optionally, also curvature of the OHMD display.

Combining image capture distance measurements with positional/orientational measurements, e.g. using a navigation system, RF markers, optical markers, and/or IMU's can be used to detect or to increase the accuracy of detection of translation, tilting or rotation of the OHMD. Combining image capture distance measurements with positional/orientational measurements, e.g. using a navigation system, RF markers, optical markers, and/or IMU's can also be used to implement corrections or to increase the accuracy of corrections, e.g. moving, re-orienting, re-aligning the OHMD display or, optionally, changing the curvature of the OHMD display, and reducing, minimizing or avoiding errors in distance and angle determinations, shape, geometry or reducing, minimizing or avoiding display distortions. In some embodiments of the invention, image capture may not be used for correcting the position, orientation, alignment and, optionally, also curvature of the OHMD display. In some of embodiments of the invention, only RF markers, optical markers, navigation markers and/or IMU's and/or calibration phantoms or reference phantoms can be used to measure the relative position, orientation, alignment, and/or direction of movement of the OHMD and the user's head and to implement any corrections, e.g. moving, re-orienting, re-aligning the OHMD display, and reducing, minimizing or avoiding errors in distance and angle determinations, shape, geometry or reducing, minimizing or avoiding display distortions.

Any moving, re-orienting, re-aligning of the OHMD display in relationship to the OHMD frame can be real time, e.g. with adjustment rates >30Hz, or at preset time intervals, e.g. every 1 sec, 2 sec, 3 sec, 5 sec, 15 Hz, 10 Hz, 5 Hz etc. Any moving, re-orienting, re-aligning of the OHMD display in relationship to the OHMD frame can be performed when the system detects movement of the OHMD frame in relationship to the user's eyes or head.

Any moving, re-orienting or re-aligning of the OHMD display in relationship to the OHMD frame can be performed using mechanical means, e.g. mechanical actuators, spring-like mechanisms, electrical means, e.g. piezoelectric crystals, magnets, and the like. Any moving, re-orienting or re-aligning of the OHMD display can be using electronic or optical means, e.g. by moving the projection of the virtual data or by altering the light path of the OHMD display and emitted light or by moving one or more mirrors or display units within the OHMD, using, for example, mechanical or electric, including piezoelectric, means. Any moving, re-orienting or re-aligning of the OHMD displays can also be performed, for example, by using a smaller area of the available display area and by aligning or re-orienting the smaller area in the desired fashion in relationship to the user's eyes.

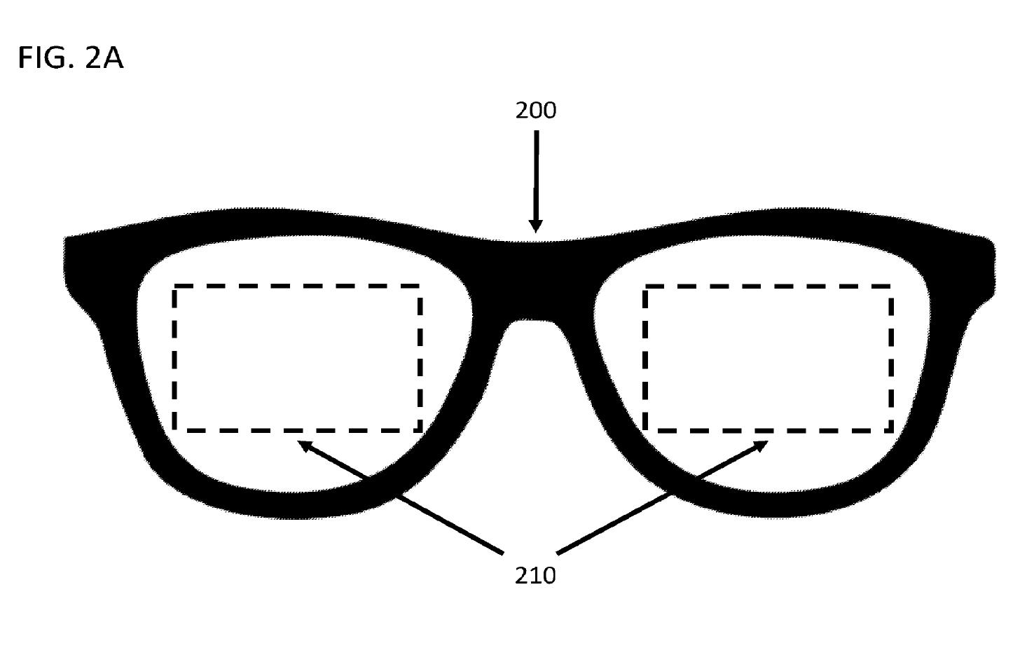

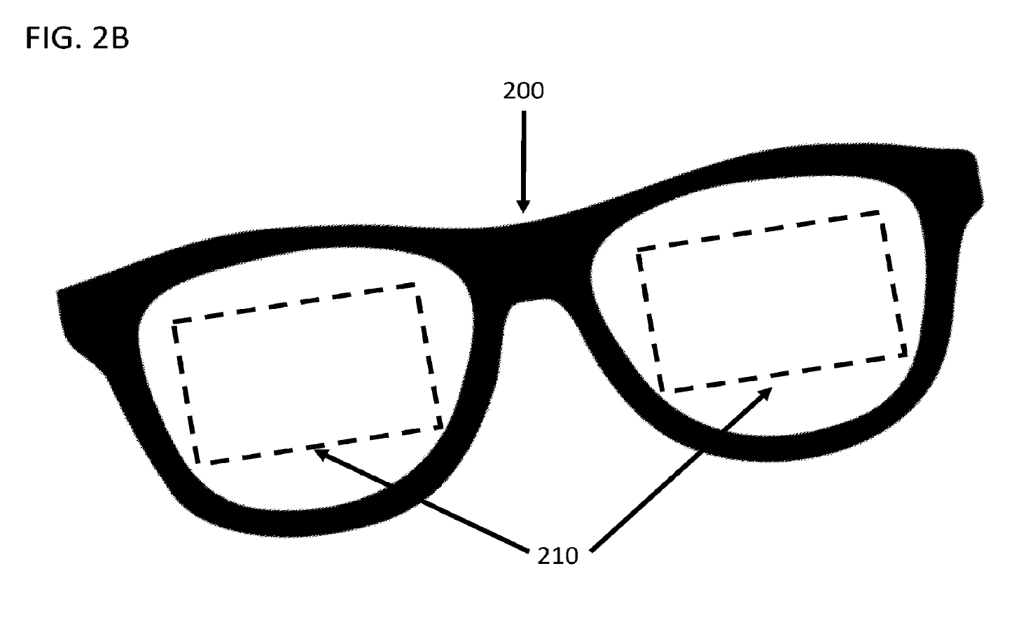

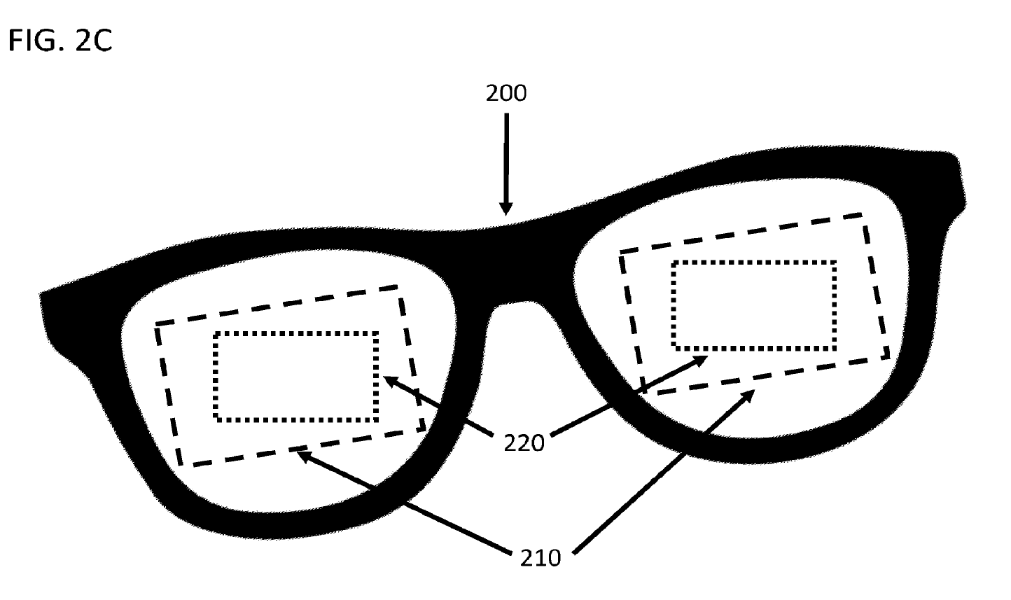

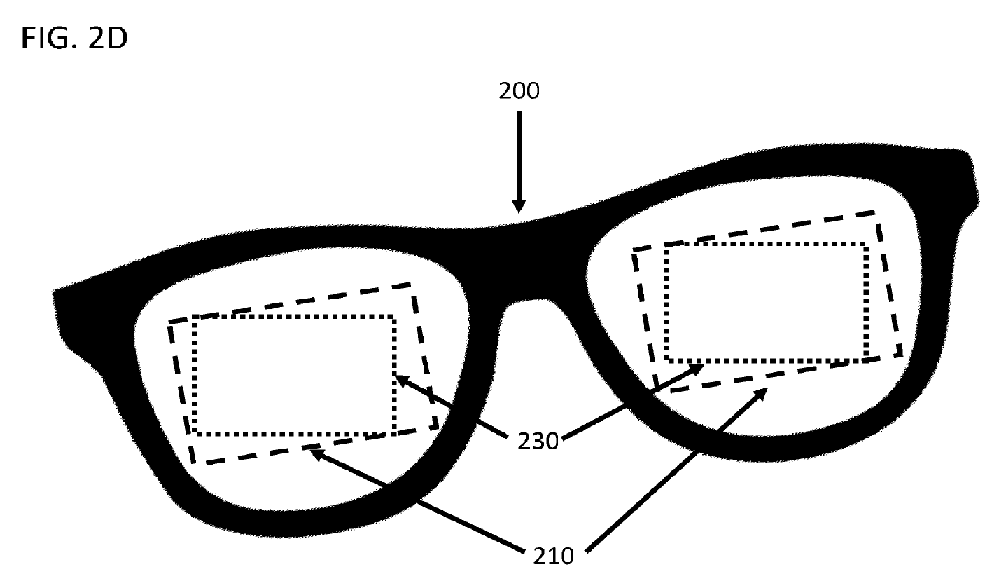

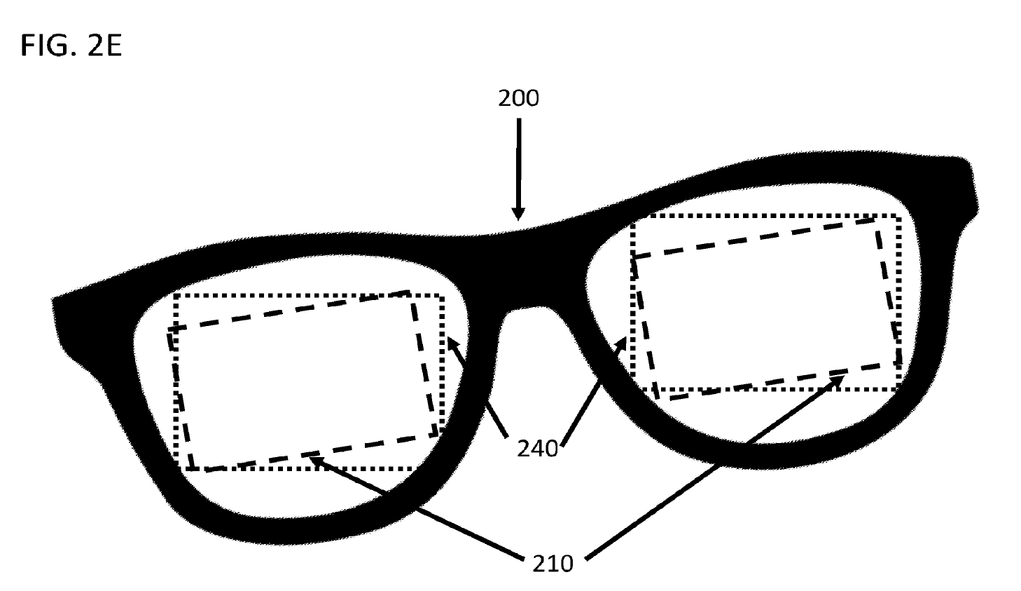

FIGS. 2A-E are illustrative, non-limiting examples of re-orienting or re-aligning one or more OHMD displays to adjust or correct, for example, for movement of an OHMD on the user's head.

FIG. 2A is an illustrative, non-limiting example showing an OHMD unit frame (200) and the borders or boundaries of the maximal available or useable area for the OHMD display (210, stippled line). The OHMD unit frame (200) and the maximal available or useable area for the OHMD display (210) are in a substantially horizontal plane.

FIG. 2B shows an OHMD unit frame (200) and the borders or boundaries of the maximal available or useable area for the OHMD display (210, stippled line). The OHMD unit frame (200) and the maximal available or useable area for the OHMD display (210) are rotated and are not in a horizontal plane. This can be caused by movement of the user's head and in conjunction with that of the OHMD unit, with corresponding movement of the virtual data displayed by the OHMD display using, for example, registration techniques as described in US 2017-0258526, entitled “Devices and Methods for Surgery”, filed Mar. 10, 2017 and U.S. Provisional Application No. 62/556,867, entitled “Devices and Methods for Surgery”, filed Sep. 11, 2017, which are incorporated herein by reference in their entirety, registering, for example, a target area and one or more OHMD's in a common coordinate system. This can also be caused by movement of the OHMD frame on the user's head, e.g. after an initial registration.

FIG. 2C shows an OHMD unit frame (200) and the borders or boundaries of the maximal available or useable area for the OHMD display (210, stippled line). The OHMD unit frame (200) and the maximal available or useable area for the OHMD display (210) are rotated and are not in a horizontal plane. If this is caused by movement of the OHMD frame relative to the user's head, e.g. after an initial registration, and it is detected, e.g. using an image and/or video capture system or using navigation markers, RF markers, optical markers, calibration and/or reference phantoms, and or IMU's, the position, orientation and/or alignment of the virtual data, e.g. area or volume, for the effective OHMD display (220, pointed line) can be changed or adjusted to be substantially horizontal in alignment again and, optionally, to remain centered over the user's pupils and/or eyes. The effective, re-aligned OHMD display (220, pointed line) uses a smaller area of the maximal available or useable area for the OHMD display (210, stippled line).

The reduced size of the re-aligned display area can be optimized to use the maximal available display dimensions, for example as a boundary condition.

FIG. 2D shows an OHMD unit frame (200) and the borders or boundaries of the maximal available or useable area for the OHMD display (210, stippled line). The OHMD unit frame (200) and the maximal available or useable area for the OHMD display (210) are rotated and are not in a horizontal plane. If this is caused by movement of the OHMD frame relative to the user's head, e.g. after an initial registration, and it is detected, e.g. using an image and/or video capture system or using navigation markers, RF markers, optical markers, calibration and/or reference phantoms, and or IMU's, the position, orientation and/or alignment of virtual data, e.g. area or volume, for the effective OHMD display (230, pointed line) can be changed or adjusted to be substantially horizontal in alignment again and, optionally, to remain centered over the user's pupils and/or eyes. The effective, re-aligned OHMD display (230, pointed line) uses a smaller area of the maximal available or useable area for the OHMD display (210, stippled line); however, in this example, it has been modified so that its corners extend to the limits or border or boundaries of the maximal available or useable area for the OHMD display (210, stippled line).

In some embodiments, an area or volume of virtual data, e.g. of a patient or a target area, can be corrected in position, orientation, alignment, e.g. rotation, that is larger than the maximal available or useable area for the OHMD display. In this case, the portions of the area or volume of virtual data that project outside the maximal available or useable area for the OHMD display can be clipped. In the event the user, e.g. surgeon, moves his or her head, a previously clipped area or volume of virtual data can be displayed again by the OHMD display within the maximal available or useable area for the OHMD display.

FIG. 2E shows an OHMD unit frame (200) and the borders or boundaries of the maximal available or useable area for the OHMD display (210, stippled line). The OHMD unit frame (200) and the maximal available or useable area for the OHMD display (210) are rotated and are not in a horizontal plane. If this is caused by movement of the OHMD frame relative to the user's head, e.g. after an initial registration, and it is detected, e.g. using an image and/or video capture system or using navigation markers, RF markers, optical markers, calibration and/or reference phantoms, and or IMU's, the position, orientation and/or alignment of the virtual data, e.g. area or volume data, for OHMD display (240, pointed line) can be changed or adjusted to be substantially horizontal in alignment again and, optionally, to remain centered over the user's pupils and/or eyes. In this example, the virtual data (240, pointed line), e.g. area or volume or contour of a device or instrument, for the OHMD display extend beyond the maximal available or useable area for the OHMD display (210, stippled line) and are being clipped at the border or boundaries of the maximal available or useable area for the OHMD display (210, stippled line).

Of note, the number of cameras used in the foregoing and following embodiments and examples is in no way meant to be limiting of the invention; more or less cameras can be deployed for different embodiments and implementations of the invention. The term image and/or video capture system can include one or more cameras.

Optionally, physical or optical measurements can be combined with image capture based measurements. For example, the inter-ocular distance can be measured using standard tools or methods used by an optometrist. The known inter-ocular distance of the user determined using such standard measurements can then, for example, be entered into the user interface of the OHMD and the image and/or video capture system can be calibrated using this known distance for any subsequent image capture based distance measurements, for example by comparing a known distance using a standard, e.g. physical or optical measurement, with a measurement of the same two or more points and their distance using the image and/or video capture system.

Data Recording

When IMU's are used to assess and/or monitor the position, orientation, alignment and direction of movement of an OHMD, the data can be recorded for different users, for a given activity including a surgical procedure, and/or for a given patient. Similarly, the position, orientation, alignment and direction of movement of an OHMD as measured with RF markers, optical markers, navigation markers, LED's, calibration phantoms and/or reference phantoms can be recorded for different users, for a given activity including a surgical procedure, and/or for a given patient. The recorded data can be analyzed, e.g. statistically, to determine, for example, average movements, positions, alignment, orientation, and or direction, speed and magnitude of movement of the OHMD, the target area, the surgical site, the patient and the surgeon. Outlier analysis can be performed and can, for example, be used to identify potential movement of the OHMD frame in relationship to the user's and/or surgeon's face or head.

In addition, when IMU's, markers and/or phantoms are applied on the left and right side of the OHMD frame and, optionally, also at the inferior and superior aspects of the OHMD frame, differences in left and right and superior and inferior movement, acceleration, acceleration forces can be used to identify any movement of the OHMD frame in relationship to the user's and/or surgeon's face or head.

In some embodiments, a level, e.g. using an air bubble in a water container, can be used to assess the position of an OHMD frame relative to the user's and/or surgeon's face and head. The level can be located on the OHMD frame; a level can also be located on the surgeon's face or head and/or his face mask, face shield and/or head cover and/or surgical gown. A level can also be located at the activity site, e.g. a surgical site, e.g. a limb or a knee. The level can be monitored using a camera, e.g. as part of an image and/or video capture system.

Error Detection using Markers on the Surgeon

In some embodiments, one or more marks, markers or trackers can be applied to the skin of the surgeon, e.g. the skin of his or her face, to the surgeon's face shield, eye shield, face mask, and/or head cover and/or other parts of the surgeon's body and/or surgical gown.

Such marks or markers can, for example, include skin marks placed, for example, with a Sharpie pen. Such marks or markers can include a small reference phantom or calibration phantom applied to the surgeon's skin. Such marks or markers can include an RF marker, optical marker, navigation marker, and/or an IMU applied to the surgeon's skin. Marks and/or markers can, for example, be applied to the area around the left eye and/or the area around the right eye, e.g. above the eye brow, below the eye brow, above the superior eye lid, below the inferior eye lid, at the nose, at the portion of the nose facing the eye, at the temple, e.g. immediately adjacent to the eye.

The OHMD display can then be placed on the user's and/or surgeon's head, for example in a preferred position. The OHMD display can then be registered relative to the user's and/or surgeon's head. Optionally, the user and/or surgeon can place his or her chin or forehead onto a stand or tripod for purposes of an initial registration and, optionally, subsequent re-registrations. If an image and/or video capture system is used for registering the position and/or orientation and/or alignment of the OHMD relative to the user's and/or surgeon's face or head, the image and/or video capture system can register the position of any skin marks or markers placed near or around the user's and/or surgeon's eye during the initial registration procedure. The image and/or video capture system can then intermittently or continuously measure the position and/or orientation and/or alignment of the skin marks or markers and compare it to the position and/or orientation and/or alignment of the skin marks or markers during the initial registration. If any movement is detected compared to the position and/or orientation and/or alignment relative to the original registration, the system can optionally adjust the position and/or orientation and/or alignment and/or geometry and/or shape of the OHMD display, as described in various sections of the specification. If any movement is detected compared to the position and/or orientation and/or alignment relative to the original registration, the system can optionally adjust the position and/or orientation and/or alignment and/or display of the virtual data, e.g. a virtual area or volume, e.g. of a patient, as described in various sections of the specification.

Error Detection using Calibration or Reference Phantoms including Surgical Instruments or Devices

In some embodiments, a calibration phantom or reference phantom with one or more known distances and/or one or more known angles can be applied to a target area and/or a patient. The calibration phantom can, optionally, include LED's, RF markers, optical markers, navigation markers and/or IMU's. Optionally, the distance and/or angles of the phantom including the distance and/or angles to the patient and/or the target area and/or the surgical site can be measured, for example using conventional measurement means such as a tape measure or a protractor. A calibration or reference phantom can also be formed by one or more medical devices or instruments, e.g. two or more pins placed in a patient's bone. The distance and/or angle between these medical devices and or instruments, e.g. pins, can be measured, for example using conventional measurement means such as a tape measure and/or a protractor. Any phantom or reference body with one or more known geometries can be used.

Optionally, an image and/or video capture system integrated into, attached to or separate from the OHMD can monitor the known distance and/or angle, e.g. the distance and/or angle between two members of a calibration phantom that has been measured or the distance and/or angle between two pins that has been measured. Alternatively, any of the other means of measuring distances and/or angles and/or of maintaining registration, including IMU's or navigation systems can be used for monitoring the geometry of the calibration or reference phantom.

If the image and/or video capture system or other system, e.g. navigation system, measures a distance and/or an angle that differs from the actual distance and/or angle, e.g. as measured earlier using conventional means, it is an indication that either the registration between virtual data and live data is not accurate anymore and/or that the OHMD display of virtual data may not be accurate anymore, e.g. due to movement of the OHMD frame from its original position on the user's and/or surgeon's head. In this instance, an alert can be transmitted. One or more corrective actions can be initiated, e.g. repeating the registration, e.g. of the OHMD relative to the target area of activity and/or the patient and/or the surgical site, and/or of the OHMD relative to the user's and/or surgeon's head and/or face.

Optionally, with a calibration and/or registration phantom applied to the target area and/or the patient, the OHMD display or the focus plane of the displayed virtual data can be moved, including translated, tilted and/or rotated, in order to re-establish a display where the virtual data substantially match the real data, including distance and angle measurements on one or more calibration or reference phantoms. Alternatively, the virtual data can be displayed in fixed alignment relative to the calibration or reference phantoms, only adjusting for the movement of the user's or surgeon's head.

Predetermined or Preferred OHMD Position and/or Orientation

In addition to determining the inter-ocular distance, the pupil-to-display distance, the pupil-to-retina distance, and the retina-to-display distance, a predetermined or a preferred position of the OHMD on the surgeon's or operator's head can be determined for each user. For example, some users can prefer wearing the OHMD in a position where the center of the display unit is substantially centered with the center of the user's pupils, wherein a horizontal line from the center of the display unit can extend to the center of the user's pupil. Some users can prefer to wear the OHMD in a higher position, where the center of the display unit is located higher than the center of the user's pupils, wherein a horizontal line from the center of the display unit can intersect with the user's face above the center of the user's pupils. Some users can prefer to wear the OHMD in a lower position, where the center of the display unit is located lower than the center of the user's pupils, wherein a horizontal line from the center of the display unit can intersect with the user's face below the center of the user's pupils. The inter-ocular distance, the pupil-to-display distance, the pupil-to-retina distance, and the retina-to-display distance can be determined and, optionally stored on a computer medium for each user's preferred position of the OHMD on the user's head.

Alternate OHMD Positions

The inter-ocular distance, the pupil-to-display distance, the pupil-to-retina distance, and the retina-to-display distance can be determined and, optionally stored on a computer medium for each user for alternate positions of the OHMD on the user's head, e.g. a “slipped glasses position” if the OHMD has slipped downward during its use, e.g. during a surgical procedure. Thus, if a user feels that the OHMD has assumed an alternate position, e.g. the user feels during a surgical procedure that the OHMD has slipped down his or her nose, the user can provide a correct command, e.g. a voice command or a virtual keyboard based command, that indicates that the inter-ocular distance, the pupil-to-display distance, the pupil-to-retina distance, and the retina-to-display distance need to be modified or adjusted for the alternate OHMD position with repositioning and/or re-aligment and/or re-focusing of the virtual display of the OHMD for the new OHMD position in relationship to the user's pupil and/or retina.

Storing OHMD Positions

Once the surgeon's or operator's interocular distance and/or pupil-to-display distance and/or the preferred position of the OHMD on the surgeon's or operator's head has been measured or determined, it can be stored in a user profile. Optionally, the OHMD or a connected computer can store multiple user profiles, which can be called up for each individual user when they use a particular OHMD. In this manner, the preferred interocular distance and/or pupil-to-pupil distance can be called up for each individual user, when they place the OHMD on their head.

In some embodiment of the invention, multiple OHMD positions on the user's head can be stored for individual user's. For example, the standard and/or preferred position can be stored, e.g. using a registration procedure, optionally include a face holder or stand. The user can then move the OHMD unit into a second position, e.g. a position that would correspond to a slipping of the OHMD unit downward on the user's nose during a procedure, e.g. resulting from sweat or greasy skin. The second position can then be stored. During the activity or procedure, the user can then optionally provide a command to the OHMD system indicating that the OHMD unit or frame has moved to one of the alternate positions, e.g. a “slipped glasses” position. In this manner, the accuracy of the displayed virtual information can be improved since the OHMD displays can optionally be moved into a different position, orientation and/or alignment to adjust for the change in position of the OHMD unit. Using such stored alternate positions can also help avoid the need for re-registrations during an activity or a procedure.

Error Correction using Display Movement and/or Shape Adjustments and/or Movement of Virtual Data and/or Distortion Correction

Using any of the devices, systems, methods and/or inputs described in the specification, e.g. RF markers, optical markers, navigation markers, levels, LED's, IMU's, calibration phantoms, reference phantoms, skin markers, markers on the user and/or surgeon, markers on the patient and/or target area, markers on the OHMD frame, one, two or more cameras, one, two or more image and/or video capture systems, the movement of the user's and/or surgeon's head, movement of the target area and/or patient and/or surgical site, alterations of the target area and/or patient and/or surgical site, and movement of the OHMD frame and/or display in relationship to the user's and/or surgeon's head or face can be tracked.

The amount of movement, e.g. in mm or degrees, including translation, rotation, tilting, slipping, of the OHMD frame can be determined in relationship to the user's and/or surgeon's head or face. The information can then be used to move, including re-align, rotate, tilt, translate the OHMD display by an appropriate amount in order to substantially match and/or maintain a match of live data and virtual data. In select embodiments, the information can be used to adjust the shape, radii, curvature and/or geometry of the OHMD display in order to reduce or avoid potential errors including distortion of virtual data. In another embodiment of the invention, the information can then be used to move, including re-align, rotate, tilt, translate the virtual data, e.g. 2D area or plane and/or 3D volume or surface, displayed by the OHMD by an appropriate amount in order to substantially match live data and virtual data or maintain a match of live data and virtual data. The moving, re-aligning, rotating, tilting, translating of the virtual data can include moving, re-aligning, rotating, tilting the focus plane of the virtual data and/or moving, re-aligning, rotating, tilting the display of the optical head mounted display unit.

In some embodiments, e.g. when angle measurements of a phantom or two portions of a medical device of known geometry or two medical devices with known angular orientation indicate a distortion of the virtual data relative to the measured live data, e.g. with visible misalignment of a virtually displayed portion of the phantom or medical device relative to the actual phantom or medical device, a distortion correction can be applied to the virtual data. The distortion correction can be based on the difference in angular orientation and/or alignment and/or distance of virtual data and live data, e.g. as measured as a misalignment of a virtually displayed portion of the phantom or medical device relative to the actual phantom or medical device. Distortion corrections of virtual data, e.g. virtual data of a patient including a 2D or 3D display of a CT scan or MRI scan, can be linear or non-linear using any algorithms known in the art or developed in the future. Distortion corrections can be applied in a single dimension or direction, e.g. an x-axis or a z-axis, in two dimensions and/or in three dimensions, e.g. an x-axis, y-axis and z-axis.

In another embodiment, when data indicate that the OHMD frame has moved in relationship to the user's and/or surgeon's head during an activity, e.g. a surgical procedure, an alert can be transmitted, e.g. visual or acoustic, alerting the user and/or surgeon to the issue. The user and/or surgeon can then optionally repeat the registration procedure, including the registration of the OHMD unit relative to the user's and/or surgeon's head and, optionally, the registration of the OHMD unit to the target area and/or the patient and/or the surgical site.

In some embodiments, a display monitor located in a user area, e.g. an operating room or a surgical suite, can be used as a calibration or reference or registration phantom for the OHMD unit including the frame and display position, orientation and/or alignment and/or direction of movement. The display monitor can be used, for example, to display image data, e.g. of a patient, or to concurrently display virtual data displayed by the OHMD. The monitor can have a rectangular or square shape of known dimensions. An image and/or video capture system integrated into, attached to or separate from the OHMD can be used to capture one or more images of the monitor. Since the dimensions of the monitor are known, the size of the monitor on the captured image(s) can be used to determine the distance of the OHMD to the monitor; the shape of the rectangle can be used to determine the angle of the OHMD relative to the monitor. If the image and/or video capture system integrated into or attached to the OHMD uses two or more cameras, the difference in shape of the rectangle detected between a first, second and any additional cameras can be used to increase the accuracy of any estimates of the angular orientation of the OHMD to the display monitor, e.g. by calibrating the measurement of a first camera against a second camera against a third camera and so forth. If two or more cameras are used integrated into or attached to different portions of the OHMD frame, e.g. the left side of the frame and the right side of the frame, the difference in projection of the monitor square or rectangle between the two cameras can also be used to estimate the user's head position and/or orientation and/or alignment and/or the position and/or orientation and/or alignment of the OHMD frame in relationship to the user's head and/or face.

In some embodiments, the user and/or surgeon can optionally look at the display monitor through the OHMD while maintaining his or her head in a neutral position, e.g. with no neck abduction, adduction, flexion, extension or rotation. This head position can be used to calibrate the position of the OHMD display in relationship to the target area and/or the patient and/or the surgical site, e.g. during an initial registration or a subsequent registration. This head position can also be used to calibrate the position of the OHMD unit/frame in relationship to the user's and/or the surgeon's head and face. Optionally, the user and/or surgeon can place his or her head on a chin stand or head holder for purposes of this calibration or registration. This process of using an external display monitor as a reference for calibration and/or registration purposes can be performed at the beginning of an activity and/or a surgical procedure, e.g. as part of an initial registration process. This process of using an external display monitor as a reference for calibration and/or registration purposes can also be performed during an activity or after an activity and/or surgical procedure, for example when there is concern that the OHMD unit may have moved relative to the user's and/or surgeon's face.

In any of the foregoing embodiments, a display monitor can be substituted with an external calibration phantom or reference phantom, e.g. one that is attached to a target area, a patient and/or a surgical site. External calibration phantoms, reference phantoms, surgical instruments, devices, monitors and any object or structure with one or more known dimensions and/or angles and/or geometries can also be used to correct any magnification errors, e.g. magnification errors of virtual data.

Error Correction by Blending In and Out Virtual Data and/or Live Data

In another embodiment of the invention, the OHMD can be used to blend out, enhance or modify all of or select virtual data and/or live data. Blending out, enhancing and modifying select or all virtual data can be applied to portions of or all of one or more of the following:
Projected start point
Projected start position
Projected start orientation/alignment
Projected intermediate point(s)
Projected intermediate position(s)
Projected intermediate orientation/alignment
Projected endpoint
Projected end position
Projected plane(s)
Projected cut plane(s)
Projected intermediate orientation/alignment
Projected path
Projected contour/outline/cross-section/surface features/shape/projection
Projected depth marker or depth gauge, optionally corresponding to a physical depth marker or depth gauge on the actual surgical tool, surgical instrument, trial implant, implant component, implant or device
Projected angle/orientation/rotation marker, optionally corresponding to a physical angle/orientation/rotation marker on the actual surgical tool, surgical instrument, trial implant, implant component, implant or device
Projected axis, e.g. rotation axis, flexion axis, extension axis
Projected axis of the actual surgical tool, surgical instrument, trial implant, implant component, implant or device, e.g. a long axis, a horizontal axis, an orthogonal axis, a drilling axis, a pinning axis, a cutting axis
Estimated/projected non-visualized portions of device/implant/implant component/surgical instrument/surgical tool, e.g. using image capture or markers attached to device/implant/implant component/surgical instrument/surgical tool with known geometry
Projected/intended/estimated virtual tissue change/alteration
All or portions of virtual data
All or portions of live data

Blending out, enhancing, or modifying of live data and virtual data and their individual contribution to the visual field of the user and visual perception by the user can be performed using different techniques and/or methods including, but not limited to, for example:
Reducing transmission of visible light reflected from the target area and/or the patient and/or the surgical site, for example using polarization filters and/or electronic filters including one or more grey level bands, optionally of varying intensity, or, for example, using the OHMD display as a filter, optionally filtering the entire spectrum of visible light or optionally filtering select portions of the spectrum, e.g. portions of the spectrum that include light emitted from the target area, the patient and/or the surgical site.
Increasing the display intensity of virtual data, e.g. making virtual data brighter than live data and, optionally, resulting in a pupillary constriction thereby further decreasing the visibility of less intense light reflect from the target area and/or the patient and/or the surgical site.
Superimposing live data captured through one or more image and/or video capture systems, e.g. integrated into or attached to the OHMD, onto live data reflected by the target area and/or the patient and/or the surgical site seen through the OHMD.
Superimposing boundaries or outlines or skeletonizations of live data of a target area, a patient and/or a surgical site, e.g. superimposing boundaries of tissue interfaces, e.g. organ/fat, organ/bone, muscle/tendon, muscle/ligament, muscle/bone, bone/tendon, bone/ligament.
Blocking live data emitted and/or reflected from the target area, the patient and/or the surgical site, e.g. through the application of filters.
Partially replacing or completely substituting live data emitted and/or reflected from the target area, the patient and/or the surgical site with live data captured by one or more image and/or video capture systems, e.g. integrated into, attached to or separate from the OHMD display, e.g. by displaying the live data captured by the image and/or video capture system with higher intensity than the live data emitted and/or reflected from the target area, the patient and/or the surgical site.

Any of the foregoing methods, approaches and/or systems for blending out, enhancing or modifying virtual data and/or live data can be applied to
Both eyes simultaneously
Only one eye, e.g. left eye or right eye
Both eyes, but with different magnitude or intensity or severity
Select areas of the visual field of one or both eyes, e.g. inferior, superior, medial, lateral quadrants or any other subregions using the same magnitude, intensity or severity
Select areas of the visual field of one or both eyes, e.g. inferior, superior, medial, lateral quadrants or any other subregions using variable magnitude, intensity or severity, optionally with gradients and or transitions, linear and non-linear, optionally reflecting any observed or underlying distortion

For example, in some embodiments, reducing transmission of visible light reflected from the target area and/or the patient and/or the surgical site can only be applied to those areas of the visual field that are subject to distortion or inaccuracy of the display of virtual data.

When the blending out, enhancing and/or modifying of virtual data and/or live data is applied to select areas of the visual field or subregions of the visual fields, linear and non-linear gradients can be applied to transition from the data that have been partially or completely blended out, enhanced or modified to data that have not been blended out, enhanced or modified. The gradients can be derived from or a reflection of any distortion including distortion gradients that can be present.

In select embodiments, the OHMD display can act as a filter, optionally filtering the entire spectrum of visible light or optionally filtering select portions of the spectrum, e.g. portions of the spectrum that include light emitted from the target area, the patient and/or the surgical site. For example, the OHMD display can be used to filter light waves that fall into the spectrum of the color red thereby subtracting or partially or completely filtering out tissue with a “red” color within the filtered part of the spectrum, wherein such tissue can, for example, include exposed muscle, cut bone and/or bleeding tissue.

Blending out, partially or completely, live data as emitted from or reflected by the target area, the patient and/or the surgical site can be beneficial when there is concern of inaccuracy of the displayed virtual data, e.g. due to inaccuracy in distances or angles or distortion, in relationship to the live data, for example due to movement of the OHMD unit in relationship to the user's and/or operator's and/or surgeon's head and/or face. In this instance, live data as emitted from or reflected by the target area, the patient and/or the surgical site can be superimposed with or substituted with, partially or completely, live data seen through an image and/or video capture system integrated into or attached to the OHMD. Since the image and/or video capture system integrated into or attached to the OHMD cannot change its location, position, orientation and/or alignment relative to the OHMD display including the focus plane (unless the display and/or focus plane have been moved/re-oriented/re-aligned or are being moved/re-oriented/re-aligned), live data captured through the image and/or video capture system and displayed by the OHMD display can be accurately aligned with virtual data displayed by the OHMD display.

Partially or completely superimposing or substituting live data as emitted from or reflected by the target area, the patient and/or the surgical site with live data seen through an image and/or video capture system integrated into or attached to the OHMD can also be beneficial when the user and/or operator and/or surgeon has one or two eyes that suffers from a refractive error, e.g. myopia, hyperopia, presbyopia, or astigmatism. In this embodiment, the live data captured by the image and/or video capture system and displayed by the OHMD display can be projected with a focal plane or projection plane adjusted or adapted in location, position, orientation, alignment, rotation and/or, optionally also curvature for the user's and/or operator's and/or surgeon's refractive error. The adjustment of the display can be different for the left eye and the right eye. The adjustment of the display can also be different for near field and far field activities. The adjustment can include or consist of distorting the display of the live and/or the virtual data based on the user's known astigmatism, e.g. by applying a distortion to the live and/or the virtual data that is similar to or based on the distortion caused by the astigmatism in the user's eye. The degree and/or intensity of the superimposition and/or substitution of live data emitted from or reflected by the target area, the patient and/or the surgical site with live data seen through an image and/or video capture system integrated into or attached to the OHMD can be different for the left eye and the right eye, depending on the refractive error present or absent in each eye. Using this approach, the user and/or operator and/or surgeon can avoid the need for wearing glasses underneath the OHMD or for wearing contact lenses.

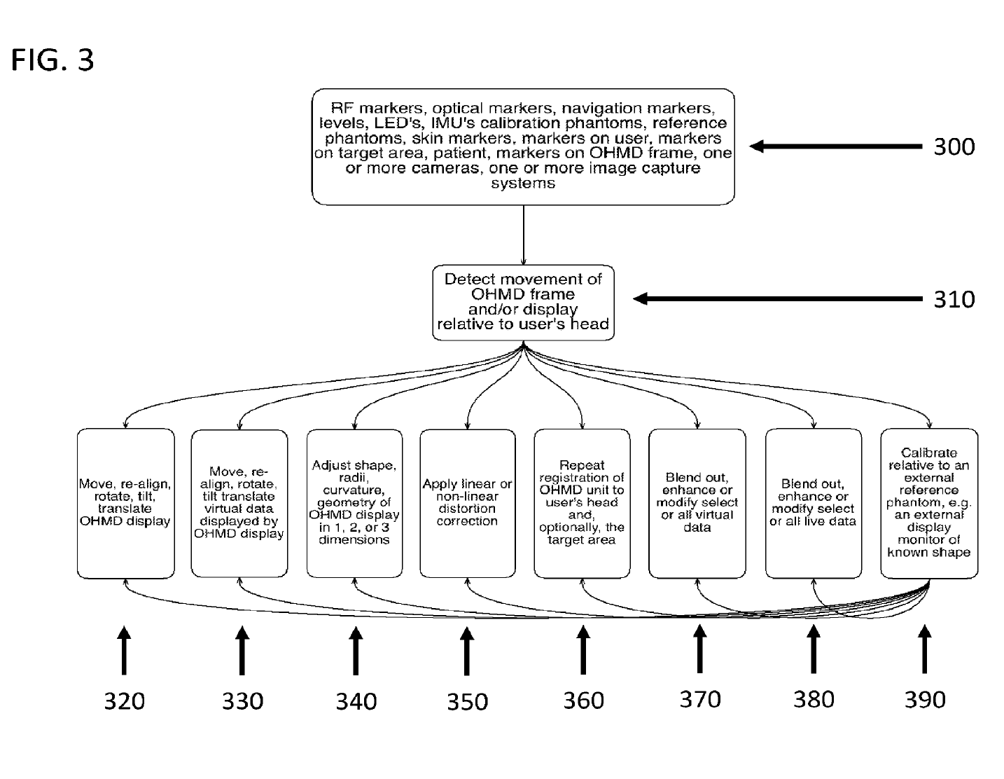

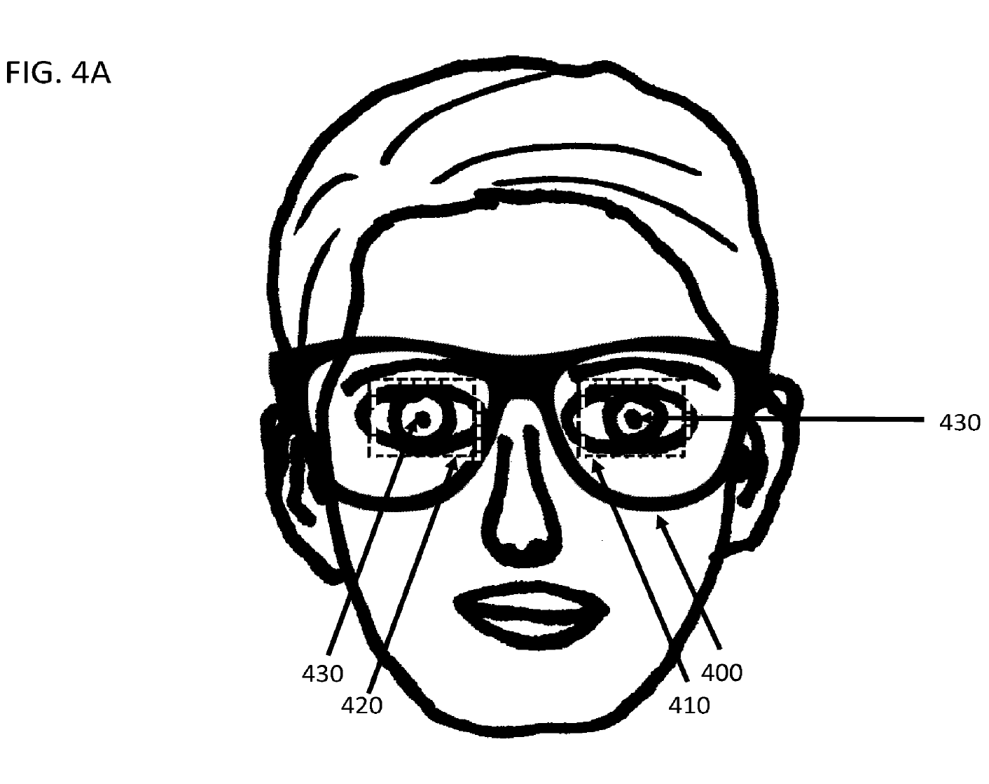

The flow chart shown in FIG. 3 provides examples of various means, methods and or systems for performing corrections in response to movement of the OHMD unit, including movement of the OHMD unit during an activity and/or surgical procedure, including movement of the OHMD unit relative to the user's and/or surgeon's head and/or face. This flow chart is only exemplary in nature and is not meant to be limiting of the invention.

In 300, various means, methods or systems of registering, for example, a target area, target site, point of interest, area of interest, volume of interest, one or more OHMD's, a surgeon, a user's or surgeon's hand, arm, face, nose or other body part, are shown. These means, methods or systems can be used to detect movement of an OHMD frame and/or display relative to a user's head 310. For example, an OHMD display can be moved, re-aligned, rotated, tilted, or translated 320, e.g. using electronic, optical, or mechanical means. Virtual data can be moved, re-aligned, rotated, tilted, or translated 330, e.g. using electronic, optical, or mechanical means. The shape, radii, curvature or geometry of the OHMD display can be adjusted in 1, 2, or 3 dimensions 340, for example using electronic, optical or mechanical means. Optionally, linear or non-linear distortion corrections can be applied 350. Optionally, the registration can be repeated 360, for example for the OHMD in relationship to the user's face and/or the target area, target site, point of interest, area of interest, volume of interest and/or the user or surgeon, e.g. select body parts. Optionally, select or all virtual data can be blended out, enhanced or modified 370. Optionally, select or all live data can be blended out, enhanced or modified 380; this approach can be, for example, implemented with VR, capturing the live data through one or more cameras or video system with display by the VR unit, as well as certain AR systems. Optionally, the OHMD display can be calibrated relative to an external reference 390, e.g. an external display monitor of known shape or one or more QR codes or other markers attached to a wall, a table, an OR table or, for example, one or more fixed structures in a room.

Moving, realigning, optionally tilting and or translating the display of the OHMD unit and/or the virtual data and/or the focus plane and/or the projection plane of the virtual data can also be used selectively and, optionally, separately for the left and/or right eye, including with different magnitude/distances/angles when a user and/or surgeon suffers from hyperopia and/or myopia and/or presbyopia or other refractive errors of one or both eyes.

In select embodiments, the distance of the OHMD display to the user's lens and/or retina and/or any other structure of the eyes can be measured, for example using one or more image and/or video capture systems or using standard means as are commonly used by optometrists and ophtalmologists. For example, when the distance of the OHMD display to the retina is known and, optionally, when the refraction of the lens is known, optionally for different levels of accommodation, the position, orientation and/or alignment of the OHMD display, the virtual data and/or the focus plane of the virtual data can be adjusted accordingly to optimize the focus, for example for a myopic eye or for a hyperopic eye. An adjustment can be fixed. An adjustment including the position, orientation and alignment of the OHMD display, the virtual data and/or the focus plane of the virtual data can also be variable, for example changing from near field to far field activities. Variable settings and adjustments of the position and/or orientation and/or alignment of the OHMD display, the virtual data and/or the focus plane of the virtual data can be beneficial when a user suffers from presbyopia of one or more eyes also.

Curved displays including curved display elements and/or mirrors and/or holographic optical elements and/or reflectors including curved arrangements of display elements and/or mirrors and/or holographic optical elements and/or reflectors can also be beneficial when a user suffers from astigmatism. The curvature can optionally vary in one or more dimensions depending on the geometry and the severity of the astigmatism. Curved displays including curved display elements and/or mirrors and/or holographic optical elements, e.g. curved waveguides, curved prisms, curved diffraction gratings, and/or reflectors including curved arrangements of display elements and/or mirrors and/or holographic optical elements, e.g. waveguides, prisms, diffraction gratings, and/or reflectors can have different curvatures for left and right eyes depending on the presence and/or absence of astigmatism and/or other visual abnormalities, including also their severity. Curved displays including curved display elements and/or mirrors and/or holographic optical elements, e.g. curved waveguides, curved prisms, curved diffraction gratings, and/or reflectors including curved arrangements of display elements and/or mirrors and/or holographic optical elements, e.g. waveguides, prisms, diffraction gratings, and/or reflectors can have one radius of curvature. Curved displays including curved display elements and/or mirrors and/or holographic optical elements, e.g. curved waveguides, curved prisms, curved diffraction gratings, and/or reflectors including curved arrangements of display elements and/or mirrors and/or holographic optical elements, e.g. waveguides, prisms, diffraction gratings, and/or reflectors can have multiple radii of curvature, optionally in one dimension or direction or plane, two dimensions or directions or planes or three dimensions or directions or planes. Curved displays including curved display elements and/or mirrors and/or holographic optical elements, e.g. curved waveguides, curved prisms, curved diffraction gratings, and/or reflectors including curved arrangements of display elements and/or mirrors and/or holographic optical elements, e.g. waveguides, prisms, diffraction gratings, and/or reflectors can have one radius of curvature in one dimension or direction or plane and a different radius of curvature in a second dimension or direction or plane. Curved displays including curved display elements and/or mirrors and/or holographic optical elements, e.g. curved waveguides, curved prisms, curved diffraction gratings, and/or reflectors including curved arrangements of display elements and/or mirrors and/or holographic optical elements, e.g. waveguides, prisms, diffraction gratings, and/or reflectors can have one radius of curvature in one dimension or direction or plane and two or more radii of curvature in a second dimension or direction or plane.

Error Prevention using Nasal, Ear, and/or Temple Fittings, Non-Customized and/or Customized

In some embodiments, mechanical means can be employed to reduce or avoid movement of the OHMD frame relative to the surgeon's or user's head and/or face and/or ears. Such mechanical means can, for example, include silicon fittings or other types of soft or semi-soft fittings to improve the fit between the OHMD frame and the user's and/or surgeons face and/or ears and/or head. Such fittings can also include spike like protrusions or small suction cup like extensions to create friction between the fitting and the skin or a vacuum like effect between the fitting and the skin.

In some embodiments, one or more fittings attachable to or integrated into the OHMD can be customized for an operator, user and/or surgeon. For example, customized nose pieces and or customized ear pieces can be used. The member extending from the eye piece to the ear piece can also include or have attached to it a customized fitting, for example to achieve a customized fit to the left and/or right temple of the operator, user and/or surgeon.

The one or more fittings including, optionally, customized fittings, e.g. customized nose or ear pieces, can be used to stabilize the OHMD on the user's head and/or face. In addition, optionally, the one or more fittings can include registration means, e.g. one or more of RF markers, optical markers, navigation markers, levels, LED's, IMU's, calibration phantoms, reference phantoms, skin markers, which can be compared, for example, to one or more of RF markers, optical markers, navigation markers, levels, LED's, IMU's, calibration phantoms, reference phantoms, skin markers, integrated or attached to the OHMD; the comparison can be used to determine and/or detect if the OHMD has moved in relationship to the one or more customized fittings and/or the user's and/or surgeon's face.

Fittings can be customized using standard techniques known in the art, including impressions, for example made of wax or other deformable materials, optionally self hardening. By creating an impression, the impression can be scanned, e.g. using an optical 3D scanner and a negative of the operator's, user's and/or surgeons facial features, portions of the nose, the ears and/or the temple can be created, which can be attached to or integrated into the OHMD.

In some embodiments, an optical 3D scanner, e.g. a laser scanner, can be used to scan the operator's, user's and/or surgeons nasal geometry, facial features, temple features and/or auricular/ear lobe and adjacent skull features. The information can then be used to derive a negative of the skin surface which, in turn, can be used to generate a customized device(s) substantially fitting the nasal geometry, facial features, temple features and/or auricular/ear lobe and adjacent skull features of the operator, surgeon, and/or user.

The one or more customized devices or fittings can then be manufactured using standard techniques known in the art or developed in the future, e.g. machining, cutting, molding, 3D printing and the like.

Curved Displays

Depending on the application, the errors can increase the closer the live object or live data or live target area or live surgical field are located relative to the OHMD unit. When an activity involves predominantly near field activities and/or interaction with the real world, e.g. in a surgical field working with a surgical target area or target tissue within the surgeon's arms' reach or in an industrial application that requires working with a target area within the user's arms' reach, a curved display including curved display elements and/or mirrors and/or holographic optical elements, e.g. curved waveguides, curved prisms, curved diffraction gratings, and/or reflectors including curved arrangements of display elements and/or mirrors and/or holographic optical elements, e.g. waveguides, prisms, diffraction gratings, and/or reflectors of the OHMD unit can optionally utilized. A curved display including curved display elements and/or mirrors and/or holographic optical elements, e.g. curved waveguides, curved prisms, curved diffraction gratings, and/or reflectors including curved arrangements of display elements and/or mirrors and/or holographic optical elements, e.g. waveguides, prisms, diffraction gratings, and/or reflectors of the OHMD unit can be help reduce near field distortions.

In addition, in some embodiments, curved displays can also be used to reduce or help avoid user discomfort related to differences in oculomotor cues, e.g. stereopsis and vergence or focus cues and accommodation, and visual cues, e.g. binocular disparity and retinal blur, processed by the brain for physical images or data and virtual images or data. For example, by approximating the curvature of the display of the OHMD unit with the natural curvature of the user's retina, optionally accounting for the convergence and divergence of light caused by the lens and the vitreous body, user discomfort related to differences in oculomotor cues and visual cues between physical images or data and virtual images or data processed by the brain can be reduced or avoided.

A curved display including curved display elements and/or mirrors and/or holographic optical elements, e.g. curved waveguides, curved prisms, curved diffraction gratings, and/or reflectors including curved arrangements of display elements and/or mirrors and/or holographic optical elements, e.g. waveguides, prisms, diffraction gratings, and/or reflectors can also be used in far field applications. A curved display including curved display elements and/or mirrors and/or holographic optical elements, e.g. curved waveguides, curved prisms, curved diffraction gratings, and/or reflectors including curved arrangements of display elements and/or mirrors and/or holographic optical elements, e.g. waveguides, prisms, diffraction gratings, and/or reflectors can help reduce distortions of the virtual data in relationship to the live data.

Curved displays including curved display elements and/or mirrors and/or holographic optical elements, e.g. curved waveguides, curved prisms, curved diffraction gratings, and/or reflectors including curved arrangements of display elements and/or mirrors and/or holographic optical elements, e.g. waveguides, prisms, diffraction gratings, and/or reflectors are applicable to any of the following OHMD techniques: diffractive waveguide display, holographic waveguide display with three holographic optical elements, e.g. in a sandwich configuration, polarized waveguide display, e.g. with multilayer polarized reflectors in a sandwich configuration, reflective waveguide display using curved semi-reflective mirror, switchable waveguide displays. The physical display(s), the display elements, the mirror(s), the grating(s), e.g. diffraction grating(s), the prism(s) and/or reflector(s) as well as the focus plane for display of the virtual data can be curved in one, two or three dimensions, with single or multiple radii in one, two or three planes, e.g. single radius in a first plane or direction and multiple radii in a second plane or direction, or single radius in a first plane or direction and single radius in a second plane or direction, or single radius in a first plane or direction and single radius in a second plane or direction and multiple radii in a third plane or direction, or multiple radii in a first plane or direction and multiple radii in a second plane or direction, or multiple radii in a first plane or direction and multiple radii in a second plane or direction and a single radius in a third plane or direction.

The curvature(s) can be chosen or selected for a given near or far field distance. The curvature(s) of also be chosen or selected for a user's vision and accommodation including astigmatism or other visual defects or distortions. The curvature(s) can be different for the left eye and the right eye depending on user preferences or vision or left and/or right eye visual defects or distortions. For example, different curvatures can be chosen for the left eye display and the right eye display of a user, if one eye is myopic and the other eye is not or is presbyopic, or hyperopic/hypermetropic. Different curvatures can be chosen for the left eye display and the right eye display of a user, if one eye has astigmatism and the other does not or if both eyes have astigmatism but of different severity and/or orientation.

The curvature can be in a single plane, e.g. an axial plane or a sagittal plane. The curvature can have a single radius. The curvature can have multiple radii in a single plane. For example, larger radii can be present in the center, e.g. the area located centrally over the pupil and projecting onto the center of the retina, e.g. near the macula or other region, while radii can optionally decrease in the periphery with smaller radii of the OHMD display present for peripheral vision areas. In select applications, smaller radii can be present in the center, e.g. the area located centrally over the pupil and projecting onto the center of the retina, while radii can optionally increase in the periphery with larger radii of the OHMD display present for peripheral vision areas.

The display including curved display elements and/or mirrors and/or holographic optical elements, e.g. curved waveguides, curved prisms, curved diffraction gratings, and/or reflectors including curved arrangements of display elements and/or mirrors and/or holographic optical elements, e.g. waveguides, prisms, diffraction gratings, and/or reflectors can be curved in multiple planes, e.g. axial and/or sagittal and/or coronal or intermediate planes. The radii can be spherical. The radii can be aspherical in nature. The display can have a constant radius in one or more planes. The display can have varying radii in one or more planes. Any combination of constant radii in one or more planes, optionally the same or different, and varying radii in another plane are possible. Curved displays including curved display elements and/or mirrors and/or holographic optical elements, e.g. curved waveguides, curved prisms, curved diffraction gratings, and/or reflectors including curved arrangements of display elements and/or mirrors and/or holographic optical elements, e.g. waveguides, prisms, diffraction gratings, and/or reflectors can have one radius of curvature. Curved displays including curved display elements and/or mirrors and/or holographic optical elements, e.g. curved waveguides, curved prisms, curved diffraction gratings, and/or reflectors including curved arrangements of display elements and/or mirrors and/or holographic optical elements, e.g. waveguides, prisms, diffraction gratings, and/or reflectors can have multiple radii of curvature, optionally in one dimension or direction or plane, two dimensions or directions or planes or three dimensions or directions or planes. Curved displays including curved display elements and/or mirrors and/or holographic optical elements, e.g. curved waveguides, curved prisms, curved diffraction gratings, and/or reflectors including curved arrangements of display elements and/or mirrors and/or holographic optical elements, e.g. waveguides, prisms, diffraction gratings, and/or reflectors can have one radius of curvature in one dimension or direction or plane and a different radius of curvature in a second dimension or direction or plane. Curved displays including curved display elements and/or mirrors and/or holographic optical elements, e.g. curved waveguides, curved prisms, curved diffraction gratings, and/or reflectors including curved arrangements of display elements and/or mirrors and/or holographic optical elements, e.g. waveguides, prisms, diffraction gratings, and/or reflectors can have one radius of curvature in one dimension or direction or plane and two or more radii of curvature in a second dimension or direction or plane.

The word display in these embodiments and throughout the specification, including the tables, flow charts, illustrations and figures, can mean the physical display and/or display elements; it can also mean the projection or an image or images generated by the physical display and/or display elements; it can also mean the focus plane or projection plane of the virtual data, e.g. in relationship to the eye, the pupil, the retina, and/or the macula; it can also mean individual display elements, a mirror, a holographic optical element, e.g. a waveguide, a gratings, e.g. a diffraction grating, a prism, a lens, a reflector, and/or a combiner, e.g. a flat combiner, curved combiner, Fresnel type combiner, cascaded prism/mirror combiner, free form TIR combiner, diffractive combiner, holographic waveguide combiner, holographic light guide combiner, or tapered oblique light guide combiner, or other light guides; it can also include a Virtual retinal display (VRD), in which the image is projected directly onto the retina, e.g. using a laser or LED. Thus, it is a subject of the current invention that any of the foregoing, in singular or plural form, i.e. physical display and/or display elements, projections or images generated by the physical display and/or display elements, focus planes or projection planes of virtual data, e.g. in relationship to the eye, the pupil, the retina, and/or the macula, individual display elements, mirrors, holographic optical elements, e.g. waveguides, gratings, e.g. diffraction gratings, prisms, lenses, reflectors, and/or combiners, e.g. flat combiners, curved combiners, Fresnel type combiners, cascaded prism/mirror combiners, free form TIR combiners, diffractive combiners, holographic waveguide combiners, holographic light guide combiners, or tapered oblique light guide combiners, or other light guides or VRD can be moved, e.g. translated, rotated, tilted, e.g. in x, y, or z direction, in x and y direction, in x and z direction, in y and z direction, in x, y and z direction, to adjust or compensate for any movement of the OHMD unit relative to the user's head, face, eye(s), pupil(s), retina(s) and/or macula(s). Thus, for example, when the virtual data are not intended to move in their position, orientation and/or alignment during an activity, e.g. a surgical procedure, it can be a subject of the current invention to maintain the virtual data in or return the virtual data to a prior or predetermined position and/or location and/or orientation and/or angulation, for example a position and/or location and/or orientation and/or angulation obtained during a calibration of the OHMD unit and display or obtained during a registration of the OHMD unit and display, even when the OHMD unit moves on the user's head or face.

In some embodiments, the individual display elements and/or mirrors and/or holographic optical elements, e.g. waveguides, prisms, diffraction gratings, and/or reflectors can be mounted on a deformable carrier, which can be adapted to the application (e.g. near field vs. far field) and/or the user's eyes (e.g. visual defects, e.g. myopic, presbyopic, hyperopic, astigmatic) and accommodation including, for example, stereopsis. If a deformable display element carrier is used, the deformation can be permanent (e.g. the shape of the carrier and the display will not change) or it can be adjustable. Many materials and devices are known in the art that can be deformable and that can, optionally, carry display elements and/or mirrors and/or holographic optical elements and/or reflectors for an OHMD display.

When a deformable OHMD display unit is used, e.g. with display elements and/or mirrors and/or holographic optical elements, e.g. waveguides, gratings, e.g. diffraction gratings, prisms and/or reflectors mounted on a deformable carrier, the deformation can, for example, be altered using mechanical means (e.g. mechanical actuators, with optional pulling or pushing), piezoelectric means, electric means, electromagnetic means, magnetic means, ultrasound and other means known in the art and developed in the future. The display shape can be adapted or adjusted for the user's eyes, e.g. range of accommodation, myopic, presbyopic, hyperopic, degree of myopia, presbyopia, hyperopia, astigmatism. The display shape can be different for the left eye and the right eye. The display shape can also be adapted based on near field vs. mid field vs. far field activities; the adaptation can be static, e.g. using a selectable mode, e.g. for predetermined near field distance(s) or far field distance(s), optionally individualized for the user's eyes, or continuous, e.g. using spatial mapping or depth mapping techniques, laser scanners or 3D scanners to determine the depth and distance of the field of view of the viewer, optionally paired with determination of the gaze direction of the viewer. The display shape can be altered in one, two or three dimensions or directions.

In some embodiments, for both see-through headsets, e.g. augmented reality (AR) OHMD's, and non-see through headsets, e.g. virtual reality (VR) OHMD's, distortion correction can be applied to the displayed data, e.g. virtual data with AR OHMD's and virtual and/or live data with VR OHMD's. The distortion correction can include or consist of distorting the display of the virtual and/or the live data based on the user's known visual defect, e.g. by applying a distortion to the virtual and/or the live data that is, for example, similar to or based on the distortion caused by the visual defect of the user's eye. Distortion correction can be applied, for example, based on a user's known or predetermined visual defect(s) such as myopia, presbyopia, hyperopia, or astigmatism.

The following examples of OHMD movement and optional adjustments or corrections are only exemplary in nature and are not meant to be limiting the invention. Someone skilled in the art will readily recognize other means of adjusting or correcting OHMD displays including display planes and/or focus planes.

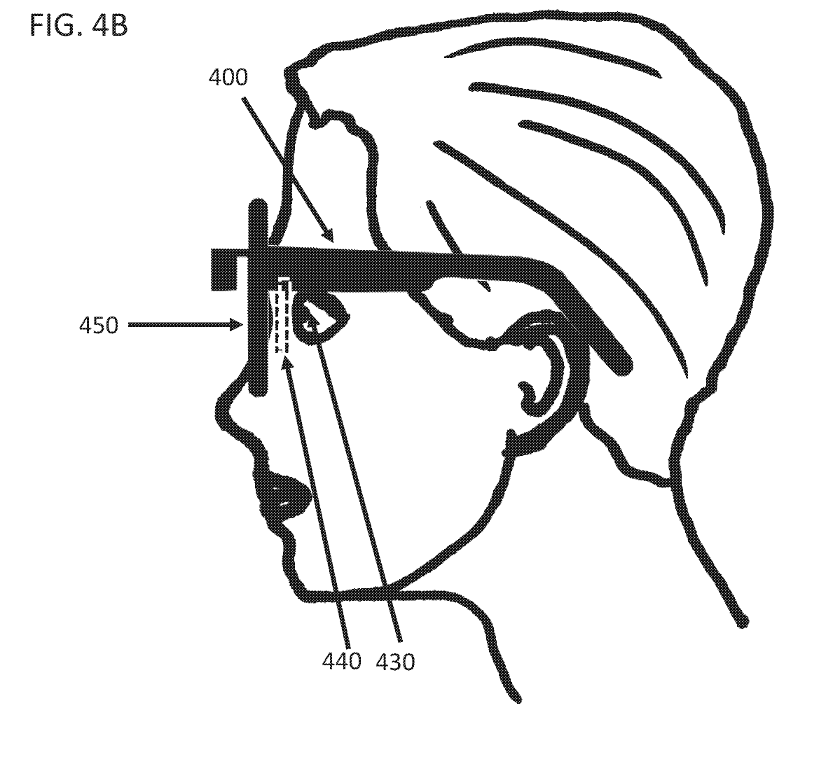

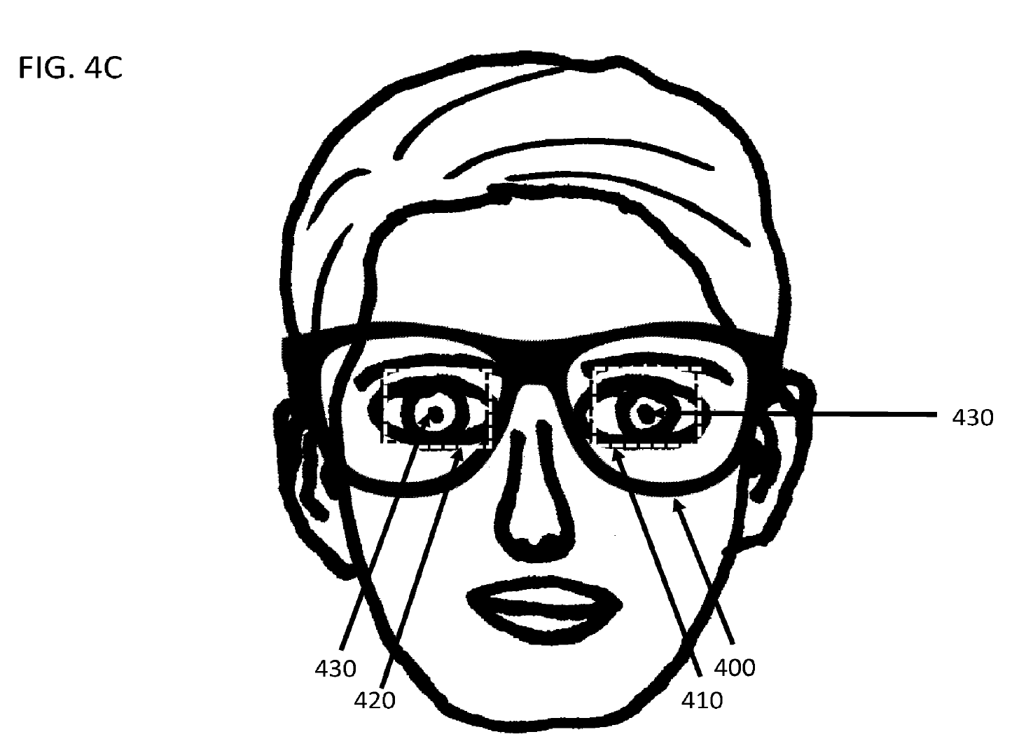

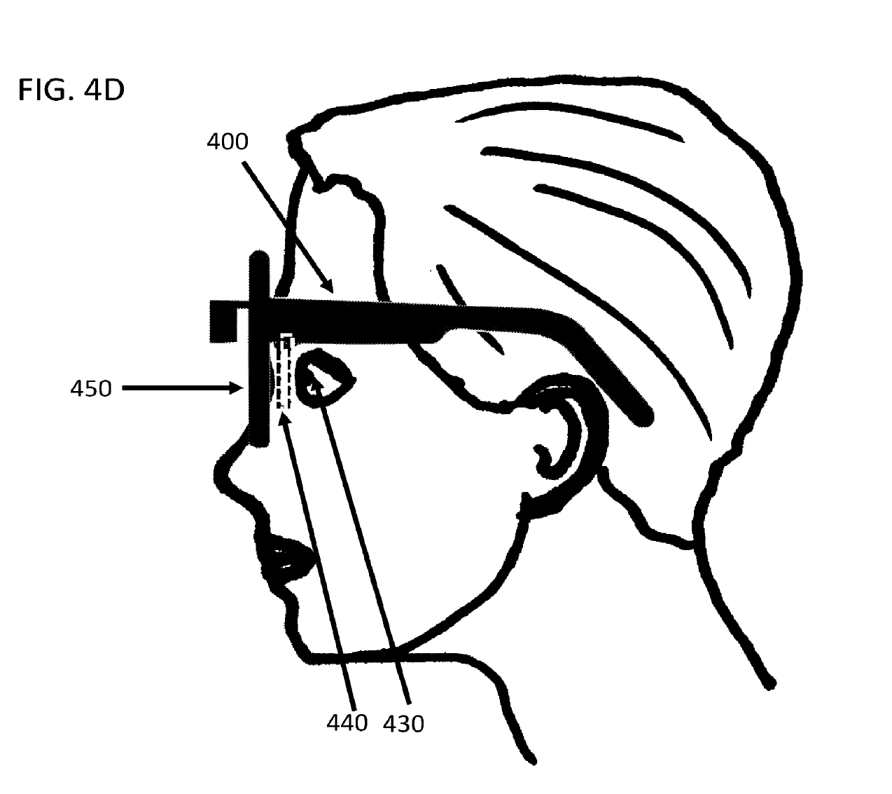

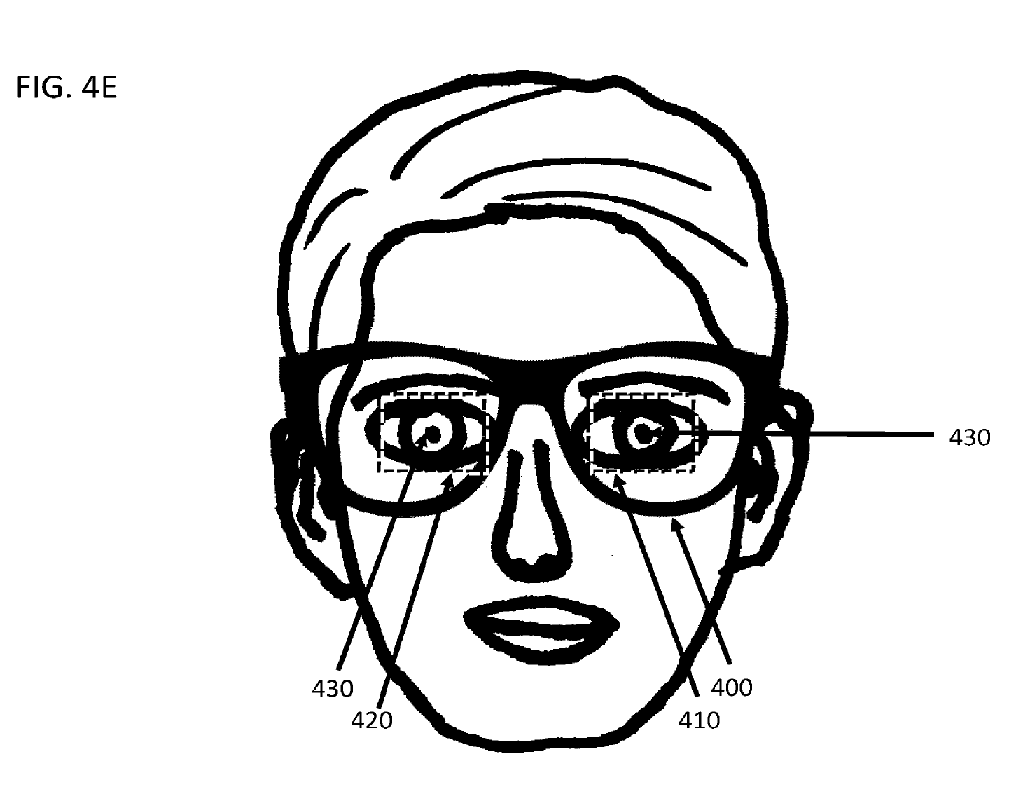

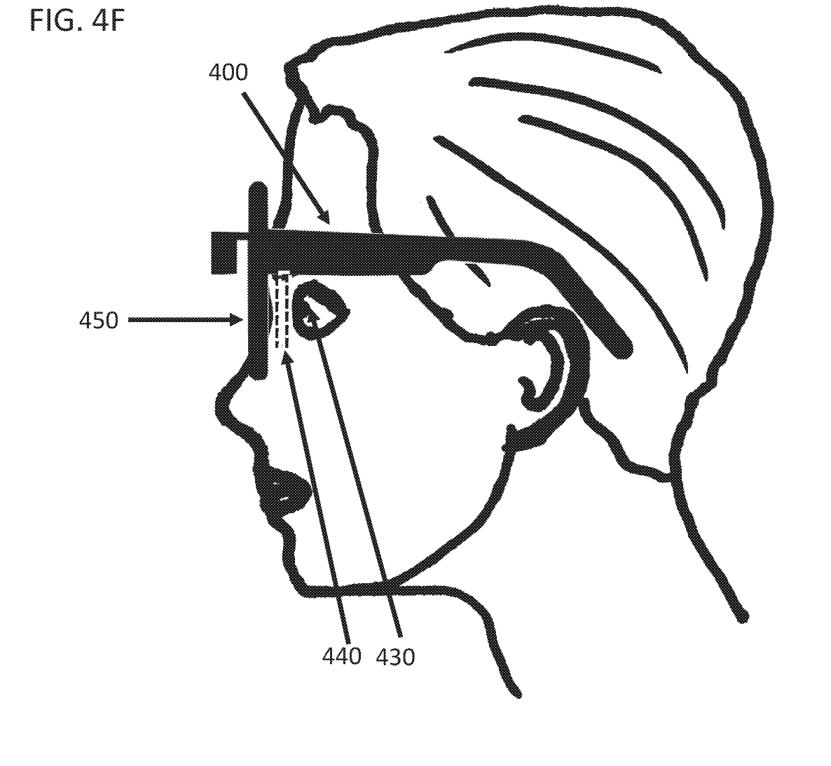

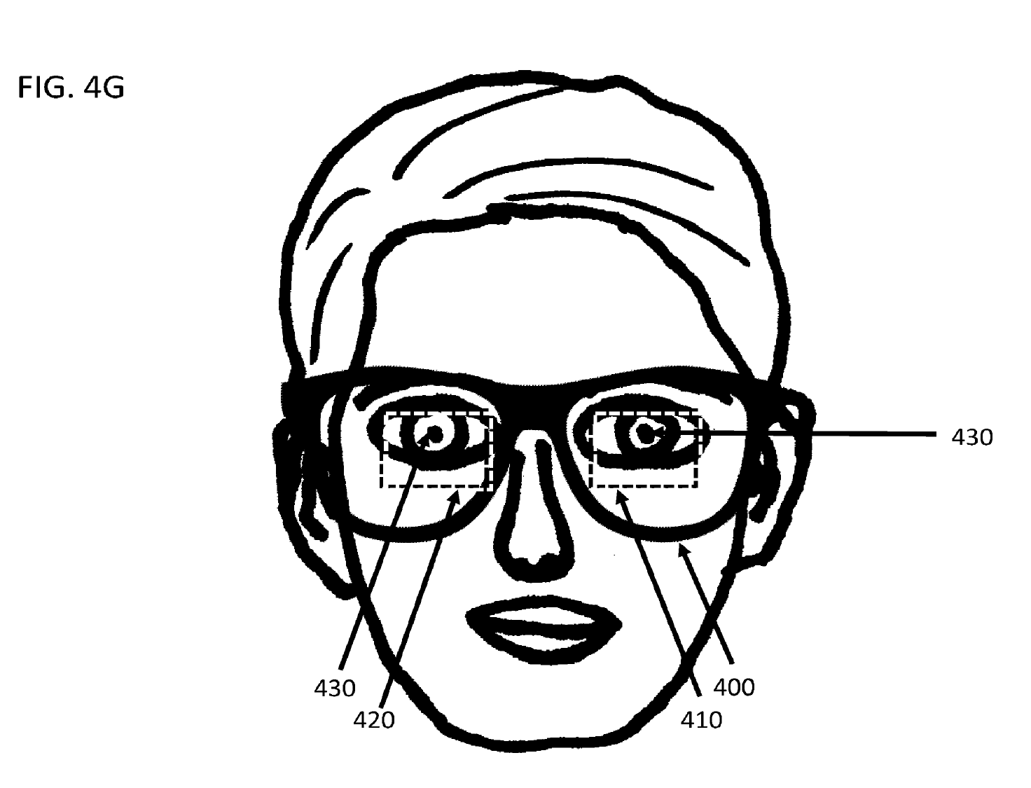

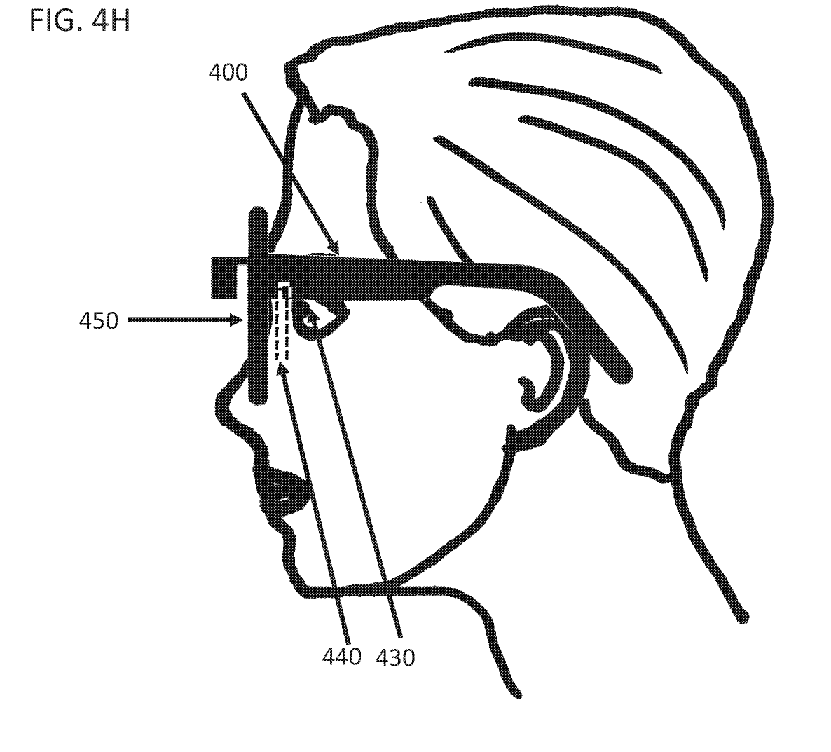

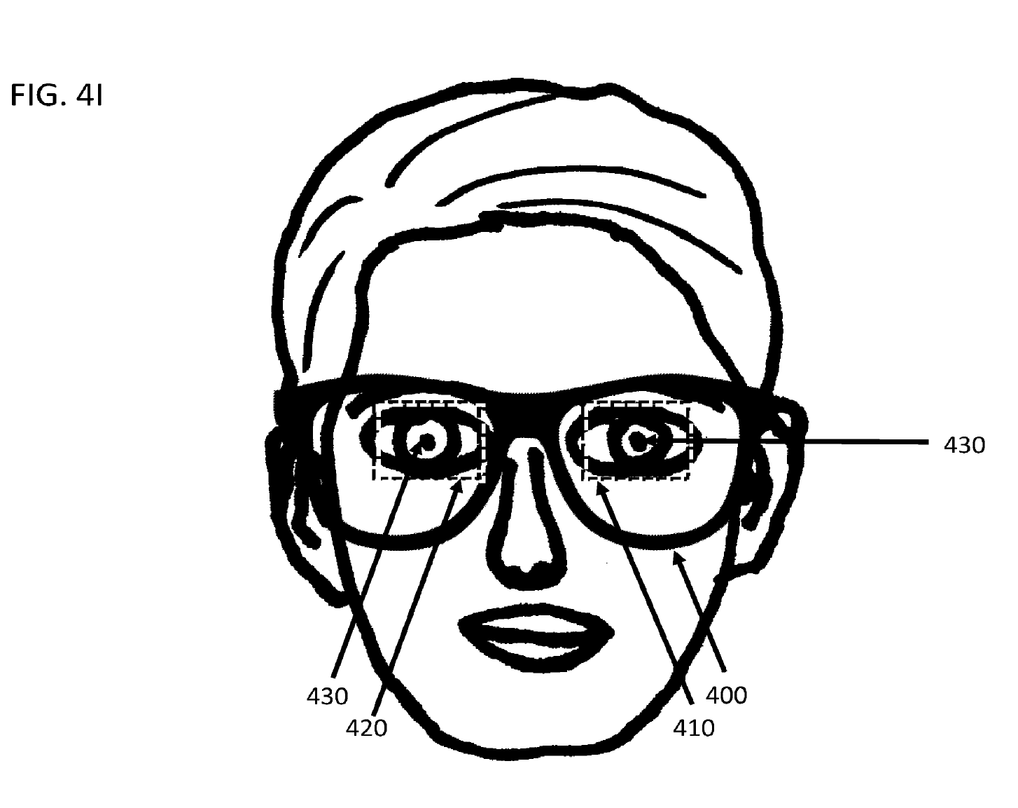

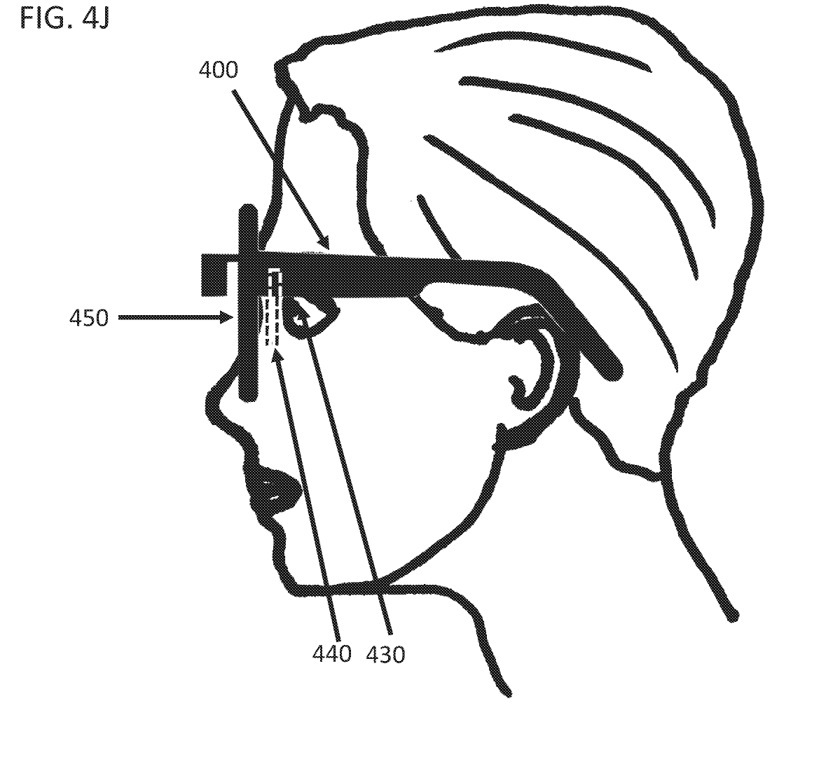

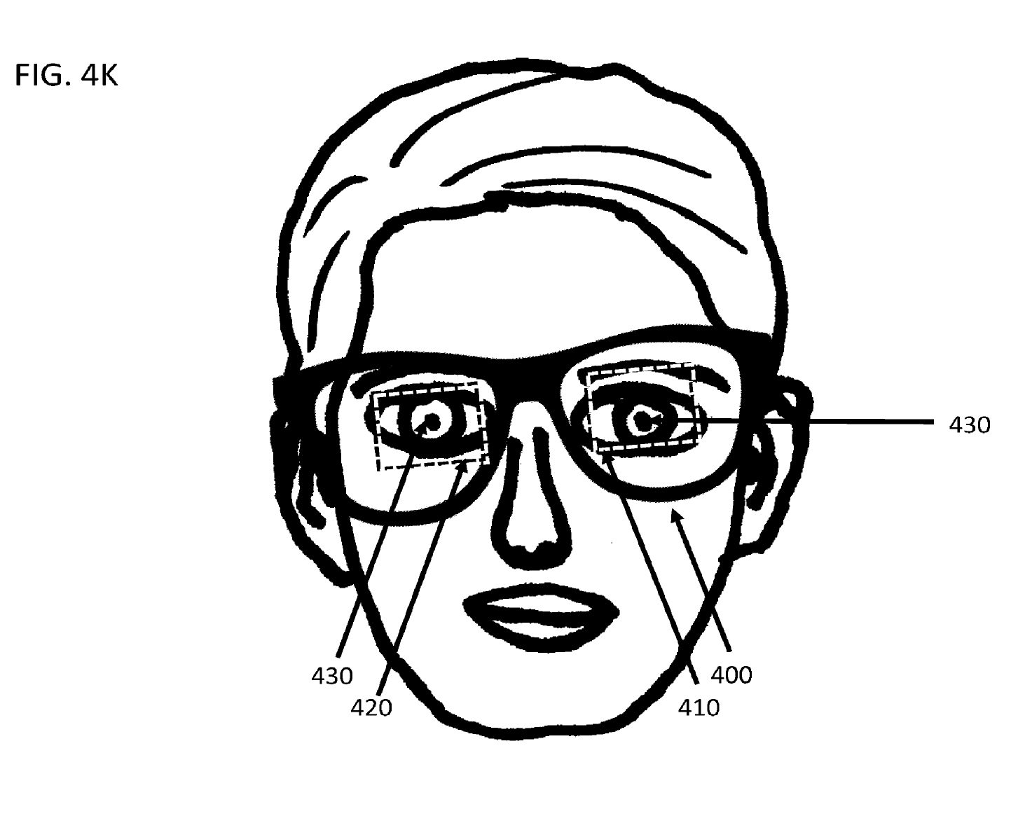

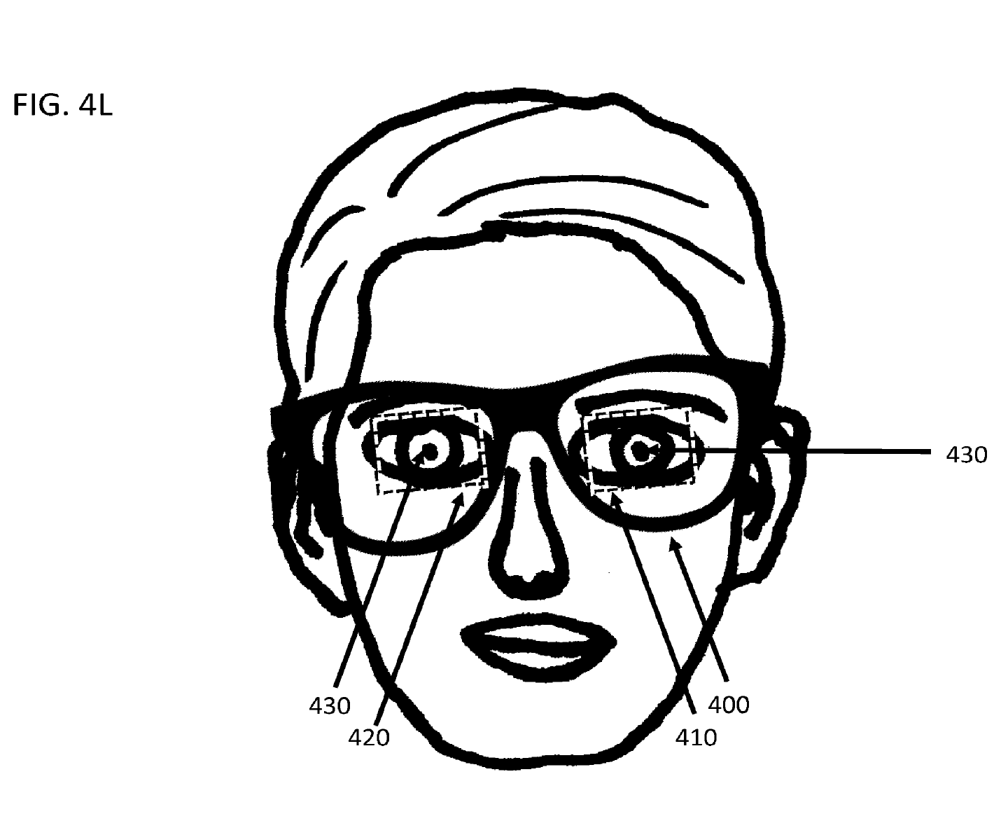

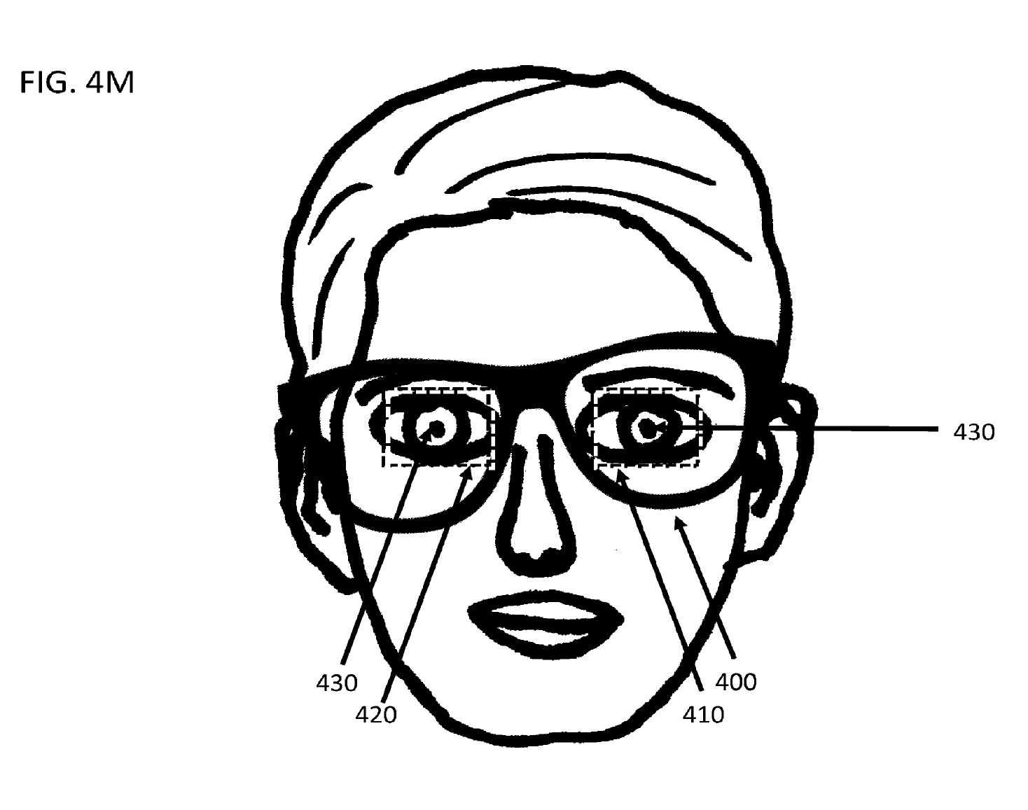

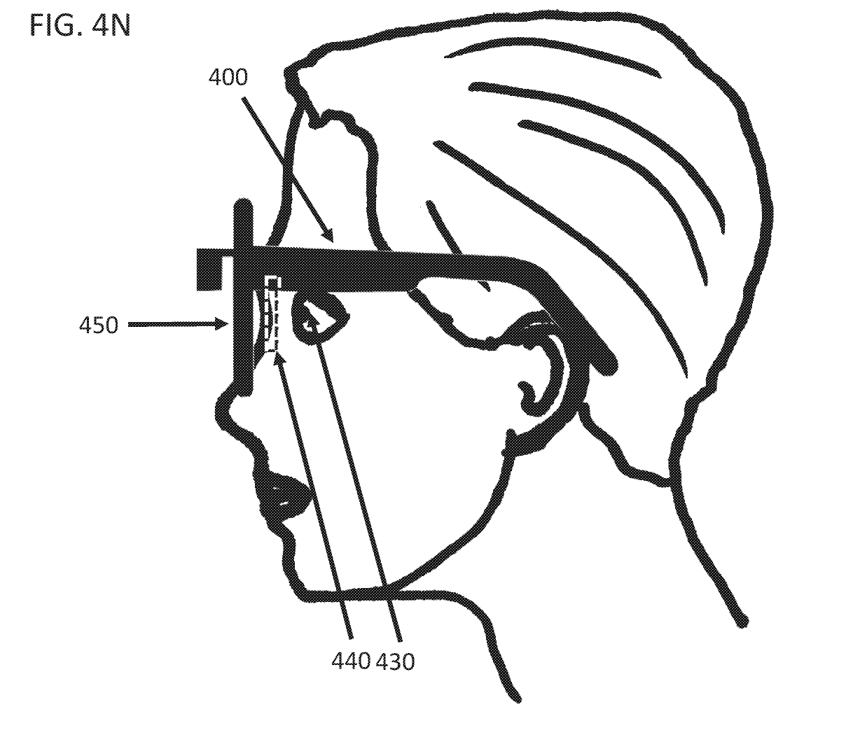

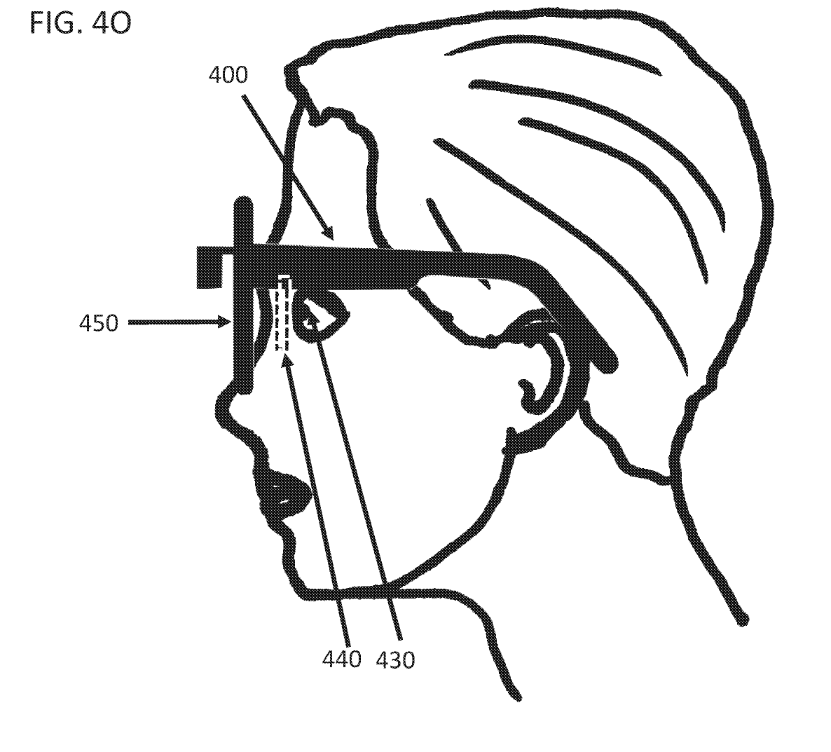

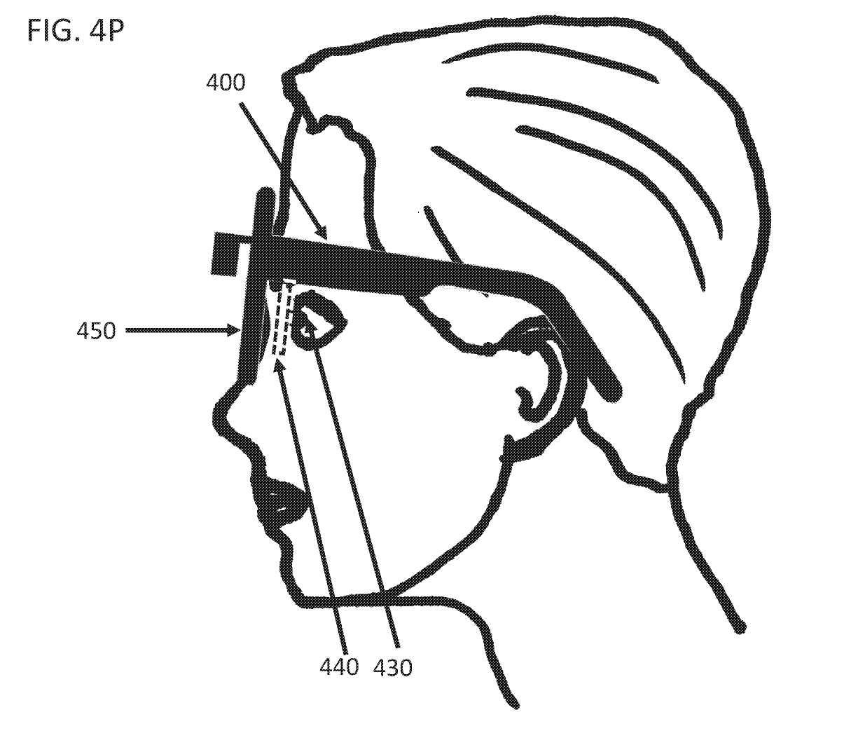

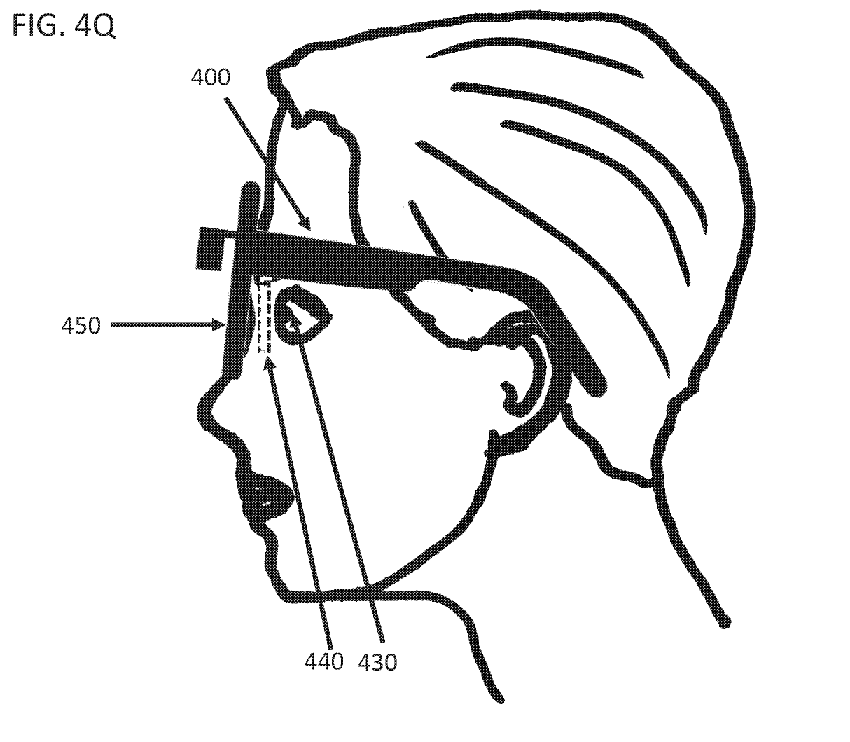

The different corrections shown in FIG. 4A-Q can in select embodiments be applied to both eyes or only one eye, e.g. the left eye or the right eye. They can also be applied to the left and right eye with different magnitude of correction. The corrections shown in FIGS. 4A-Q, for example, can be achieved by moving, e.g. translating or rotating including tilting, the display of the OHMD unit, including for example the projection plane or focus plane of the OHMD unit.

These types of adjustments can, for example, also be used for focusing the virtual data in relationship to a user's lens and retina. These and adjustments can also be performed for hyperopic eyes (selectively left or right, e.g. with different magnitude) and myopic eyes (selectively left or right, e.g. with different magnitude).

FIG. 4A shows a frontal view of an optical head mount display (OHMD) unit in a typical or representative position on the user's head, which can be a preferred position. The frame 400 of the OHMD unit is substantially centered over the eyes in the center of the face. The left and right side of the frame of the OHMD unit are in a horizontally straight position, not tilted or mal-aligned. The left eye display (rectangle with black and white stippled lines) 410 and the right eye display (rectangle with black and white stippled lines) 420 of the OHMD unit are centered over the respective left and right eye and pupil (black dot in center of eyes) 430 in this example. The display (rectangle with black and white stippled lines) 410 of the OHMD unit is parallel to the horizontal plane, orthogonal to the ground, and not rotated or titled.

FIG. 4B shows a side view of an optical head mount display (OHMD) unit in a typical or representative position on the user's head, which can be a preferred position. The frame 400 of the OHMD unit is substantially centered over the eye(s) or pupil(s) in the center of the face. The front facing portion 450 of the frame of the OHMD unit and the display 440 (rectangle with black and white stippled lines) of the OHMD unit are in a vertical plane on this side view, not tilted or mal-aligned, and substantially parallel to a frontal plane of the face. The display 440 (rectangle with black and white stippled lines) of the OHMD unit is centered over the eyes and pupils 430 (black dot in center of eyes).

FIG. 4C shows a frontal view of an optical head mount display (OHMD) unit in a different position when compared to the position shown in FIG. 4A. This can be an alternate position. The alternate position can be intentional by the user. The optical head mount unit can also have moved relative to its position during the initial registration of the OHMD and the patient and/or anatomy and/or target area. The frame 400 of the OHMD unit is more superiorly located, moved up on the user's head. This can be a superior translation if the preferred user position is, for example, as show in FIGS. 4A and 4B. The frame 400 of the OHMD unit is centered higher than the eyes. The left and right side of the frame of the OHMD unit are in a horizontally straight position, not tilted or mal-aligned. The left eye display 410 and the right eye display 420 (rectangles with black and white stippled lines) of the OHMD unit are not centered over the eyes and pupils 430 (black dot in center of eyes), but are centered superior to the eyes and pupils 430. The left eye display 410 and the right eye display 420 (rectangles with black and white stippled lines) of the OHMD unit are parallel to the horizontal plane, orthogonal to the ground, and not rotated or titled.

In surgical or medical procedures and any other activities or interactions between virtual data and real world that require high precision in registering virtual and live or real data, a superior or any other translation or rotation or movement of the OHMD unit after the initial registration of the OHMD unit and the target area with centering of the display of the OHMD unit superior to the eyes and pupils and/or not aligned with the eyes and pupils can result in a mis-registration or misaligned display of the virtual data, virtual anatomy, virtual surgical plan, projected path(s), projected endpoint(s), projected planes, projected cut planes, virtual instruments or virtual devices or implants in relationship to the live anatomy, the live target tissue and/or the live patient and/or a target area of activity.

FIG. 4D shows a side view of an optical head mount display (OHMD) unit in a different position when compared to the position shown in FIG. 4B. This can be an alternate position. The alternate position can be intentional by the user; it can be unintentional. The optical head mount unit can also have moved relative to its position during the initial registration of the OHMD and the patient and/or anatomy and/or target area. The frame 400 of the OHMD unit is more superiorly located, moved up on the user's head. This can be a superior translation if the preferred user position is as show in FIG. 4A and FIG. 4B. The frame 400 of the OHMD unit is centered higher than the eyes. The front facing portion 450 of the frame of the OHMD unit and the display 440 (rectangle with black and white stippled lines) of the OHMD unit are in a vertical plane on this side view in this example, not tilted or mal-aligned, and substantially parallel to a frontal plane of the face. The display 440 (rectangle with black and white stippled lines) of the OHMD unit is not centered over the eyes and pupils 430 (black dot in center of eyes), but is centered superior to the eyes and pupils 430.

In surgical or medical procedures and any other activities or interactions between virtual data and real world that require high precision in registering virtual and live or real data, a superior or any other translation or rotation or movement of the OHMD unit after the initial registration of the OHMD unit and the target area with centering of the display of the OHMD unit superior to the eyes and pupils and/or not aligned with the eyes and pupils can result in a mis-registration or misaligned display of the virtual data, virtual anatomy, virtual surgical plan, projected path(s), projected endpoint(s), projected planes, projected cut planes, virtual surgical instruments or virtual medical devices or implants in relationship to the live anatomy, the live target tissue and/or the live patient and/or a target area of activity.

FIG. 4E shows a frontal view of an optical head mount display (OHMD) unit in a different position when compared to the position shown in FIG. 4A. This can be an alternate position. The alternate position can be intentional by the user; it can be unintentional. The optical head mount unit can also have moved relative to its position during the initial registration of the OHMD and the patient and/or anatomy and/or target area. The frame 400 of the OHMD unit is more superiorly located, moved up on the user's head. The position of the frame of the OHMD unit is the same as that shown in FIG. 4C. The frame 400 of the OHMD unit is centered higher than the eyes or pupils 430. The left and right side of the frame 400 of the OHMD unit are in a horizontally straight position, not tilted or mal-aligned.

A correction or adjustment or compensation has been performed adjusting the position, location and/or orientation of the left eye display 410 and the right eye display 420 (rectangles with black and white stippled lines) of the OHMD unit when compared to FIG. 4C so that they are centered over the eyes and pupils 430 (black dot in center of eyes) by moving them inferiorly to compensate for the superior movement of the frame 400 of the OHMD unit. The displays 410 and 420 (rectangle with black and white stippled lines) of the OHMD unit can remain parallel to the horizontal plane, orthogonal to the ground, and not rotated or titled. In surgical or medical procedures and any other activities or interactions between virtual data and real world that require high precision in registering virtual and live or real or physical data, an adjustment of the position and/or location and/or orientation of the display of the OHMD unit to adjust for a superior or other translation or rotation of the frame of the OHMD unit after the initial registration of the OHMD and the target area can help avoid or reduce a mis-registration or misaligned display of the virtual data, virtual anatomy, virtual surgical plan, projected path(s), projected endpoint(s), projected planes, projected cut planes, virtual instruments or virtual devices or implants or virtual tools in relationship to the live anatomy, the live target tissue and/or the live patient and/or a target area of activity.

FIG. 4F shows a side view of an optical head mount display (OHMD) unit in a different position when compared to the position shown in FIG. 4B. This can be an alternate position. The alternate position can be intentional by the user; it can be unintentional. The optical head mount unit can also have moved relative to its position during the initial registration of the OHMD and the patient and/or anatomy and/or target area. The frame of the OHMD unit is more superiorly located, moved up on the user's head. This can be a superior translation if the preferred user position is as show in FIG. 4A and FIG. 4B. The position of the frame 400 of the OHMD unit is the same as that shown in FIG. 4D. The frame 400 of the OHMD unit is centered higher than the eyes and pupils 430. The front facing portion 450 of the frame of the OHMD unit and the display 440 (rectangle with black and white stippled lines) of the OHMD unit are in a vertical plane on this side view, not tilted or mal-aligned.

A correction or adjustment has been performed adjusting the position, location and/or orientation of the display 440 (rectangle with black and white stippled lines) of the OHMD unit when compared to FIG. 4D so that it is centered over the eyes and pupils 430 (black dot in center of eyes), by moving it inferiorly to compensate for the superior movement of the frame 400 of the OHMD unit. The display 440 (rectangle with black and white stippled lines) of the OHMD unit can remain parallel to the horizontal plane, orthogonal to the ground, and not rotated or titled. In surgical or medical procedures and any other activities or interactions between virtual data and real world that require high precision in registering virtual and live or real or physical data, an adjustment of the position and/or location and/or orientation of the display of the OHMD unit to adjust for a superior or other translation or rotation of the frame of the OHMD unit after the initial registration of the OHMD and the target area can help avoid or reduce a mis-registration or misaligned display of the virtual data, virtual anatomy, virtual surgical plan, projected path(s), projected endpoint(s), projected planes, projected cut planes, virtual instruments or virtual devices or implants or virtual tools in relationship to the live anatomy, the live target tissue and/or the live patient and/or a target area of activity.

FIG. 4G shows a frontal view of an optical head mount display (OHMD) unit in a different position when compared to the position shown in FIG. 4A. This can be an alternate position. The alternate position can be intentional by the user; it can be unintentional. The optical head mount unit can also have moved relative to its position during the initial registration of the OHMD and the patient and/or anatomy and/or target area. The frame 400 of the OHMD unit is more inferiorly located, moved down on the user's head. This can be an inferior translation if the preferred user position is, for example, as show in FIG. 4A and FIG. 4B. The frame 400 of the OHMD unit is centered lower than the eyes. The left and right side of the frame 400 of the OHMD unit are in a horizontally straight position, not tilted or mal-aligned. The left eye display 410 and the right eye display 420 (rectangles with black and white stippled lines) of the OHMD unit are not centered over the eyes and pupils 430 (black dot in center of eyes), but are centered inferior to the eyes and pupils 430. The left eye display 410 and the right eye display 420 (rectangles with black and white stippled lines) of the OHMD unit are parallel to the horizontal plane, orthogonal to the ground, and not rotated or titled. In surgical or medical procedures and any other activities or interactions between virtual data and real world that require high precision in registering virtual and live or real or physical data, an inferior or any other translation or rotation or movement after the initial registration of the OHMD and the target area with centering of the display of the OHMD unit inferior to the eyes and pupils and/or not aligned with the eyes and pupils can result in a mis-registration or misaligned display of the virtual data, virtual anatomy, virtual surgical plan, projected path(s), projected endpoint(s), projected planes, projected cut planes, virtual instruments or virtual devices or implants or virtual tools in relationship to the live anatomy, the live target tissue and/or the live patient and/or the target area of activity.

FIG. 4H shows a side view of an optical head mount display (OHMD) unit in a different position when compared to the position shown in FIG. 4B. This can be an alternate position. The alternate position can be intentional by the user; it can be unintentional. The optical head mount unit can also have moved relative to its position during the initial registration of the OHMD and the patient and/or anatomy and/or target area. The frame 400 of the OHMD unit is more inferiorly located, moved down on the user's head. This can be an inferior translation if the preferred user position is as show in FIG. 4A and FIG. 4B. The frame 400 of the OHMD unit is centered lower than the eyes or pupil 430. The front facing portion 450 of the frame of the OHMD unit and the display 440 (rectangle with black and white stippled lines) of the OHMD unit are in a vertical plane on this side view, not tilted or mal-aligned. The display 440 (rectangle with black and white stippled lines) of the OHMD unit is not centered over the eyes and pupils 430 (black dot in center of eyes), but is centered inferior to the eyes and pupils 430.

In surgical or medical procedures and any other activities or interactions between virtual data and real world that require high precision in registering virtual and live or real data, an inferior or any other translation or rotation or movement of the OHMD unit after the initial registration of the OHMD unit and the target area with centering of the display of the OHMD unit inferior to the eyes and pupils and/or not aligned with the eyes and pupils can result in a mis-registration or misaligned display of the virtual data, virtual anatomy, virtual surgical plan, projected path(s), projected endpoint(s), projected planes, projected cut planes, virtual instruments or virtual devices or implants in relationship to the live anatomy, the live target tissue and/or the live patient and/or a target area of activity.

FIG. 4I shows a frontal view of an optical head mount display (OHMD) unit in a different position when compared to the position shown in FIG. 4A. This can be an alternate position. The alternate position can be intentional by the user; it can be unintentional. The optical head mount unit can also have moved relative to its position during the initial registration of the OHMD and the patient and/or anatomy and/or target area. The frame 400 of the OHMD unit is more inferiorly located, moved down on the user's head. The position of the frame 400 of the OHMD unit is the same as that shown in FIG. 4G. The frame 400 of the OHMD unit is centered lower than the eyes or pupils 430. The left and right side of the frame of the OHMD unit are in a horizontally straight position, not tilted or mal-aligned.

A correction or adjustment has been performed adjusting the position, location and/or orientation of the left eye display 410 and the right eye display 420 (rectangles with black and white stippled lines) of the OHMD unit when compared to FIG. 4G so that they are centered over the eyes and pupils 430 (black dot in center of eyes), by moving them superiorly thereby compensating for the inferior movement of the frame 400 of the OHMD unit. The left eye display 410 and the right eye display 420 (rectangles with black and white stippled lines) of the OHMD unit can remain parallel to the horizontal plane, orthogonal to the ground, and not rotated or titled. In surgical or medical procedures and any other activities or interactions between virtual data and real world that require high precision in registering virtual and live or real or physical data, an adjustment of the position and/or location and/or orientation of the display of the OHMD unit to adjust for an inferior or other translation or rotation of the frame of the OHMD unit after the initial registration of the OHMD and the target area can help avoid or reduce a mis-registration or misaligned display of the virtual data, virtual anatomy, virtual surgical plan, projected path(s), projected endpoint(s), projected planes, projected cut planes, virtual instruments or virtual devices or implants in relationship to the live anatomy, the live target tissue and/or the live patient and/or a target area of activity.

FIG. 4J shows a side view of an optical head mount display (OHMD) unit in a different position when compared to the position shown in FIG. 4B. This can be an alternate position. The alternate position can be intentional by the user; it can be unintentional. The optical head mount unit can also have moved relative to its position during the initial registration of the OHMD and the patient and/or anatomy and/or target area. The frame of the OHMD unit is more inferiorly located, moved down on the user's head. This can be an inferior translation if the preferred user position is as show in FIG. 4A and FIG. 4B. The position of the frame 400 of the OHMD unit is the same as that shown in FIG. 4H. The frame 400 of the OHMD unit is centered lower than the eyes or pupil 430. The front facing portion 450 of the frame of the OHMD unit and the display 440 (rectangle with black and white stippled lines) of the OHMD unit are in a vertical plane on this side view, not tilted or mal-aligned.

A correction or adjustment has been performed adjusting the position, location and/or orientation of the display 440 (rectangle with black and white stippled lines) of the OHMD unit when compared to FIG. 4H so that it is centered over the eyes and pupils 430 (black dot in center of eyes). The display 440 (rectangle with black and white stippled lines) of the OHMD unit can remain parallel to the horizontal plane, orthogonal to the ground, and not rotated or titled. In surgical or medical procedures and any other activities or interactions between virtual data and real world that require high precision in registering virtual and live or real or physical data, an adjustment of the position and/or location and/or orientation of the display of the OHMD unit to adjust for an inferior or other translation or rotation of the frame of the OHMD unit after the initial registration of the OHMD unit and the target area can help avoid or reduce a mis-registration or misaligned display of the virtual data, virtual anatomy, virtual surgical plan, projected path(s), projected endpoint(s), projected planes, projected cut planes, virtual surgical instruments, virtual medical devices or virtual implants, virtual tools, or virtual instruments or virtual devices in relationship to the live anatomy, the live target tissue and/or the live patient.

FIG. 4K shows a frontal view of an optical head mount display (OHMD) unit in a different position when compared to the position shown in FIG. 4A. This can be an alternate position. The alternate position can be intentional by the user; it can be unintentional. The optical head mount unit can also have moved relative to its position during the initial registration of the OHMD and the patient and/or anatomy and/or target area. The frame 400 of the OHMD unit is more inferiorly located on the user's right side, moved down on the user's head, and more superiorly located on the user's left side, moved up on the user's head. This can be a rotation, with right inferior translation and left superior translation, if the preferred user position is, for example, as show in FIG. 4 and FIG. 4B. The left and right side of the frame 400 of the OHMD unit are not in a horizontally straight position, but are tilted and/or mal-aligned. The left eye display 410 and the right eye display 420 (rectangles with black and white stippled lines) of the OHMD unit are not centered over the eyes and pupils 430 (black dot in center of eyes); the display for the right eye 420 is tilted and moved inferior and the display for the left eye 410 is tilted and moved superior. The left eye display 410 and the right eye display 420 of the OHMD unit are at an angle other than 0 or 180 degrees to the horizontal plane, rotated or titled.

In surgical or medical procedures and any other activities or interactions between virtual data and real world that require high precision in registering virtual and live or real or physical data, an inferior or any other translation or rotation or movement after the initial registration of the OHMD and the target area with centering of the display of the OHMD unit inferior to the eyes and pupils and/or not aligned with the eyes and pupils can result in a mis-registration or misaligned display of the virtual data, virtual anatomy, virtual surgical plan, projected path(s), projected endpoint(s), projected planes, projected cut planes, virtual surgical instruments or virtual medical devices or virtual implants, or virtual tools, virtual instruments or virtual devices in relationship to the live anatomy, the live target tissue and/or the live patient and/or a target area of activity.

FIG. 4L shows a frontal view of an optical head mount display (OHMD) unit in a different position when compared to the position shown in FIG. 4A. This can be an alternate position. The alternate position can be intentional by the user; it can be unintentional. The optical head mount unit can also have moved relative to its position during the initial registration of the OHMD and the patient and/or anatomy and/or target area. The frame 400 of the OHMD unit is more inferiorly located on the user's right side, moved down on the user's head, and more superiorly located on the user's left side, moved up on the user's head. This can be a rotation, with right inferior translation and left superior translation, if the preferred user position is, for example, as show in FIG. 4A and FIG. 4B. The position of the frame 400 of the OHMD unit is the same as that shown in FIG. 4K. The left and right side of the frame of the OHMD unit are not in a horizontally straight position, but are tilted and/or mal-aligned.

A correction or adjustment has been performed adjusting the position, location and/or orientation of the left eye display 410 and the right eye display 420 (rectangles with black and white stippled lines) of the OHMD unit when compared to FIG. 4K so that the displays are centered over the left and right eyes and the left and right pupils 430 (black dot in center of eyes). The left eye display 410 and the right eye display 420 (rectangles with black and white stippled lines) of the OHMD unit are in this correction not parallel to the horizontal plane and not orthogonal to the ground; they remain rotated or titled.

In surgical or medical procedures and any other activities or interactions between virtual data and real world that require high precision in registering virtual and live or real data, an adjustment of the position and/or location and/or orientation and/or rotation of the display of the OHMD unit to adjust or compensate for tilting, rotation or translation of the frame of the OHMD unit after the initial registration of the OHMD and the target area can help avoid or reduce a mis-registration or misaligned display of the virtual data, virtual anatomy, virtual surgical plan, projected path(s), projected endpoint(s), projected planes, projected cut planes, virtual surgical tools, virtual surgical instruments, virtual medical devices or virtual implants, or virtual tools, virtual instruments or virtual devices in relationship to the live anatomy, the live target tissue and/or the live patient and/or a target area of activity.

FIG. 4M shows a frontal view of an optical head mount display (OHMD) unit in a different position when compared to the position shown in FIG. 4A. This can be an alternate position. The alternate position can be intentional by the user; it can be unintentional. The optical head mount unit can also have moved relative to its position during the initial registration of the OHMD and the patient and/or anatomy and/or target area. The frame 400 of the OHMD unit is more inferiorly located on the user's right side, moved down on the user's head, and more superiorly located on the user's left side, moved up on the user's head. This can be a rotation, with right inferior translation and left superior translation, if the preferred user position is, for example, as show in FIG. 4A and FIG. 4B. The position of the frame 400 of the OHMD unit is the same as that shown in FIG. 4K. The left and right side of the frame of the OHMD unit are not in a horizontally straight position, but are tilted and/or mal-aligned.

A correction or adjustment has been performed adjusting the position, location and/or orientation of the left eye display 410 and the right eye display 420 (rectangles with black and white stippled lines) of the OHMD unit when compared to FIG. 4K so that the left eye display 410 and the right eye display 420 (rectangles with black and white stippled lines) are centered over the left and right eyes and the left and right pupils 430 (black dot in center of eyes). In addition, unlike the correction in FIG. 4L, the left eye display 410 and the right eye display 420 (rectangles with black and white stippled lines) of the OHMD unit are in this correction also parallel to the horizontal plane and orthogonal to the ground; the displays were rotated to this corrected orientation achieving an orientation similar to the one shown in FIG. 4A. Thus, as shown in exemplary, non-limiting manner in FIG. 4L, the left eye display 410 and the right eye display 420 (rectangles with black and white stippled lines) can be moved to remain centered over the pupils 430, while remaining parallel to the frame of the OHMD unit or while maintaining a predetermined angular alignment or orientation to the OHMD unit; alternatively, as shown in exemplary, non-limiting manner in FIG. 4M, left eye display 410 and the right eye display 420 (rectangles with black and white stippled lines) can be moved to maintain an orientation parallel to the horizontal plane and orthogonal to the ground. Someone skilled in the art will recognize that any other intended, desired or predetermined orientation, angle, or distance to the eye and or pupil and/or the ground and/or the horizon and/or any other landmark can be maintained using the invention.

In surgical or medical procedures and any other activities or interactions between virtual data and real world that require high precision in registering virtual and live or real or physical data including images, an adjustment of the position and/or location and/or orientation and/or rotation of the display of the OHMD unit to adjust for tilting, rotation or translation of the frame of the OHMD unit after the initial registration of the OHMD and the target area can help avoid or reduce a mis-registration or misaligned display of the virtual data, virtual anatomy, virtual surgical plan, projected path(s), projected endpoint(s), projected planes, virtual surgical tools, virtual surgical instruments, virtual medical devices or virtual implants, or virtual tools, virtual instruments or virtual devices in relationship to the live anatomy, the live target tissue and/or the live patient and/or a target area of activity.

FIG. 4N shows a side view of an optical head mount display (OHMD) unit in a different position when compared to the position shown in FIG. 4B. This can be an alternate position. The alternate position can be intentional by the user; it can be unintentional. The optical head mount unit can also have moved relative to its position during the initial registration of the OHMD and the patient and/or anatomy and/or target area. The frame 400 of the OHMD unit is more anteriorly located, moved forward on the user's head. This can be an anterior translation if the preferred user position is as show in FIG. 4A and FIG. 4B. The frame 400 of the OHMD unit is centered more anterior relative to the eyes. The front facing portion 450 of the frame of the OHMD unit and the display 440 (rectangle with black and white stippled lines) of the OHMD unit are in a vertical plane on this side view, not tilted. The display 440 (rectangle with black and white stippled lines) of the OHMD unit is centered over the eyes and pupils 430 (black dot in center of eyes). The anterior movement of the frame of the OHMD unit has also resulted in an anterior translation of the display 440 (rectangle with black and white stippled lines) of the OHMD unit when compared to the position shown in FIG. 4B.

In surgical or medical procedures and any other activities or interactions between virtual data and real world that require high precision in registering virtual and live or real data, an anterior or any other translation or rotation or movement after the initial registration of the OHMD and the target area with centering of the display of the OHMD unit anterior to the eyes and pupils and/or not aligned with the eyes and pupils can result in a mis-registration or misaligned display of the virtual data, virtual anatomy, virtual surgical plan, projected path(s), projected endpoint(s), projected planes, projected cut planes, virtual surgical instruments or virtual medical devices or implants and/or virtual tools, virtual instruments and/or virtual devices in relationship to the live anatomy, the live target tissue and/or the live patient and or target area of activity. An anterior or posterior translation of the OHMD unit and the display 440 (rectangle with black and white stippled lines) or any other movement resulting in an increase or decrease in distance or angle between the display 440 (rectangle with black and white stippled lines) and the eye, pupil, and/or retina, for example when compared to an initial registration, can also result in magnification errors and, potentially, distortion errors; a magnification error or distortion can make virtual data, virtual anatomy, virtual surgical plan, projected path(s), projected endpoint(s), projected plane(s), projected cut plane(s), virtual surgical instrument(s) or virtual medical device(s) or implant(s) and/or virtual tool(s), virtual instrument(s) and/or virtual device(s) appear too large or too small or distorted. In certain circumstances, the magnification error or distortion may not be readily apparent to the user and can lead to operator errors. An anterior or posterior translation of the frame and display of the OHMD unit can also lead to focus issues with the potential of an unsharp display being projected or a display that requires a focus for the user's eye that is different from the focus required for seeing the real data and real information sharp. This can also lead to user discomfort, for example due to discrepancies in stereopsis, focus cues, binocular disparity and retinal blur between virtual data and/or virtual objects and real or physical data and/or real or physical objects. An anterior or posterior translation of the frame and display of the OHMD unit can also lead to magnification errors and the potential for false or inaccurate information being displayed or mal-alignment between virtual data and live data due to differences in magnification or displayed size, shape and dimensions vs. actual size, shape and dimensions.

FIG. 4O shows a side view of an optical head mount display (OHMD) unit in a different position when compared to the position shown in FIG. 4B. This can be an alternate position. The alternate position can be intentional by the user; it can be unintentional. The optical head mount unit can also have moved relative to its position during the initial registration of the OHMD and the patient and/or anatomy and/or target area. The frame 400 of the OHMD unit is more anteriorly located, moved forward on the user's head. This can be an anterior translation if the preferred user position is as show in FIG. 4A and FIG. 4B. The frame 400 of the OHMD unit is centered more anterior relative to the eyes. The front facing portion 450 of the frame of the OHMD unit and the display 440 (rectangle with black and white stippled lines) of the OHMD unit are in a vertical plane on this side view, not tilted. The display 440 (rectangle with black and white stippled lines) of the OHMD unit is centered over the eyes and pupils 430 (black dot in center of eyes).

The anterior movement of the display 440 (rectangle with black and white stippled lines) of the OHMD unit shown in FIG. 4N has been corrected. While the frame 400 of the OHMD unit is still anteriorly translated (moved forward) when compared to the position shown in FIG. 4B, the display 440 (rectangle with black and white stippled lines) of the OHMD unit has been re-positioned to correct for the anterior translation of the frame and to maintain the position of the display relative to the user's eye including pupil and retina similar to the position shown in FIG. 4B.

In surgical or medical procedures and any other activities or interactions, e.g. in gaming or industrial, aviation, aerospace, automotive applications, between virtual data and real world that require high precision in registering virtual and live or real or physical data, an adjustment of the position and/or location and/or orientation and/or rotation of the display of the OHMD unit to adjust for tilting, rotation or anterior or posterior or other translation of the frame of the OHMD unit, e.g. after the initial registration of the OHMD and the target area, including an anterior or posterior translation of the display can help avoid or reduce a mis-registration or misaligned display of the virtual data, virtual anatomy, virtual surgical plan, projected path(s), projected endpoint(s), projected plane(s), projected cut plane(s), virtual surgical instrument(s) or virtual medical device(s) or implant(s) and/or virtual tool(s), virtual instrument(s) and/or virtual device(s) in relationship to the live anatomy, the live target tissue and/or the live patient and/or a target area of activity; it can also help to avoid or reduce an unsharp display or a display requiring different eye focus/accommodation for the virtual data as compared to the live data; it can also help avoid or reduce magnification errors or distortion of virtual data when compared to live data thereby reducing the potential for errors resulting from inaccurate display of virtual data with inaccurate distances, angles, shapes or dimensions of virtual data displayed; it can help improve the accuracy of the display of the virtual data by maintaining a magnification with virtual data dimensions and/or alignment and/or position and/or orientation that are close to or similar to or the same as those of the live data; it can help improve the accuracy of the display of the virtual data by reducing distortion with virtual data dimensions and/or shape and/or alignment and/or position and/or orientation that are close to or similar to or the same as those of the live data; it can also help decrease user discomfort by reducing discrepancies in stereopsis, focus cues, binocular disparity and retinal blur between virtual data and/or virtual objects and real or physical data and/or real or physical objects.

FIG. 4P shows a side view of an optical head mount display (OHMD) unit in a different position when compared to the position shown in FIG. 4B. This can be an alternate position. The alternate position can be intentional by the user; it can be unintentional. The optical head mount unit can also have moved relative to its position during the initial registration of the OHMD and the patient and/or anatomy and/or target area. The frame 400 of the OHMD unit is tilted or rotated, tilted upward on the user's head. Of note, a tilting or rotation in the opposite direction is also possible resulting in a downward tilt of the OHMD unit (not shown). The front facing 450 portion of the frame 400 of the OHMD unit and the display 440 (rectangle with black and white stippled lines) of the OHMD unit are not in a vertical plane on this side view, but are angled or tilted at an angle other than 0 degrees or 180 degrees relative to the vertical plane or sagittal plane. The display 440 (rectangle with black and white stippled lines) of the OHMD unit is centered over the eyes and pupils 430 (black dot in center of eyes). The tilting or rotation of the frame of the OHMD unit in the vertical orientation or sagittal orientation has also resulted in a corresponding tilting or rotation of the display 440 (rectangle with black and white stippled lines) of the OHMD unit when compared to the position shown in FIG. 4B.

In surgical or medical procedures and any other activities or interactions between virtual data and real world that require high precision in registering virtual and live or real or physical data, a tilting or rotation or movement after the initial registration of the OHMD and the target area with tilting or rotation of the display 440 (rectangle with black and white stippled lines) of the OHMD unit relative to the eyes and pupils 430 and retina can result in a mis-registration or misaligned display of the virtual data, virtual anatomy, virtual surgical plan, projected path(s), projected endpoint(s), projected plane(s), projected cut plane(s), virtual surgical tool(s), virtual surgical instrument(s) or virtual medical device(s) or implant(s) and/or virtual tool(s), virtual instrument(s) and/or virtual device(s) in relationship to the live anatomy, the live target tissue and/or the live patient and/or target area of activity.

A tilting or a rotation of the display of the OHMD unit can also result in focus issues with the potential of an unsharp display being projected or a display that requires a focus for the user's eye that is different from the focus required for seeing the real data and real information sharp. The focus issues can also include an unsharp display of portions, e.g. an inferiorly displayed and/or superiorly displayed portion or, if tilting or rotation are in an axial plane, a medially displayed and/or laterally displayed portion of the virtual data or a portion of the virtual data displayed on the user's left side and/or the user's right side, with the potential to require different focus or different eye accommodation for different portions or parts of the virtual data.

A tilting or rotation of the display of the OHMD unit, e.g. in superior, inferior, left or right or medial or lateral direction, can also result in a distortion of the virtual data, e.g. with different magnification of superior vs. inferior portions of the virtual data, or medial or lateral portions of the virtual data, or left or right portions of the virtual data with the potential to result in a distorted display with inaccurate, distorted distances, shapes, geometries or dimensions of the virtual data relative to the live data or real data, e.g. with virtual data or objects being, at least in portions, smaller and/or larger and/or distorted relative to live, physical data or objects.

A tilting or rotation of the display of the OHMD unit, e.g. in superior, inferior, left or right or medial or lateral direction, can also result in user discomfort, for example due to discrepancies in stereopsis, focus cues, binocular disparity and retinal blur between virtual data and/or virtual objects and real or physical data and/or real or physical objects.

FIG. 4Q shows a side view of an optical head mount display (OHMD) unit in a different position when compared to the position shown in FIG. 4B. This can be an alternate position. The alternate position can be intentional by the user; it can be unintentional. The optical head mount unit can also have moved relative to its position during the initial registration of the OHMD and the patient and/or anatomy and/or target area. The frame 400 of the OHMD unit is tilted or rotated, tilted upward on the user's head. Of note, a tilting or rotation in the opposite direction is also possible resulting in a downward tilt of the OHMD unit (not shown). The front facing portion 450 of the frame 400 of the OHMD unit is not in a vertical plane on this side view, but is angled or tilted at an angle other than 0 degrees or 180 degrees relative to the vertical plane or sagittal plane.

The tilting and/or rotation of the display 440 (rectangle with black and white stippled lines) of the OHMD unit shown in FIG. 4P has been corrected. While the frame 400 of the OHMD unit is still tilted and/or rotated (in this example tilted upward on the user's head) when compared to the position shown in FIG. 4B, the display 440 (rectangle with black and white stippled lines) of the OHMD unit has been re-oriented and/or re-positioned to correct for the tilting and/or rotation of the frame 400 and to maintain the position of the display 440 (rectangle with black and white stippled lines) relative to the user's eye including pupil 430 and retina similar to the position shown in FIG. 4B. The display 440 (rectangle with black and white stippled lines) of the OHMD unit is centered over the eyes and pupils 430 (black dot in center of eyes).

In surgical or medical procedures and any other activities or interactions between virtual data and real world that require high precision in registering virtual and live or real or physical data, an adjustment of the position and/or location and/or orientation and/or tilt and/or rotation of the display of the OHMD unit to adjust for tilting, rotation or translation of the frame of the OHMD unit, e.g. after the initial registration of the OHMD and the target area, including a corrective or compensatory tilting or rotation or translation of the display back into a substantially vertical plane and/or back into a substantially coronal plane and/or back into a substantially axial plane and/or back into a plane substantially parallel to a frontal plane of the user's face and/or back to any other predetermined plane and/or back to the plane of the display at the time of the initial registration and/or back to the x, y and z coordinates of the display at the time of the initial registration or any subsequent registration, or combinations thereof can help avoid or reduce a mis-registration or misaligned display of the virtual data, virtual anatomy, virtual surgical plan, projected path(s), projected endpoint(s), projected plane(s), projected cut plane(s), virtual surgical tool(s), virtual surgical instrument(s) or virtual medical device(s) or implant(s) and/or virtual tool(s), virtual instrument(s) and/or virtual device(s) in relationship to the live anatomy, the live target tissue and/or the live patient and/or a target area of activity and/or a target volume of activity; it can also help to avoid or reduce an unsharp display or a display requiring different eye focus/accommodation for portions or all of the virtual data as compared to the live data; it can also help avoid or reduce magnification errors or distortion of portions or all of the virtual data when compared to live data thereby reducing the potential for errors resulting from inaccurate display of portions or all of the virtual data with inaccurate or distorted distances, shapes or dimensions of portions or all of portions or all of the virtual data displayed; it can help improve the accuracy of the display of portions or all of the virtual data by maintaining a magnification with virtual data dimensions and/or alignment and/or position and/or orientation that are close to or similar to or the same as those of the live data. A corrective or compensatory tilting or rotation or translation of the display of the OHMD unit, e.g. in superior, inferior, left or right or medial or lateral or anterior or posterior or any oblique direction, e.g. with the display returning back into a substantially vertical plane and/or returning back into a substantially coronal plane and/or returning back into a substantially axial plane and/or returning back into a plane substantially parallel to a frontal plane of the user's face and/or returning back to any other predetermined plane and/or returning back to the plane of the display at the time of the initial registration and/or returning back to the x, y and z coordinates of the display at the time of the initial registration or any subsequent registration, or combinations thereof can also help reduce in user discomfort, for example due to discrepancies in stereopsis, focus cues, binocular disparity and retinal blur between virtual data and/or virtual objects and real or physical data and/or real or physical objects.

A corrective or compensatory movement, e.g. translation, rotation or tilting, of the display of the OHMD unit can be performed using, for example, electronic means, optical means, mechanical means and combinations thereof. FIG. 5 is an illustrative, exemplary, non-limiting flow chart showing how the movement of the display can be performed. For example, one or more cameras or image capture systems 500, e.g. for imaging visible light or infrared light, can be used to obtain images or video of the user's head, face, eye(s), pupil(s) and/or retina(s) 510. One or more 3D scanners, e.g. as described, for example, in US 2017-0258526, entitled “Devices and Methods for Surgery”, filed Mar. 10, 2017 and U.S. Provisional Application No. 62/556,867, entitled “Devices and Methods for Surgery”, filed Sep. 11, 2017, which are incorporated herein by reference in their entirety, can also be used. The cameras, image capture systems or 3D scanners can be integrated into or attached to the OHMD or can, optionally, be separate from the OHMD 515. Optionally, a light source 520 can be integrated or attached to the OHMD 515. For example, the light source can be an LED. The light source can emit visible light or it can emit light from other parts of the spectrum, e.g. infrared. In some embodiments, the light source can be attached to or integrated into the OHMD unit, for example the frame of the OHMD unit 515. The light emitted from the light source and, for example, reflections of the light from the eye, e.g. the sclera, cornea, lens or pupil, can be detected by the one or more cameras, image capture systems or 3D scanners. The angle of reflected light as well as the intensity, dispersion and/or wavelength of reflected light from the eye, e.g. the sclera, cornea, lens or pupil, can be measured by the one or more cameras, image capture systems or 3D scanners and can, for example, be used to measure or estimate a distance of the eye, sclera, cornea, lens or pupil from the eye 530. In some embodiments, one or more light sources 520 can be integrated or attached to portions of the OHMD unit 515 with one or more cameras, image capture or video systems or 3D scanners 500 integrated or attached to, for example, an opposing portion or a different portion of the OHMD unit. For example, one or more light sources 520 can be located on a superior portion of the frame or other part of the OHMD unit, while one or more cameras, image capture or video systems or 3D scanners 500 can be located on an inferior portion of the frame or other part of the OHMD unit. In another example, one or more light sources 520 can be located on a medial portion of the frame or other part of the OHMD unit, while one or more cameras, image capture or video systems or 3D scanners 500 can be located on a lateral portion of the frame or other part of the OHMD unit. Multiple cameras and light sources can be used. Someone skilled in the art can recognize different camera and light source arrangements, which can also be different for the left eye and the right eye of the user. In some embodiments, computer software including image processing software, e.g. as described, for example, in US 2017-0258526, entitled “Devices and Methods for Surgery”, filed Mar. 10, 2017 and U.S. Provisional Application No. 62/556,867, entitled “Devices and Methods for Surgery”, filed Sep. 11, 2017, which are incorporated herein by reference in their entirety, can also be used to identify structures of the eye, e.g. a pupil, in the images, as also shown in FIG. 1, and to determine the distance or angle of the structure 530 from the camera(s), image capture system(s) and/or 3D scanner 500.

The distance, angle and/or orientation of the one or more camera(s), image capture system(s) and/or 3D scanner 500 to the user's head, face, eye(s), pupil(s), retina(s) and other structures can be determined, for example, as part of a calibration 540 of the OHMD unit for a particular user, for example when the user first uses the OHMD unit. The distance, angle and/or orientation of the one or more camera(s), image capture system(s) and/or 3D scanner 500 to the user's head, face, eye(s), pupil(s), retina(s) and other structures can be determined, for example, as part of registration 540 of the OHMD unit for a particular user during a procedure, e.g. a surgical procedure or an industrial or aerospace application. The distance, angle and/or orientation of the one or more camera(s), image capture system(s) and/or 3D scanner 500 to the user's head, face, eye(s), pupil(s), retina(s) and other structures can be determined, for example, for a predetermined position or a preferred position or a first position 540 of the OHMD unit for a particular user, e.g. during a procedure, e.g. a surgical procedure or an industrial or aerospace application. The one or more camera(s), image capture system(s) and/or 3D scanner 500 can be part of a tracking system, optionally integrated into or attached to the OHMD unit 515. The tracking system 500 can be used to track data, e.g. the distance, angle, including, for example, reflections or reflected light, e.g. IR light, e.g. angle, intensity, dispersion, wavelength, from the eye, sclera, cornea, lens or other structures, intermittently or continuously 550 during a process or procedure. The cameras and tracking system 500 can transmit image data and/or tracking data 545 to computer processor 555 configured to detect movement 560 of the OHMD unit, e.g. the OHMD unit frame, and any integrated or attached cameras and/or light sources, relative to the user's head, face, eye(s), pupil(s), retina(s) or other structures. The amount and direction of movement of the OHMD unit 515 in x, y, z direction, e.g. translation, rotation, tilting, and any integrated or attached cameras and/or light sources relative to the user's head, face, eye(s), pupil(s), retina(s) or other structures can be determined by the computer processor 555 and the desired amount of adjustment, correction or compensation can be determined 565. The adjustment, correction or compensation can be optical 570, electronic 572, mechanical 574, or combinations thereof 576. Optical adjustments, corrections, or compensation can, for example, include, but are not limited to change in focus, e.g. of a lens system or mirror(s), change in focal point, change in focal plane, change in lens convergence or divergence, change in mirror curvature 578. Electronic adjustments, corrections, or compensation can, for example, include, but are not limited to magnification, minification, zoom in, zoom out, distortion correction, image blurring or deblurring, moving displayed virtual data within the available field of view of the display, clipping virtual data, re-orienting and/or rotating virtual data 580. Mechanical adjustments, corrections, or compensation can, for example, include, but are not limited to moving, e.g. translating, rotating, tilting, re-aligning, depending on the material and structures used, also bending display elements, mirrors, holographic optical elements, e.g. waveguides, gratings, e.g. diffraction gratings, prisms, lenses, reflectors, combiners, light guides 582. Any combination of optical, electronic or mechanical adjustments, corrections or compensation can be applied. The optical, electronic or mechanical adjustments, corrections or compensation can be used to move, e.g. translate, tilt, or rotate the display 584. In embodiments, the adjustment, correction or compensation can consist of moving the display to the predetermined, preferred or first position 586, e.g. from a second position. The predetermined, preferred or first position can be from a calibration or registration step 540. In embodiments, x, y, and z coordinates of the display from the predetermined, preferred or first position can be used to move the display from the x, y, z coordinates of a second position back to the x, y, z coordinates of the predetermined, preferred or first position.

In some embodiments, the adjustment, correction or compensation can entail changing an x-coordinate, a y-coordinate or a z-coordinate of the display. In some embodiments, the adjustment, correction or compensation can entail changing a single coordinate, e.g. only an x-coordinate, only a y-coordinate or only a z-coordinate of the display. In some embodiments, the adjustment, correction or compensation can entail changing one or more x-coordinates and one or more y-coordinates of the display. In some embodiments, the adjustment, correction or compensation can entail changing one or more x-coordinates and one or more z-coordinates of the display. In some embodiments, the adjustment, correction or compensation can entail changing one or more y-coordinates and one or more z-coordinates of the display. In some embodiments, the adjustment, correction or compensation can entail changing one or more x-coordinates, one or more y-coordinates and one or more z-coordinates of the display.

In embodiments, the visual or camera image appearance or camera image pattern or camera image dimensions or shape of the eye, sclera, cornea, pupil and other structures of the eye obtained from the predetermined, preferred or first position, e.g. during a registration or calibration step 540, can be used to move the display from a second position back to the predetermined, preferred or first position, for example by moving the display and, for example, by iteratively matching the visual or camera image appearance or camera image pattern or camera image dimensions or shape of the eye, sclera, cornea, pupil and other structures of the eye for different positions until a close match to the predetermined, preferred or first position has been found.

It is understood that the examples and embodiments described herein can be used with see-through headsets, e.g. augmented reality (AR) OHMD's, and non-see through headsets, e.g. virtual reality (VR) OHMD's. It is understood that the examples and embodiments described herein are for illustrative purposes only and that various modifications of changes in light thereof are to be included within the spirit and purview of this application and scope of the appended claims. All publications, patents and patent applications cited herein are hereby incorporated by reference in their entirety for all purposes.

1. A system comprising
an optical head mounted display unit configured to be registered or calibrated in relationship to at least one of a user's head, face, eye or pupil;
a computer processor configured for measuring movement of the optical head mount display unit in relationship to the at least one of the user's head, face, eye or pupil; and
a means for adjusting one or more of the position, orientation, or alignment of the display of the optical head mounted display unit to adjust or compensate for the movement of the optical head mounted display unit in relationship to the at least one of the user's head, face, eye or pupil, for viewing live data and virtual data with the optical head mounted display unit.

2. The system of claim 1, wherein the means of adjusting the one or more of a position, orientation or alignment of the display maintains the display substantially centered over the user's eye or pupil.

3. The system of claim 1, wherein the optical head mounted display unit displays a left display and a right display and wherein the left display is maintained substantially centered over the left eye of the user and the right display is maintained substantially centered over the right eye of the user.

4. The system of claim 1, wherein the optical head mounted display unit displays a left display and a right display and wherein the left display is maintained substantially centered over the left pupil of the user and the right display is maintained substantially centered over the right pupil of the user.

5. The system of claim 1, wherein the optical head mounted display is a see-through optical head mounted display.

6. The system of claim 1, wherein the optical head mounted display is a non-see through or a virtual reality optical head mounted display.

7. The system of claim 6, further comprising one or more cameras for displaying live data of a target area of activity by the non-see through virtual reality optical head mounted display.

8. The system of claim 1, wherein the adjusting of the position, orientation or alignment of the display of the optical head mounted display unit includes at least one of translation or rotation or tilting.

9. The system of claim 8, wherein the translation is along at least one of an x-axis, y-axis or z-axis or combinations thereof.

10. The system of claim 8, wherein the rotation is in at least an axial plane, a sagittal plane, a coronal plane, an oblique plane or combinations thereof.

11. The system of claim 8, wherein the tilting is in at least an axial plane, a sagittal plane, a coronal plane, or combinations thereof.

12. The system of claim 1 wherein the display of the optical head mounted display unit includes at least one of a physical display or physical display elements, a projection or an image generated by the physical display or physical display elements, a focus plane or a projection plane of virtual data, an individual display element, a mirror, a holographic optical element, a waveguide, a grating, a diffraction grating, a prism, a lens, a reflector, a combiner or a light guide.

13. The system of claim 1, wherein the display is maintained in a substantially parallel plane relative to the frontal plane of the face of the user.

14. The system of claim 1, wherein the means of adjusting one or more of a position, orientation or alignment of the display of the optical head mounted display unit is at least one of optical, optoelectronic, mechanical or electrical means or a combination thereof.

15. The system of claim 1, wherein the adjusting is intermittent or continuous.

16. The system of claim 1, wherein the display of the optical head mounted display unit is at a predetermined position, orientation or alignment relative to the eye or pupil of the user and wherein the means of adjusting the one or more of the position, orientation or alignment of the display maintains the display substantially at the predetermined position.

17. A method for viewing live data and virtual data with an optical head mounted display unit, the method comprising
registering or calibrating the optical head mounted display unit in relationship to at least one of a user's head, face, eye or pupil;
measuring movement of the optical head mount display unit in relationship to the at least one of the user's head, face, eye or pupil; and
adjusting one or more of the position, orientation, or alignment of the display of the optical head mounted display unit to adjust or compensate for the movement of the optical head mounted display unit in relationship to the at least one of the user's head, face, eye or pupil.
